(19) United States
(12) Patent Application Publication
(10) Pub. No.: US 2017/0199570 A1
(43) Pub. Date: Jul. 13, 2017

(54) MOBILE TERMINAL AND CONTROL METHOD THEREFOR

(71) Applicant: LG ELECTRONICS INC., Seoul (KR)

(72) Inventors: Yunmi KWON, Seoul (KR); Jonghwan KIM, Seoul (KR); Jekwang YOUN, Seoul (KR); Hyemi JUNG, Seoul (KR); Arim KWON, Seoul (KR)

(73) Assignee: LG ELECTRONICS INC., Seoul (KR)

(21) Appl. No.: 15/314,038

(22) PCT Filed: Nov. 11, 2014
(86) PCT No.: PCT/KR2014/010802

§ 371 Date: Nov. 25, 2016

(30) Foreign Application Priority Data
May 27, 2014 (KR) 10-2014-0063404
Jul. 25, 2014 (KR) 10-2014-0094874

(51) Int. Cl. G06F 3/01; G06F 3/0484; G06F 3/0481; G06F 3/0482

(52) U.S. Cl. CPC G06F 3/015; G06F 3/0482; G06F 3/04845; G06F 3/04817; G06F 2203/04803

(57) ABSTRACT

A mobile terminal and a control method therefor are disclosed. The mobile terminal according to one embodiment of the present invention comprises: a brainwave detection unit; a brain wave recognition unit; a display unit; and a control unit, wherein the control unit controls the display unit so as to display a first screen corresponding to a first application currently being executed, controls the brainwave detection unit so as to detect the brain wave, controls the brainwave recognition unit so as to recognize the detected brainwave, on the basis of the first application, and controls the display unit so as to display a second screen which differs from the first screen with respect to at least a part thereof, on the basis of the recognized result of the brainwave.

### TECHNICAL FIELD

The present invention relates to a mobile terminal enabling a user to more conveniently use the mobile terminal and a method of controlling therefor.

### BACKGROUND ART

A terminal can be classified into a mobile/portable terminal and a stationary terminal in accordance with whether the terminal is capable of being moved. Again, the mobile terminal can be divided into a handheld (type) terminal and a vehicle mounted terminal.

A function of a mobile terminal is diversifying. For instance, the function of the mobile terminal includes such a function as data and audio communication, capturing a picture and a video using a camera, audio recording, playing a music file using a speaker system and outputting an image or a video on a display unit. Some of the terminals may have an additional function such as playing an electronic game or perform a function of a multimedia player. In particular, a latest mobile terminal can receive a multicast signal providing such visual contents as a broadcast, a video and a television program.

As the function of the terminal is diversified, the terminal is implemented in a form of a multimedia player equipped with multiple functions such as capturing a picture or a video, playing a music file or a video file, playing a game, receiving a broadcast and the like.

In order to support and increase the function of the terminal, it may consider improving a structural part and/or a software part of the terminal.

A function of a current mobile terminal is configured to be performed only when a user directly controls the function according to an intention of the user. Recently, it is required to have enhancement of a mobile terminal capable of being automatically controlled according to an intention of a user via brainwave recognition as well as a mobile terminal directly controlled by the user.

### DISCLOSURE OF THE INVENTION

### Technical Tasks

An object of the present invention is to solve the aforementioned problem and other problems. Another object of the present invention is to provide a mobile terminal capable of controlling various functions via brainwave recognition without being directly controlled by a user and a method of controlling therefor.

A technical task of one embodiment of the present invention is to provide user environment appropriate for an intention of a user via brainwave recognition.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a mobile terminal includes a brainwave detection unit, a brainwave recognition unit, a display unit, and a controller, the controller configured to control the display unit to display a first screen corresponding to a currently executed first application, the controller configured to control the brainwave detection unit to detect a brainwave, the controller configured to control the brainwave recognition unit to recognize the detected brainwave based on the first application, the controller configured to control the display unit to display a second screen different from the first screen in at least a part based on a brainwave recognition result.

To further achieve these and other advantages and in accordance with the purpose of the present invention, according to a different embodiment, a method of controlling a mobile terminal includes the steps of detecting and recognizing a brainwave, occurring a specific event, and displaying a screen corresponding to the specific event based on a brainwave recognition result.

To further achieve these and other advantages and in accordance with the purpose of the present invention, according to a further different embodiment, a mobile terminal includes a brainwave detection unit, a brainwave recognition unit, a display unit, a memory configured to store brainwave data according to concentration, and a controller, the controller configured to control the display unit to display a first screen corresponding to a currently executed first application, the controller configured to control the brainwave detection unit to detect a brainwave, the controller configured to control the brainwave recognition unit to detect concentration of a user by analyzing the detected brainwave based on the brainwave data according to the concentration, the controller configured to execute at least one of a specific function related to the application and a specific function related to the display unit according to the detected concentration.

To further achieve these and other advantages and in accordance with the purpose of the present invention, according to a further different embodiment, a mobile terminal includes a brainwave detection unit, a brainwave recognition unit, a memory configured to store brainwave data according to a current status and concentration of a user, and a controller, the controller configured to control the brainwave detection unit to detect a brainwave, the controller configured to control the brainwave recognition unit to detect the current status and the concentration of the user by analyzing the detected brainwave based on the brainwave data, the controller configured to execute a predetermined function related to the detected current status and the concentration of the user.

### Advantageous Effects

Advantage and effectiveness of a mobile terminal according to the present invention and a method of controlling therefor are described in the following.

According to at least one of embodiments of the present invention, it is able to provide a mobile terminal capable of controlling various functions via brainwave recognition without being directly controlled by a user.

According to at least one of embodiments of the present invention, it is able to provide user environment appropriate for an intention of a user via brainwave recognition.

An additional scope to which the present invention is applicable is going to be clearly understood based on the following detail description. Various changes and modifications can be clearly understood by those skilled in the art within the idea and the scope of the present invention. Hence, specific embodiment such as the detail description and preferred embodiment of the present invention should be understood as a given example.

### DESCRIPTION OF DRAWINGS

FIG. 1A is a block diagram of a mobile terminal in accordance with the present disclosure.

FIGS. 1B and 1C are conceptual views of one example of the mobile terminal, viewed from different directions;

FIG. 2 is a conceptual view of a deformable mobile terminal according to an alternative embodiment of the present disclosure.

FIG. 3 is a conceptual view of a wearable mobile terminal according to another alternative embodiment of the present disclosure.

FIG. 4 is a conceptual view of a wearable mobile terminal according to another alternative embodiment of the present disclosure.

FIG. 5 is a flowchart for an example of a method of controlling a mobile terminal via brainwave recognition according to one embodiment of the present invention;

FIGS. 6 to 8 are diagrams for explaining an example of a method of controlling a mobile terminal via brainwave recognition according to one embodiment of the present invention;

FIGS. 9 to 1I are diagrams for explaining a different example of a method of controlling a mobile terminal via brainwave recognition according to one embodiment of the present invention;

FIG. 12 is a diagram for explaining a further different example of a method of controlling a mobile terminal via brainwave recognition in the mobile terminal according to one embodiment of the present invention;

FIG. 13 is a diagram for explaining a further different example of a method of controlling a mobile terminal via brainwave recognition according to one embodiment of the present invention;

FIG. 14 is a diagram for explaining a further different example of a method of controlling a mobile terminal via brainwave recognition according to one embodiment of the present invention;

FIG. 15 is a diagram for explaining a further different example of a method of controlling a mobile terminal via brainwave recognition according to one embodiment of the present invention;

FIG. 16 is a diagram for explaining a further different example of a method of controlling a mobile terminal via brainwave recognition according to one embodiment of the present invention;

FIG. 17 is a diagram for explaining a further different example of a method of controlling a mobile terminal via brainwave recognition according to one embodiment of the present invention;

FIG. 18 is a diagram for explaining a further different example of a method of controlling a mobile terminal via brainwave recognition according to one embodiment of the present invention;

FIG. 19 is a diagram for explaining a further different example of a method of controlling a mobile terminal via brainwave recognition according to one embodiment of the present invention;

FIG. 20 is a diagram for explaining a further different example of a method of controlling a mobile terminal via brainwave recognition according to one embodiment of the present invention;

FIG. 21 is a diagram for explaining a further different example of a method of controlling a mobile terminal via brainwave recognition according to one embodiment of the present invention;

FIGS. 22 to 23 are diagrams for explaining a further different of a method of controlling a mobile terminal via brainwave recognition according to a different embodiment of the present invention;

FIG. 24 is a flowchart for an example of a method of controlling a mobile terminal via brainwave recognition according to a different embodiment of the present invention;

FIG. 25 is a diagram for explaining an example of a method of controlling a mobile terminal via brainwave recognition according to a different embodiment of the present invention;

FIG. 26 is a diagram for explaining a different example of a method of controlling a mobile terminal via brainwave recognition according to a different embodiment of the present invention;

FIG. 27 is a diagram for explaining a further different example of a method of controlling a mobile terminal via brainwave recognition according to a different embodiment of the present invention;

FIG. 28 is a diagram for explaining a further different example of a method of controlling a mobile terminal via brainwave recognition according to a different embodiment of the present invention;

FIG. 29 is a diagram for explaining a further different example of a method of controlling a mobile terminal via brainwave recognition according to a different embodiment of the present invention;

FIG. 30 is a diagram for explaining a further different example of a method of controlling a mobile terminal via brainwave recognition according to a different embodiment of the present invention;

FIG. 31 is a diagram for explaining a further different example of a method of controlling a mobile terminal via brainwave recognition according to a different embodiment of the present invention;

FIG. 32 is a diagram for explaining a further different example of a method of controlling a mobile terminal via brainwave recognition according to a different embodiment of the present invention;

FIG. 33 is a diagram for explaining a further different example of a method of controlling a mobile terminal via brainwave recognition according to a different embodiment of the present invention;

FIG. 34 is a flowchart for explaining an example of a method of controlling a mobile terminal via brainwave recognition according to a further different embodiment of the present invention;

FIG. 35 is a diagram for explaining an example of a method of controlling a mobile terminal via brainwave recognition according to a further different embodiment of the present invention;

FIG. 36 is a diagram for explaining a different example of a method of controlling a mobile terminal via brainwave recognition according to a further different embodiment of the present invention;

FIG. 37 is a diagram for explaining an example of a method of controlling a mobile terminal via brainwave recognition according to a further different embodiment of the present invention;

FIG. 38 is a flowchart for an example of a method of controlling a mobile terminal via brainwave recognition according to one embodiment of the present invention;

FIG. 39 is a diagram for explaining an example of a method of controlling a mobile terminal via brainwave recognition according to one embodiment of the present invention;

FIG. 40 is a diagram for explaining an example of a method of controlling a mobile terminal via brainwave recognition according to one embodiment of the present invention;

FIG. 41 is a diagram for explaining an example of a method of controlling a mobile terminal via brainwave recognition according to one embodiment of the present invention;

FIG. 42 is a diagram for explaining an example of a method of controlling a mobile terminal via brainwave recognition according to one embodiment of the present invention;

FIG. 43 is a diagram for explaining an example of a method of controlling a mobile terminal via brainwave recognition according to one embodiment of the present invention;

FIG. 44 is a diagram for explaining an example of a method of controlling a mobile terminal via brainwave recognition according to one embodiment of the present invention;

FIG. 45 is a diagram for explaining an example of a method of controlling a mobile terminal via brainwave recognition according to one embodiment of the present invention;

FIG. 46 is a diagram for explaining an example of a method of controlling a mobile terminal via brainwave recognition according to one embodiment of the present invention;

FIG. 47 is a diagram for explaining an example of a method of controlling a mobile terminal via brainwave recognition according to one embodiment of the present invention;

FIG. 48 is a flowchart for explaining an example of a method of controlling a mobile terminal via brainwave recognition according to one embodiment of the present invention;

FIG. 49 is a diagram for explaining an example of a method of controlling a mobile terminal via brainwave recognition according to one embodiment of the present invention;

FIG. 50 is a diagram for explaining an example of a method of controlling a mobile terminal via brainwave recognition according to one embodiment of the present invention;

FIG. 51 is a flowchart for a different example of a method of controlling a mobile terminal via brainwave recognition according to one embodiment of the present invention;

FIG. 52 is a flowchart for an example of a method of controlling a mobile terminal via brainwave recognition according to one embodiment of the present invention;

FIG. 53 is a diagram for explaining an example of a method of controlling a mobile terminal via brainwave recognition according to one embodiment of the present invention;

FIG. 54 is a diagram for explaining an example of a method of controlling a mobile terminal via brainwave recognition according to one embodiment of the present invention;

FIG. 55 is a diagram for explaining an example of a method of controlling a mobile terminal via brainwave recognition according to one embodiment of the present invention;

FIG. 56 is a flowchart for explaining an example of a method of controlling a mobile terminal via brainwave recognition according to one embodiment of the present invention;

FIG. 57 is a diagram for explaining an example of a method of controlling a mobile terminal via brainwave recognition according to one embodiment of the present invention;

FIG. 58 is a diagram for explaining an example of a method of controlling a mobile terminal via brainwave recognition according to one embodiment of the present invention;

FIG. 59 is a diagram for explaining an example of a method of controlling a mobile terminal via brainwave recognition according to one embodiment of the present invention;

FIG. 60 is a diagram for explaining an example of a method of controlling a mobile terminal via brainwave recognition according to one embodiment of the present invention.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

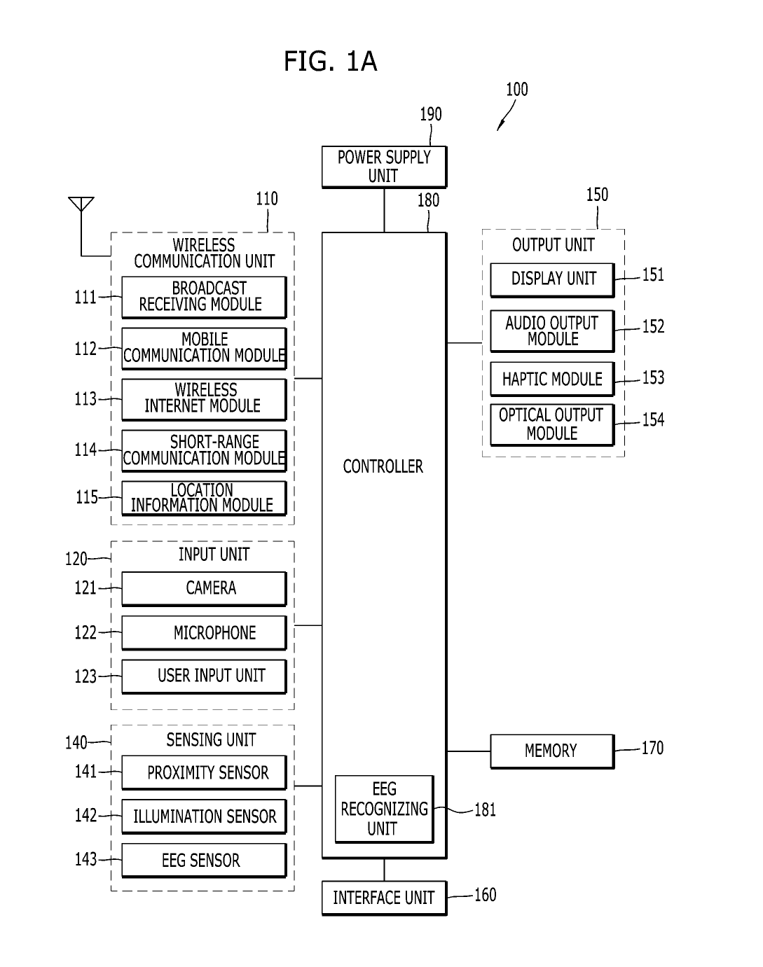

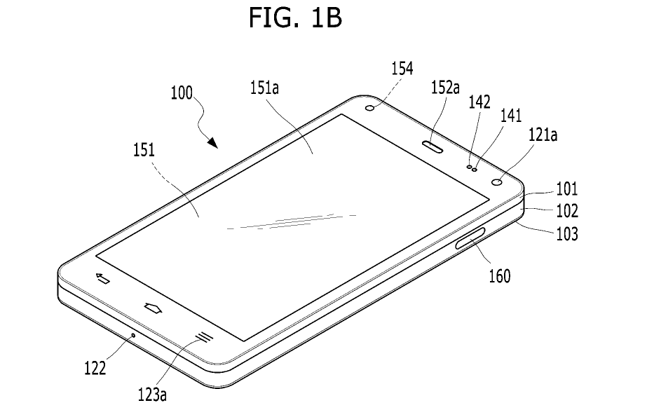

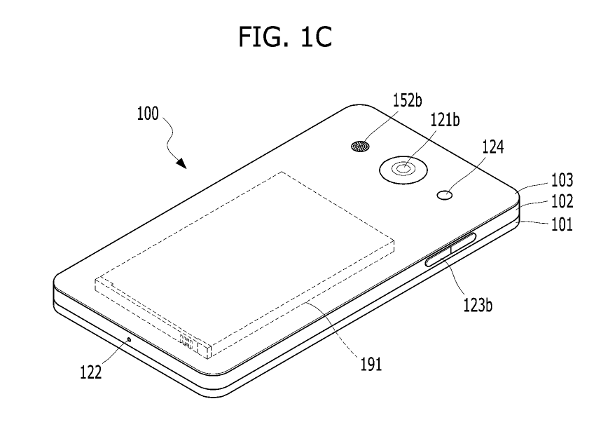

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

And, the sensing unit 140 can further include a brainwave sensor 143. The brainwave sensor 143 can output a brainwave detected from scalp of a user to the brainwave recognition unit 181. In this case, brainwave recognition is to analyze a frequency range, a wave form or pattern, etc. of the detected brainwave. Hence, the brainwave recognition has a meaning different from simply sensing a brainwave. Although the brainwave sensor 143 and the brainwave recognition unit 181 are depicted as separate configurations in FIG. 1a, depending on an embodiment, the brainwave sensor 143 and the brainwave recognition unit 181 can be implemented as a single configuration element. The brainwave sensor 143 can include a contact electrode configured to detect a brainwave in a manner of being directly contacted with scalp of a user or may include a non-contact electrode capable of detecting a brainwave without being directly contacted with scalp of the user. The brainwave sensor 143 includes not only a brainwave sensor of a currently developed form but also a brainwave sensor of a form to be developed in the future. If a configuration is able to sense a brainwave of a user, the configuration may belong to the brainwave sensor 143 of the present invention. A brainwave can be detected by the brainwave sensor 143 embedded in the mobile terminal 100, can be received from an external device via the wireless communication unit 110, or can be received from a wire-connected external device via the interface unit 160. In case of receiving a brainwave via the wireless communication unit 110 or the interface unit 160, it may be not necessary to install the brainwave sensor 143 in the mobile terminal 100. In the present specification, if a brainwave is detected by the brainwave sensor 143, the brainwave sensor 143 can be referred to as a brainwave detection unit. If a brainwave is detected by the wireless communication unit 110, the wireless communication unit 110 can be referred to as a brainwave detection unit. If a brainwave is detected by the interface unit 160, the interface unit 160 can be referred to as a brainwave detection unit. If a brainwave is received from an external device via the wireless communication unit 110, the brainwave can be received via the mobile communication module 112, the wireless internet module 113, or the short-distance communication module 114.

Although it is depicted as the brainwave recognition unit 181 is implemented in the inside of the controller 180 in FIG. 1a, depending on an embodiment, the brainwave recognition unit 181 can be implemented as a configuration separated from the controller 180. Or, in some cases, both the controller 180 and the brainwave recognition unit 181 can be commonly referred to as the controller 180 without being distinguished one from another. In the following, for clarity, assume that recognition of a brainwave received from the brainwave sensor 143 is performed by the brainwave recognition unit 181 and overall controlling of the mobile terminal 100 based on a result of the brainwave recognition is performed by the controller 180.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The memory 170 stores data necessary for the brainwave recognition unit 181 to analyze a brainwave.

A brainwave can be mainly classified into an alpha wave, a beta wave, a theta wave, and a delta wave according to a frequency. The alpha wave is generated when a human closes eyes and relaxes a body and the alpha wave has frequencies between 8 and 13 Hz. The beta wave is mostly generated when a human is awake and the beta wave has frequencies between 14 and 100 Hz. The theta wave is generated when a human is in a light sleep and the theta wave has frequencies (e.g., 4-8 Hz) lower than that of the alpha wave. The theta wave is generated in a boundary state between awareness and dream. The delta wave has frequencies lower than 4 Hz which is lower than the theta wave and the delta wave corresponds to a brainwave mostly measured when a human is in a sleep state or an unconscious state. The memory 170 may store data of brainwaves classified according to a frequency.

And, the memory 170 can also store data on a wave form or a pattern of a brainwave according to human emotions including fright, joy, anger, happiness, delight, depression, and the like. Depending on an embodiment, when a different brainwave occurs for a same emotion according to a race, age, character, and a health condition, data on the brainwave can also be stored in the memory 170.

And, data on a wave from or a pattern which is generated when a human has a specific idea can also be stored in the memory 170. For example, sufficient experience data on a wave form or a pattern, which is generated when a human has such an idea as “volume up”, can be stored in the memory 170.

If a brainwave data corresponding to a specific idea is analyzed, it is able to know a current status of a human (e.g., a thing on which a human is currently concentrating, a current action of a human, etc.).

And, data on a wave form or a pattern generated by a brainwave according to concentration can also be stored in the memory 170. Depending on an embodiment, when a different brainwave occurs for a same concentration according to a race, age, character, and a health condition, data on the brainwave can also be stored in the memory 170.

Depending on an embodiment, the memory 170 can periodically or aperiodically update the brainwave recognition-related data.

The brainwave recognition unit 181 performs signal processing on a brainwave detected by the brainwave sensor 143 and may be able to analyze the brainwave. As an example, in order to analyze the brainwave, the brainwave recognition unit 181 amplifies an electrical signal inputted from the brainwave sensor 143, eliminates an unnecessary component from the amplified signal, converts the signal from which the unnecessary component is eliminated into a digital signal, performs Fourier transform on the digital signal, and calculates an output value of the brainwave according to a frequency. The brainwave recognition unit 181 can analyze a frequency range of the brainwave, a wave form or a pattern of the brainwave, and the like with reference to the data stored in the memory 170. The brainwave recognition unit 181 can identify emotion of a user, an intention of the user, and the like based on a result of the brainwave analysis.

And, in order to increase accuracy of brainwave recognition, the brainwave recognition unit 181 can identify emotion of a user, an intention of the user, and the like with reference to the data stored in the memory 170 based on a type, a function, a current status, and the like of a currently executed application.

The controller 180 generates a prescribed control signal based on the brainwave recognition result of the brainwave recognition unit 181 and may be then able to deliver the control signal to an appropriate configuration element. For example, a brainwave detected by the brainwave sensor 143 is analyzed by the brainwave recognition unit 181. As a result, if it is determined as a frequency and/or a wave form of the detected brainwave is matched with a frequency and/or a wave form of a brainwave which is generated when a user intends “volume up”, the controller 180 can control the audio output unit 152 to output an audio signal by increasing strength of the audio signal.

And, when a prescribed control signal is generated based on a brainwave recognition result, the controller 180 can generate the control signal based on a type, a function, a current status, and the like of a currently executed application to make the generated control signal to be more precisely matched with an intention or emotion of a user.

The memory 170 may store a mapping data between a recognition result of a brainwave and a specific control signal. The controller 180 can generate an appropriate control signal based on the mapping data stored in the memory 170 and the brainwave recognition result of the brainwave recognition unit 181.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

The above discussed some elements performs various embodiments. Furthermore, the control method of the mobile device performs based on at least one operation program stored in the memory (170).

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100.

The wireless Internet module 113 may transmit and/or receive wireless signals via communication networks according to wireless Internet technologies.

Examples of such wireless Internet access include Wireless LAN (WEAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according, to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like).

However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal (100) may include display (151), first/second audio output (152a, 152b), proximity sensor (141), illumination sensor (142), optical output module (154), first/second cameras (121a, 121b), the first and second manipulation units 123a and 123b, microphone (122), interface (160), and so on.

FIGS. 1B and 1C depict certain components as arranged on the mobile terminal. However, it is to be understood that alternative arrangements are possible and within the teachings of the instant disclosure.

Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Furthermore, the present invention can be applied to a flexible display. Hereinafter, the flexible display will be explained in detail.

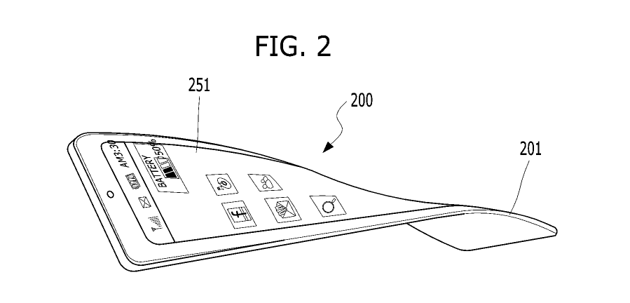

FIG. 2 is a conceptual view of a deformable mobile terminal according to an alternative embodiment of the present invention.

In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming, of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

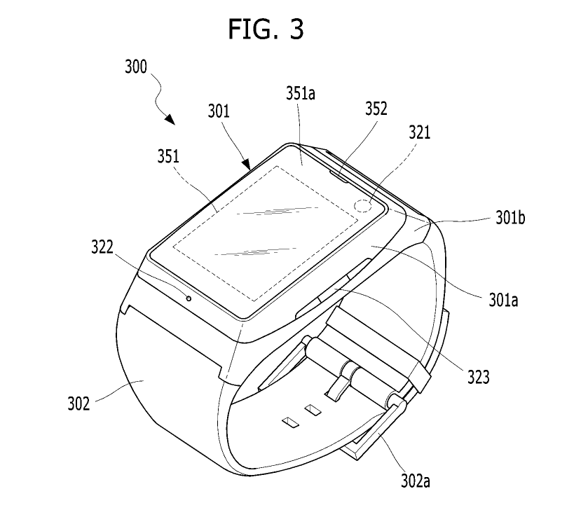

FIG. 3 is a perspective view illustrating one example of a watch-type mobile terminal 300 in accordance with another exemplary embodiment. As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components.

Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

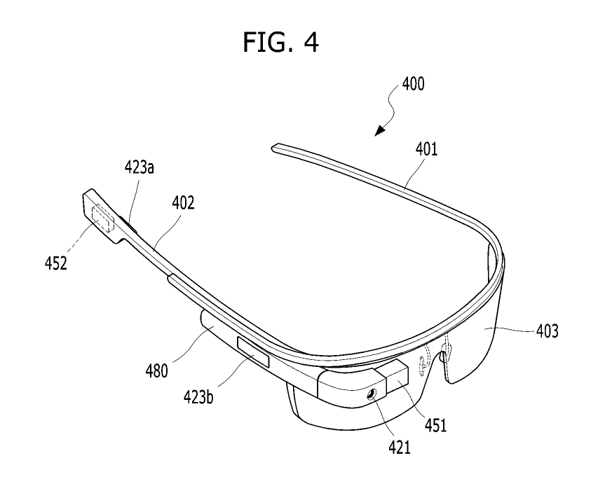

FIG. 4 is a perspective view illustrating one example of a glass-type mobile terminal 400 according to another exemplary embodiment.

The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing.

The camera 421 may be positioned at most any location of the mobile terminal. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

A communication system which is operable with the variously described mobile terminals will now be described in more detail.

Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system.

A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal.

Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

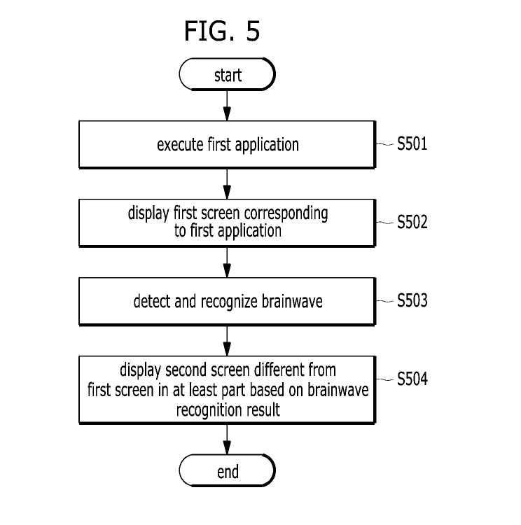

FIG. 5 is a flowchart for an example of a method of controlling a mobile terminal via brainwave recognition according to one embodiment of the present invention. For clarity, a case that a mobile terminal corresponds to the mobile terminal mentioned earlier in FIGS. 1a to 1c is mainly explained. Yet, the mobile terminal may correspond to the mobile terminal 200/300/400 mentioned earlier in FIGS. 2 to 4 depending on an embodiment.

A first application is executed in the mobile terminal 100 [S501]. In this case, execution of the first application can include not only a case of executing the first application by a user by operating the mobile terminal 100 but also a case of automatically triggering the first application due to a call signal reception, a predetermined notification, or the like.

Subsequently, the controller 180 controls the display unit 151 to display a first screen corresponding to the first application [S502]. The first screen corresponding to the first application may correspond to an execution screen at the time of starting the first application or an execution screen corresponding to a state of the first application after prescribed time elapses from the start of the first application.

If a brainwave is detected by the brainwave detection unit, the controller 180 controls the brainwave recognition unit 181 to recognize the detected brainwave [S503]. Specifically, if a brainwave is detected via a brainwave sensor 143 or reception of a brainwave is detected via a wireless communication unit 110 or an interface unit 160, the controller 180 controls the brainwave recognition unit 181 to recognize the brainwave. It is not mandatory to perform the step S503 prior to the step S501 or the step S502. In some cases, the step S503 can be performed with the step S501 or the step S502 in parallel.

The controller 180 controls the display unit 151 to display a second screen, which differs from the first screen in at least a part, based on a brainwave recognition result recognized by the brainwave recognition unit 181 [S504]. In particular, if an intention or emotion of a user is determined based on the brainwave recognition result recognized by the brainwave recognition unit 181, the controller 180 generates a control signal in response to the intention or the emotion of the user to control a corresponding configuration element. The second screen may be different from the first screen in a part only or may be totally different from the first screen.

Depending on an embodiment, the controller 180 can control the display unit 151 and/or the audio output unit 152 to output a guide message for checking whether or not the second screen is displayed before the second screen is displayed on the display unit 151. If the guide message is outputted via the display unit 151, the guide message can be outputted in a form of GUI for receiving a command from a user. If the guide message is outputted via the audio output unit 152, the guide message can be outputted in a form of audio data. If a first command for selecting the display of the second screen is detected, the controller 180 can control the display unit 151 to display the second screen at last. The first command can be detected via a touch screen of the display unit 151 or can be detected via voice recognition based on an audio signal received through the microphone 122. If the first command is detected, the controller 180 is able to learn that the recognized brainwave is matched with the intention of the user intending to display the second screen and the controller 180 can store a result of the learning in the memory 160. On the contrary, if a second command for not selecting the display of the second screen is detected, the controller 180 is able to learn that the recognized brainwave is not matched with the intention of the user related to the display of the second screen. The controller 180 can store a result of the learning in the memory 160. Whenever a specific screen is outputted on the display unit 151 based on a result of brainwave recognition, the controller 180 can output a guide message to check whether or not the output of the specific screen is matched with the intention of the user. A result of user selection according to the output of the guide message can be stored in the memory 160 together with the recognized brainwave. By doing so, it may be able to enhance accuracy of a control signal when the control signal is generated based on brainwave recognition. If the guide message is outputted more than a predetermined count in relation to an identical/similar brainwave, the guide message may not be outputted. And, if a user selects termination of outputting the guide message, the guide message may not be outputted.

The controller 180 can execute a specific function among functions related to the first application based on a brainwave recognition result.

Depending on an embodiment, the controller 180 can control the display unit 151 and/or the audio output unit 152 to output a guide message for checking whether or not the specific function is executed before the specific function is executed. If the guide message is outputted via the display unit 151, the guide message can be outputted in a form of GUI for receiving a command from a user. If the guide message is outputted via the audio output unit 152, the guide message can be outputted in a form of audio data. If a first command for selecting execution of the specific function is detected, the controller 180 can execute the specific function at last. The first command can be detected via a touch screen of the display unit 151 or can be detected via voice recognition based on an audio signal received through the microphone 122. If the first command is detected, the controller 180 is able to learn that the recognized brainwave is matched with the intention of the user intending to execute the specific function and the controller 180 can store a result of the learning in the memory 160. On the contrary, if a second command for not selecting the execution of the specific function is detected, the controller 180 is able to learn that the recognized brainwave is not matched with the intention of the user related to the specific function. The controller 180 can store a result of the learning in the memory 160. Whenever a specific function related to the first application is executed based on a result of brainwave recognition, the controller 180 can output a guide message to check whether or not the execution of the specific function is matched with the intention of the user. A result of user selection according to the output of the guide message can be stored in the memory 160 together with the recognized brainwave. By doing so, it may be able to enhance accuracy of a control signal when the control signal is generated based on brainwave recognition. If the guide message is outputted more than a predetermined count in relation to an identical/similar brainwave, the guide message may not be outputted. And, if a user selects termination of outputting the guide message, the guide message may not be outputted. Depending on an embodiment, if display of the second screen corresponds to the execution of the specific function of the first application, the controller 180 can control the display unit 151 and/or the audio output unit 152 to output a guide message for checking whether or not the specific function is executed before the second screen is displayed and the specific function is executed. If a command for selecting whether or not the specific function is executed is detected, the controller 180 controls the display unit 151 to display the second screen and can execute the specific function.

Depending on an embodiment, when the second screen is displayed on the display unit 151, the controller 180 controls the brainwave detection unit to redetect a brainwave of a user and may control the brainwave recognition unit 181 to recognize the redetected brainwave. After the brainwave is recognized, if it is determined as the redetected brainwave denies a current state, the controller 180 can restore a state that a control obtained by previous brainwave recognition does not exist. On the contrary, after the brainwave is recognized, if it is determined as the redetected brainwave affirms the current state, a control effect obtained by the previous brainwave recognition can be maintained. And, after the brainwave is recognized, if it is determined as the redetected brainwave affirms the current state but does not feel feeling of satisfaction yet, it is able to execute a specific function of the first application towards the increase of a control effect while the control effect obtained by the brainwave recognition is maintained. For example, when it is necessary to switch a screen by three steps in total to execute a first function of a first application, towards the increase of the control effect may indicate to control the first application to make the screen to be sequentially switched by the three steps. If the first function of the first application is related to a numerical change, towards the increase of the control effect may indicate to execute the first function towards the increase of the numerical change. Although it is not specifically explained, the control of the mobile terminal 100 controlled by the redetection and recognition of the brainwave can be similarly applied to all embodiments of the present invention described in the following.

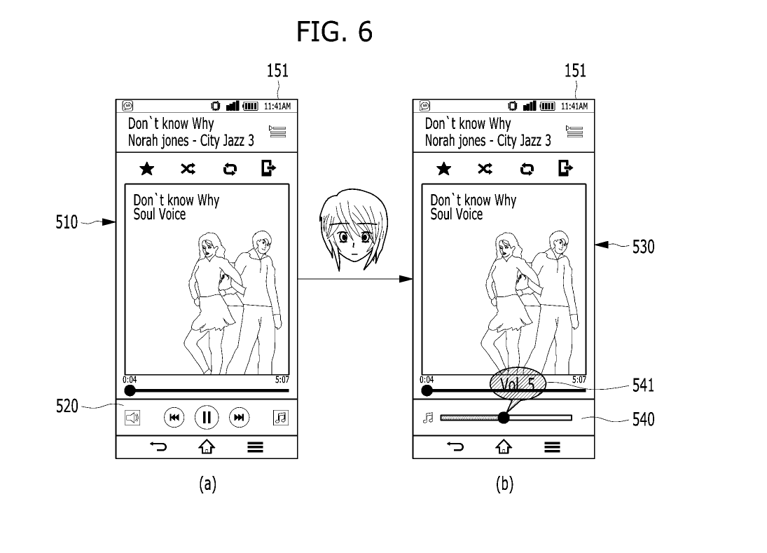

In the following, one embodiment of the present invention mentioned earlier in relation to FIG. 5 is explained in detail with reference to FIGS. 6 to 23.

FIGS. 6 to 8 are diagrams for explaining an example of a method of controlling a mobile terminal via brainwave recognition according to one embodiment of the present invention.

First of all, referring to FIG. 6 (a), a first screen 510 corresponding to a first application is displayed on the display unit 151 of the mobile terminal 100. As an example, the first application is a music playing application. The first screen 510 can include a first GUI 520 for controlling several functions (e.g., pausing, playing a previous song, playing a next song, checking a playlist, etc.) of the first application.

If a brainwave is detected by the brainwave detection unit, the controller 180 controls the brainwave recognition unit 181 to recognize the detected brainwave.

Referring to FIG. 6 (b), after the brainwave is recognized, if it is determined as an intention of a user corresponds to “volume up”, the controller 180 controls the display unit 151 to display a second screen 530 different from the first screen 510 in at least a part based on a result of the brainwave recognition. When the second screen 530 is displayed on the display unit 151, the controller 180 controls the display unit 151 to display a GUI corresponding to a specific function among functions related to the first application based on the brainwave recognition result.

When the first screen 510 and the second screen 530 are compared with each other, it is able to see that a second GUI 540 for controlling a volume adjusting function is included in the second screen 530 among functions of the first application. Since the user wants to increase volume of music in playing, the second GUI 540 for controlling the volume is outputted on the display unit 151 in accordance with the intention of the user.

Moreover, the controller 180 can directly execute the volume adjusting function (i.e., volume up function) among the functions related to the first application based on the brainwave recognition result. In particular, if it is determined as an intention of a user corresponds to “volume up”, the controller 180 can increase volume as much as a predetermined amount while outputting the second screen 530 on the display unit 151.

Depending on an embodiment, the controller 180 can control the display unit 151 to display an indicator 541 indicating a result of the volume adjusting function on the second screen 530. A user is able to identify the increased volume, which is increased according to the brainwave recognition result, via the indicator 541 displayed on the second screen 530.

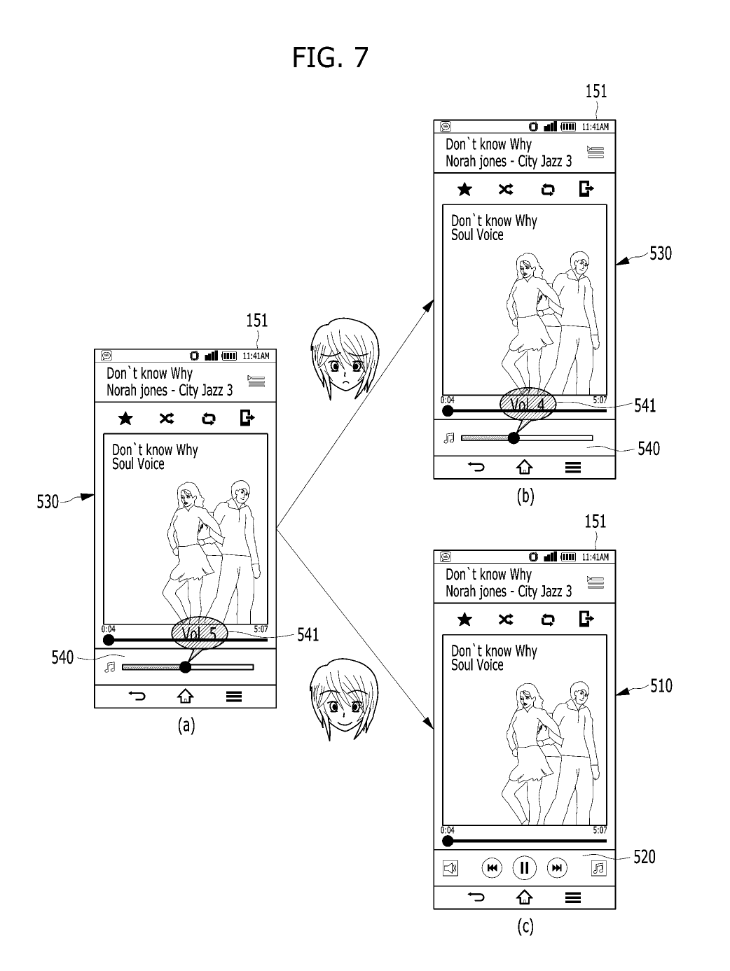

FIG. 7 is a diagram for explaining a situation capable of being occurred after FIG. 6.

First of all, referring to FIGS. 7 (a) and (b), although the controller 180 has executed the volume up function of the first application according to the brain recognition result, the result may not be matched with the intention of the user due to an error of brainwave recognition.

When the second screen 530 is displayed on the display unit 151, the controller 180 controls the brainwave detection unit to redetect a brainwave of the user and can control the brainwave recognition unit 181 to recognize the redetected brainwave.

After the brainwave is recognized, if the redetected brainwave is recognized as a brainwave of a first type, the controller 180 may return to a state of which the volume up function is not executed. In this case, the brainwave of the first type may correspond to a brainwave of a certain range matched with a brainwave of a frequency, a waveform and/or a pattern that appears when a user in a mood of denying a current status. Hence, the volume, which has increased to level 5 (Vol. 5) is return to a volume of level 4 (Vol. 4) corresponding to a previous state. The controller 180 outputs the second screen 530 including a second GUI 540 for controlling the volume adjusting function of the first application on the display unit 151 and can display an indicator 541 on the second screen 530 to indicate that the volume has returned to an original state according to the brainwave recognition result. The controller 180 can control the display unit 151 to display the first screen 510 including the first GUI 520 again after prescribed time elapses.

Or, referring to FIGS. 7 (a) and (c), a result of executing the volume up function of the first application executed by the controller 180 according to the brainwave recognition result may satisfy a user.

When the second screen 530 is displayed on the display unit 151, the controller 180 controls the brainwave detection unit to redetect a brainwave of a user and can control the brainwave recognition unit 181 to recognize the redetected brainwave.

After the brainwave is recognized, if the redetected brainwave is recognized as a brainwave of a second type, the controller 180 may maintain the execution effect of the volume up function and can control the display unit 151 to display the first screen 510 again instead of the second screen 530. In this case, the brainwave of the second type may correspond to a brainwave of a certain range matched with a brainwave of a frequency, a waveform and/or a pattern that appears when a user is in a mood of satisfying a current status.

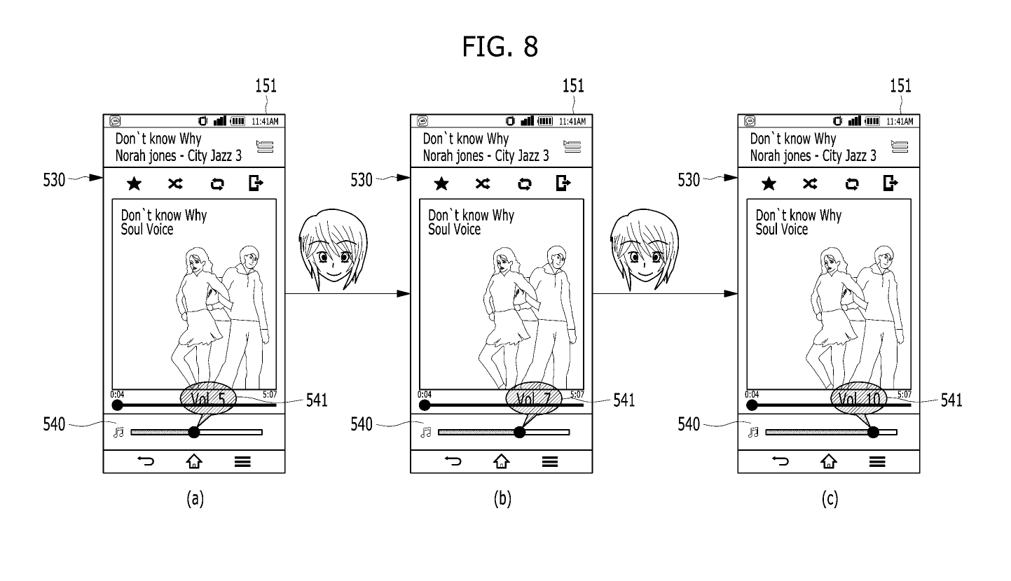

FIG. 8 is a diagram for explaining a situation capable of being occurred after the controller 180 controls the volume up function of the first application according to the brainwave recognition result in FIG. 6.

When the second screen 530 is displayed on the display unit 151, the controller 180 controls the brainwave detection unit to redetect a brainwave of a user and can control the brainwave recognition unit 181 to recognize the redetected brainwave.

After the brainwave is recognized, if the redetected brainwave is recognized as a brainwave of a third type and the brainwave of the third type is continuously detected for more than predetermined time or detected with strength stronger than predetermined strength, the controller 180 can execute a specific function in a direction of increasing an execution effect of the specific function of the first application. In this case, the brainwave of the third type may correspond to a brainwave of a certain range matched with a brainwave of a frequency, a waveform and/or a pattern that appears when a user is in a mood of satisfying a control result controlled by previous brainwave recognition and intending to continuously move forward from a current status. As an example, the brainwave of the third type may correspond to a brainwave that appears when the user is in a mood of strongly affirmative to the control result controlled by the previous brainwave recognition.

If the redetected brainwave is recognized as the brainwave of the third type, the controller 180 executes the volume adjusting function in a direction of increasing the volume. If the brainwave recognized as the brainwave of the third type is continuously detected for more than predetermined time or detected with strength stronger than predetermined strength, the controller can continuously execute the volume adjusting function in a direction of increasing the volume. The controller 180 can execute the volume adjusting function in the direction of increasing the volume until the brainwave of the third type is not detected. The controller 180 outputs the second screen 530 including a second GUI 540 for controlling the volume adjusting function of the first application on the display unit 151 and display an indicator 541 on the second screen 530 to indicate that the volume is increasing according to the brainwave recognition result.

In FIG. 8, a case that the specific function corresponds to the volume adjusting function has been explained as an example. For example, if the specific function is related to a numerical change such as a screen brightness adjusting function, a next song playing function, a previous song playing function, and the like (if the specific function corresponds to the next song playing function or the previous song playing function, the numerical change indicates the number of skipped songs), the contents mentioned earlier in FIG. 8 can be similarly applied.

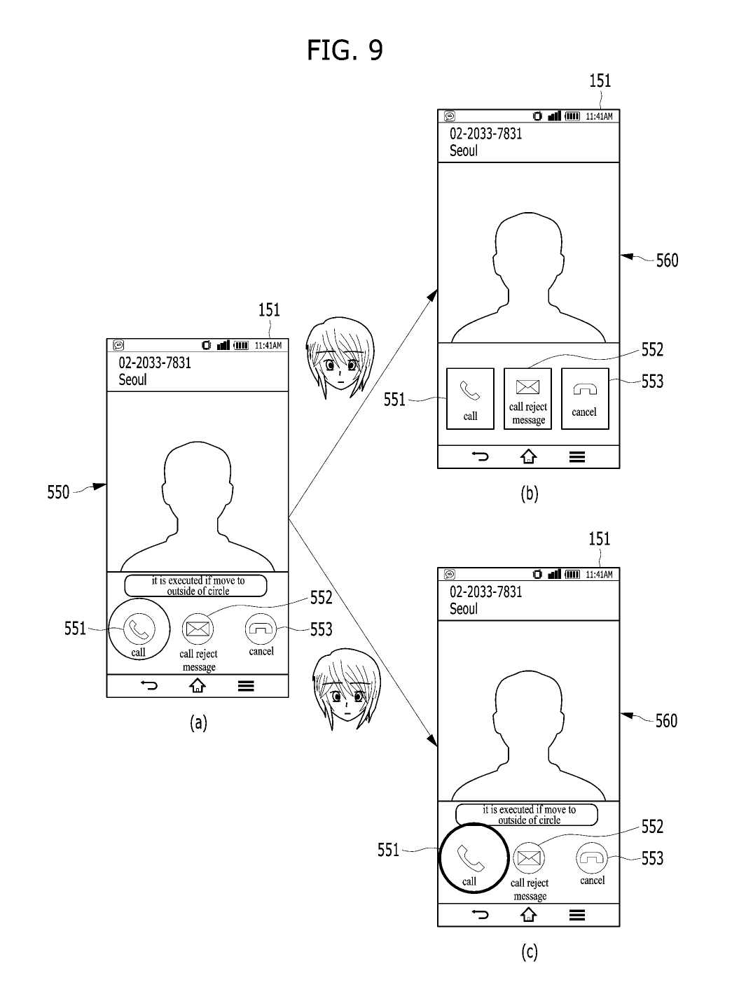

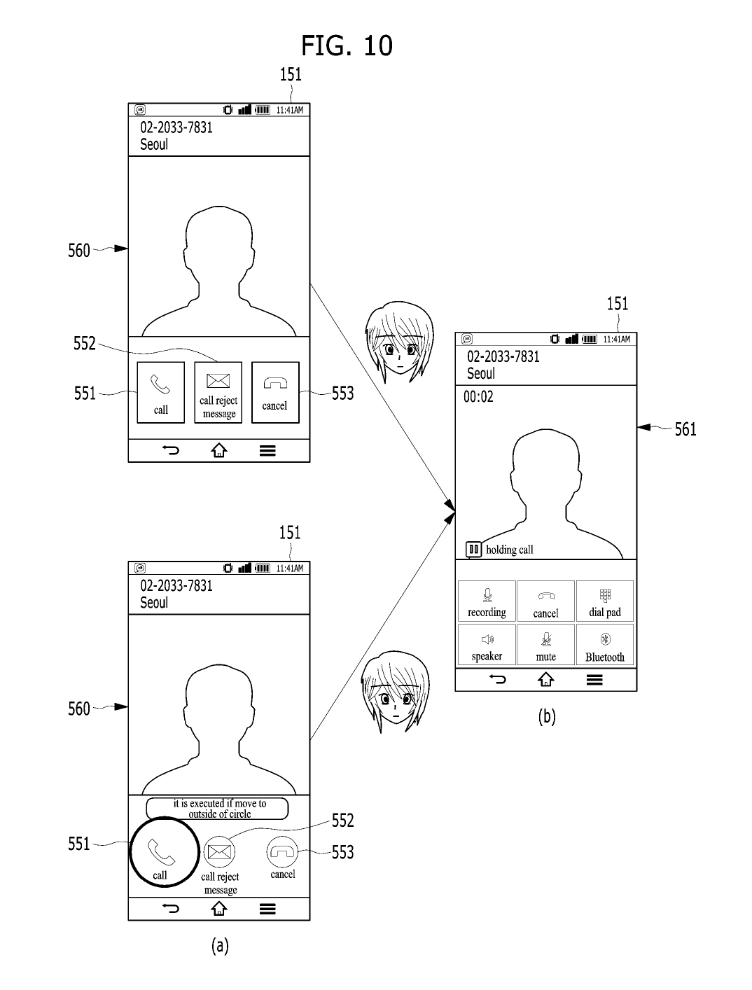

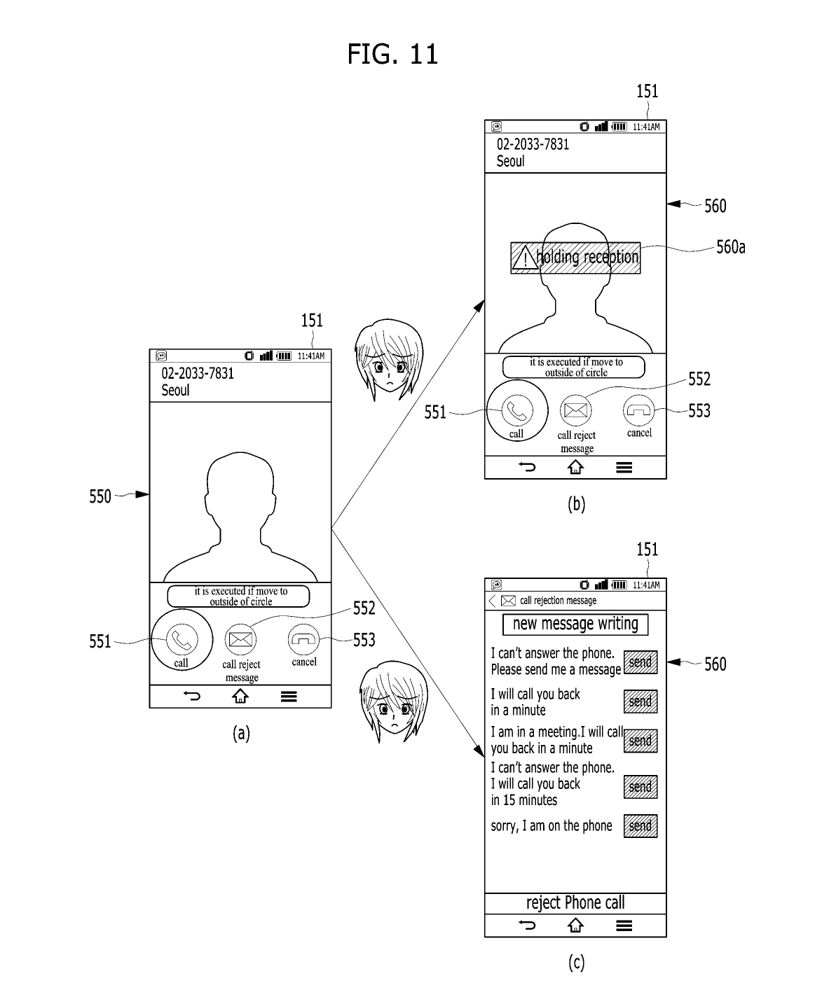

FIGS. 9 to 11 are diagrams for explaining a different example of a method of controlling a mobile terminal via brainwave recognition according to one embodiment of the present invention.

First of all, referring to FIG. 9 (a), a first screen 550 corresponding to a first application is displayed on the display unit 151 of the mobile terminal 100. As an example, the first application is a calling application and the application can be triggered by receiving a call signal.

As an example, the first screen 550 can include a first menu icon 551 corresponding to an answering function, a second menu icon 552 corresponding to a function of sending a phone call denial message, and a third menu icon 553 corresponding to a phone call denial function. The first icon menu to the third menu icon 551/552/553 included in the first screen 550 can be configured to be accessed by a touch and drag scheme. For example, a user can execute the answering function by dragging the first menu icon 551 in a random direction while touching the first menu icon 551.

If a brainwave is detected by the brainwave detection unit, the controller 180 controls the brainwave recognition unit 181 to recognize the detected brainwave.

After the brainwave is recognized, if it is determined as an intention of a user corresponds to “answering phone”, the controller 180 controls the display unit 151 to display a second screen 560 different from the first screen 550 in at least a part based on a result of the brainwave recognition.

As an example, referring to FIG. 9 (b), unlike the first screen 550, the first icon menu to the third menu icon 551/552/553 included in the second screen 560 can be configured to be accessed by a tap scheme instead of the touch and drag scheme. For example, a user can execute the answering function by lightly tapping the first menu icon 551 included in the second screen 560. Since it is determined as the intention of the user corresponds to the “answering phone” based on the brainwave recognition, the controller 180 outputs the second screen 560 including the menu icons capable of more conveniently accessing the answering function using the tap scheme on the display unit 151.

As a different example, referring to FIG. 9 (c), among the first menu icon to the third menu icon 551/552/553 included in the second screen 560, the first menu icon 551 corresponding to the answering function, which is related to the brainwave recognition result, can be displayed on the second screen 560 in a manner of being magnified. By doing so, a user can more easily access the answering function.

FIG. 9 (b) and FIG. 9 (c) are just an example only. The controller 180 can control the display unit 151 to display the menu icons included in the first screen 550 in a manner of changing at least one selected from the group consisting of a size, a shape, a location and array of the menu icons based on the brainwave recognition result.

FIG. 10 is a diagram for explaining a situation capable of being occurred after FIG. 9.

Referring to FIG. 10 (a), when the second screen 560 is displayed on the display unit 151, the controller 180 controls the brainwave detection unit to redetect a brainwave of a user and can control the brainwave recognition unit 181 to recognize the redetected brainwave.

After the brainwave is recognized, if the redetected brainwave is recognized as a brainwave of a first type, the controller 180 can control the answering function of the first application to be executed. In this case, the brainwave of the first type may correspond to a brainwave that appears when a user is affirmative to a current status or a brainwave of a certain range matched with a brainwave of a frequency, a waveform and/or a pattern that appears when a user intends to perform “answering phone”.

The controller 180 controls the answering phone function of the first application to be executed and can control the display unit 151 to display a third screen 561 corresponding to the answering phone function. In particular, if the brainwave that appears when a user intends to perform “answering phone” is continuously detected for more than predetermined time, the controller 180 outputs the second screen 560 on the display unit 151 and may be then able to display the third screen 561 by executing the answering phone function. If the brainwave that appears when a user intends to perform “answering phone” is detected, the controller outputs the second screen 560 on the display unit 151. If a brainwave that appears when a user is affirmative to a current status is detected, the controller can output the third screen 561 on the display unit 151 by executing the answering phone function.

Unlike FIG. 9, FIG. 11 is a diagram for explaining an example for a case that a user intends to reject a phone call.

Referring to FIG. 11 (a), a first screen 550 corresponding to a first application is displayed on the display unit 151 of the mobile terminal 100. As an example, the first application is a calling application and the application can be triggered by receiving a call signal.

If a brainwave is detected by the brainwave detection unit, the controller 180 controls the brainwave recognition unit 181 to recognize the detected brainwave.

After the brainwave is recognized, if it is determined as an intention of a user corresponds to “reject phone call”, the controller 180 controls the display unit 151 to display a second screen 560 different from the first screen 550 in at least a part based on a result of the brainwave recognition.

As an example, referring to FIG. 11 (b), the controller 180 can control the first application to postpone call signal reception based on the brainwave recognition result that intends “reject phone call”. In this case, postponing the call signal reception may indicate a state that a sound notification or a vibration notification is canceled while a state of receiving a call signal is maintained. Depending on an embodiment, a message 560a for notifying reception postponement can be included in the second screen 560 as an indicator indicating a control result based on the brainwave recognition result.

As a different example, referring to FIG. 11 (c), the controller 180 can control the first application to execute a function of sending a phone call rejection message corresponding to the second menu icon 552 based on the brainwave recognition result that intends “reject phone call”. A list of phone call rejection messages stored in advance is included in the second screen 560. Depending on an embodiment, when a brainwave is redetected and recognized, if it is determined as an intention of a user is to transmit a random rejection message in the list of the phone call rejection messages, the controller can control a mobile communication module 112 to transmit the random rejection message to a mobile terminal of a counterpart.

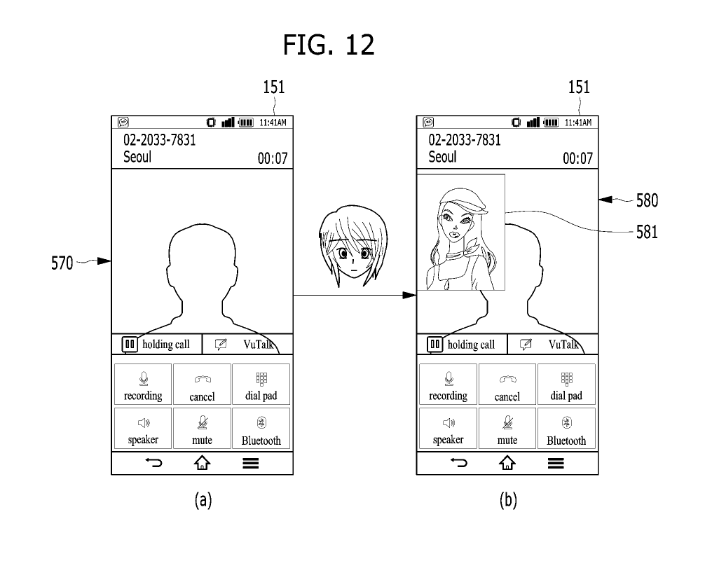

Meanwhile, it may be able to execute a second application related to the first application via brainwave recognition in a state that the first application is executed in the mobile terminal 100. Regarding this, it is explained in the following with reference to FIG. 12.

FIG. 12 is a diagram for explaining a further different example of a method of controlling a mobile terminal via brainwave recognition in the mobile terminal according to one embodiment of the present invention.

First of all, referring to FIG. 12 (a), a first screen 570 corresponding to a first application is displayed on the display unit 151 of the mobile terminal 100. As an example, the first application is a calling application.

If a brainwave is detected by the brainwave detection unit, the controller 180 controls the brainwave recognition unit 181 to recognize the detected brainwave.

After the brainwave is recognized, if it is determined as an intention of a user corresponds to “video call”, the controller 180 controls the display unit 151 to display a second screen 580 different from the first screen 570 in at least a part based on a result of the brainwave recognition. Specifically, the controller 180 can control the display unit 151 to display the second screen 580 including an execution screen of a camera application related to the “video call” among applications related to the first application as a sub screen 581 based on the brainwave recognition result that intends the “video call”.

In this case, the controller 180 may operate in two ways.

First of all, the controller 180 executes the camera application (or activates the camera 121) based on the brainwave recognition result intending the “video call” and may be able to control a video call function to be executed among functions of the calling application. The sub screen 581 corresponds to a preview image obtained by the camera 121a and the sub screen is continuously displayed on the second screen 580 while the video call is made.

Secondly, the controller 180 executes the camera application (or activates the camera 121) based on the brainwave recognition result intending the “video call” and may be able to control a preview image obtained by the camera 121a to be outputted on the second screen 580 during prescribed time as the sub screen 581. In this case, the video call function of the calling application is not executed yet and the subs screen 581 is outputted for prescribed time. By doing so, a user can check a state of the user via the sub screen 581 before the video call function is executed in earnest.

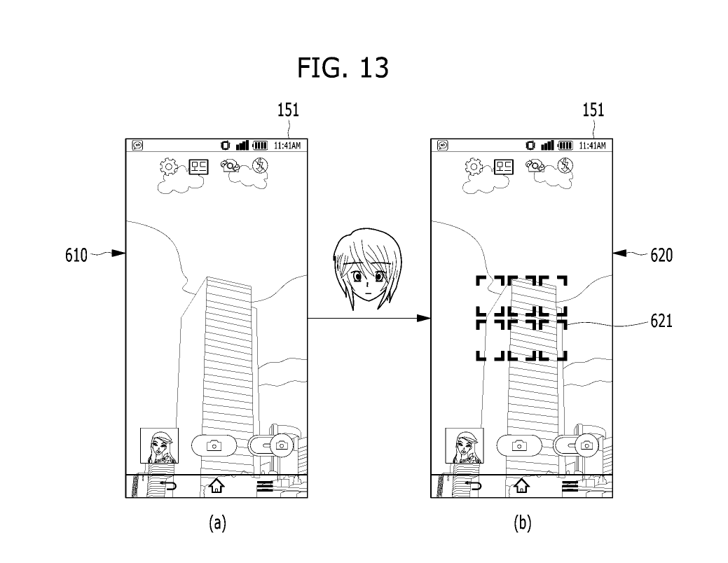

FIG. 13 is a diagram for explaining a further different example of a method of controlling a mobile terminal via brainwave recognition according to one embodiment of the present invention.

First of all, referring to FIG. 13 (a), a first screen 610 corresponding to a first application is displayed on the display unit 151 of the mobile terminal 100. As an example, the first application is a camera application and the first screen 610 may correspond to a preview image obtained by the camera 121.

If a brainwave is detected by the brainwave detection unit, the controller 180 controls the brainwave recognition unit 181 to recognize the detected brainwave.

After the brainwave is recognized, if it is determined as an intention of a user corresponds to “capturing picture”, the controller 180 controls the display unit 151 to display a second screen 620 different from the first screen 610 in at least a part based on a result of the brainwave recognition. The controller 180 executes a specific function related to the first application based on the brainwave recognition result and can control the display unit 151 to display an indicator indicating an execution result of the specific function.

As an example, referring to FIG. 13 (b), the controller 180 can control a focusing function to be executed among functions of the camera application based on the brainwave recognition result and can output an indicator 621 indicating an execution result of the focusing function on the display unit 151. A user is able to identify that the focusing function is executed as a prior step of capturing a picture based on the brainwave recognition result via the indicator 621 outputted on the second screen 620.

Depending on an embodiment, when the second screen 620 is displayed on the display unit 151, the controller 180 controls the brainwave detection unit to redetect a brainwave of a user and can control the brainwave recognition unit 181 to recognize the redetected brainwave. After the brainwave is recognized, if the redetected brainwave is recognized as a brainwave of a first type, the controller 180 can control a picture capturing function of the camera application to be executed. In this case, the brainwave of the first type may correspond to a brainwave that appears when a user is affirmative to a current status or a brainwave of a certain range matched with a brainwave of a frequency, a waveform and/or a pattern that appears when a user intends to perform “capturing picture”. If the picture capturing function of the camera application is executed, an image captured by the camera 121 can be displayed on the display unit 151.

On the contrary, after the brainwave is recognized, if the redetected brainwave is recognized as a brainwave of a second type, the controller 180 may return to a state that the focusing function is not controlled. In this case, the brainwave of the second type may correspond to a brainwave of a certain range matched with a brainwave of a frequency, a waveform and/or a pattern that appears when a user is negative to a current status. In particular, if a result of the first brainwave recognition is not matched with an intention of a user due to an error or the intention of the user changes, a redetected brainwave can be recognized as the brainwave of the second type. In this case, as shown in FIG. 13 (a), a preview image can be displayed on the display unit 151.

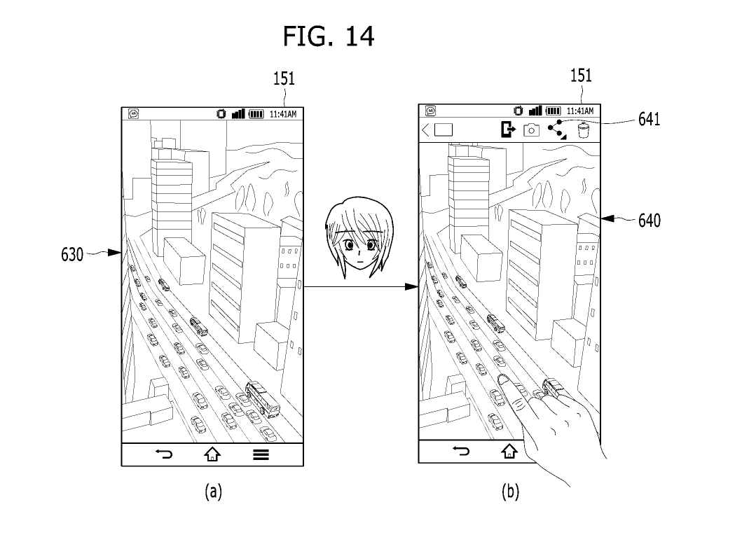

FIG. 14 is a diagram for explaining a further different example of a method of controlling a mobile terminal via brainwave recognition according to one embodiment of the present invention.

First of all, referring to FIG. 14 (a), a first screen 630 corresponding to a first application is displayed on the display unit 151 of the mobile terminal 100. As an example, the first application is a gallery application and the first screen 630 may correspond to an image stored in the gallery application.

If a brainwave is detected by the brainwave detection unit, the controller 180 controls the brainwave recognition unit 181 to recognize the detected brainwave.

After the brainwave is recognized, if it is determined as an intention of a user corresponds to “picture sharing”, the controller 180 controls the display unit 151 to display a second screen 640 different from the first screen 630 in at least a part based on a result of the brainwave recognition. When the second screen 640 is displayed on the display unit 151, the controller 180 can control the display unit 151 to display GUI corresponding to a specific function among functions related to the first application. And, the controller 180 executes a specific function among functions related to the first application based on the brainwave recognition result and can control the display unit 151 to display an indicator indicating an execution result of the specific function on the second screen 640. In some cases, the GUI corresponding to the specific function is identical to the indicator.

As an example, referring to FIG. 14 (b), the controller 180 can control the display unit 151 to display GUI 641 for performing a picture sharing function among functions related to the gallery application based on the brainwave recognition result. In FIG. 14, a case that a user intends to perform “picture sharing” is explained as an example. The contents mentioned above in relation to FIG. 4 can be identically applied to various functions of the gallery application including a picture editing function, a picture deleting function, a detail information checking function, a picture moving function, and the like.

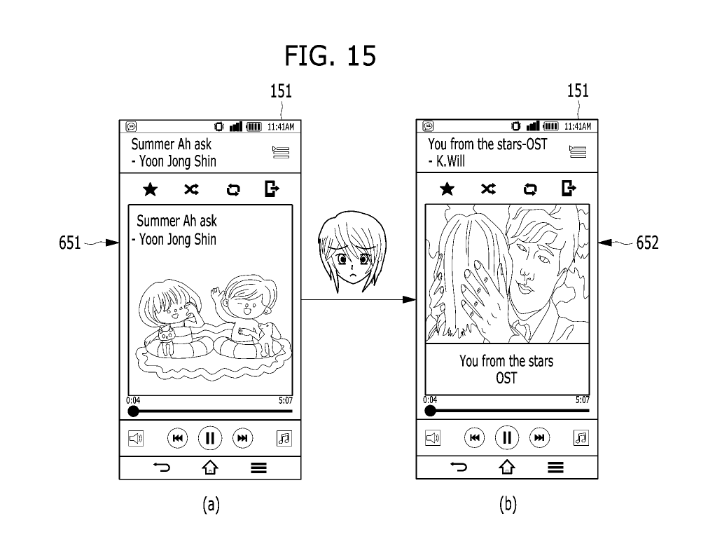

FIG. 15 is a diagram for explaining a further different example of a method of controlling a mobile terminal via brainwave recognition according to one embodiment of the present invention.

First of all, referring to FIG. 15 (a), a first screen 651 corresponding to a first application is displayed on the display unit 151 of the mobile terminal 100. As an example, the first application is a music playing application and the first screen 651 may correspond to a playback screen of a music file stored in the music playing application.

If a brainwave is detected by the brainwave detection unit, the controller 180 controls the brainwave recognition unit 181 to recognize the detected brainwave.

After the brainwave is recognized, if it is determined as the detected brainwave corresponds to a brainwave of a first type, the controller 180 controls the display unit 151 to display a second screen 652 different from the first screen 651 in at least a part based on a result of the brainwave recognition. In this case, the brainwave of the first type may correspond to a brainwave of a certain range matched with a brainwave of a frequency, a waveform and/or a pattern that appears when a user is negative to a current status. The controller 180 executes a specific function among functions related to the first application based on the brainwave recognition result and can control the display unit 151 to display an indicator indicating an execution result of the specific function on the second screen 652.

As an example, referring to FIG. 15 (b), the controller 180 can control a next song playing function to be executed among functions of music playing application based on the brainwave recognition result and can control the display unit 151 to output an image corresponding to a next song as the second screen 652. And, the controller 180 can control the audio output unit 152 to output an audio signal corresponding to the next song.

Depending on an embodiment, when the second screen 652 is displayed on the display unit 151, the controller 180 controls the brainwave detection unit to redetect a brainwave of a user and can control the brainwave recognition unit 181 to recognize the redetected brainwave. After the brainwave is recognized, if the redetected brainwave is recognized as a brainwave of a second type, the controller 180 may return to a state that the next song playing function is not controlled. In this case, the brainwave of the second type may correspond to a brainwave of a certain range matched with a brainwave of a frequency, a waveform and/or a pattern that appears when a user is negative to a current status. In particular, if a result of the first brainwave recognition is not matched with an intention of a user due to an error or the intention of the user changes, a redetected brainwave can be recognized as the brainwave of the second type. In this case, as shown in FIG. 15 (a), the display unit 151 displays the first screen 651 and the audio output unit 152 outputs an audio signal corresponding to an image of the first screen 651.

On the contrary, after the brainwave is recognized, if the redetected brainwave is recognized as a brainwave of a third type, the controller 180 maintains a control effect of the next song playing function and can execute the next song playing function in a direction of increasing the control effect of the next song playing function. In this case, the brainwave of the third type may correspond to a brainwave of a certain range matched with a brainwave of a frequency, a waveform and/or a pattern that appears when a user is in a mood of satisfying a control result controlled by previous brainwave recognition and intending to continuously move forward from a current status. As an example, the brainwave of the third type may correspond to a brainwave that appears when the user is in a mood of strongly affirmative to the control result controlled by the previous brainwave recognition. In particular, as shown in FIG. 15 (b), the controller 180 controls the display unit 151 to display an image corresponding to a next song of a song corresponding to an image of the second screen 652 and can control the audio output unit 152 to output an audio signal corresponding to a next song of a song corresponding to an image of the second screen 652.

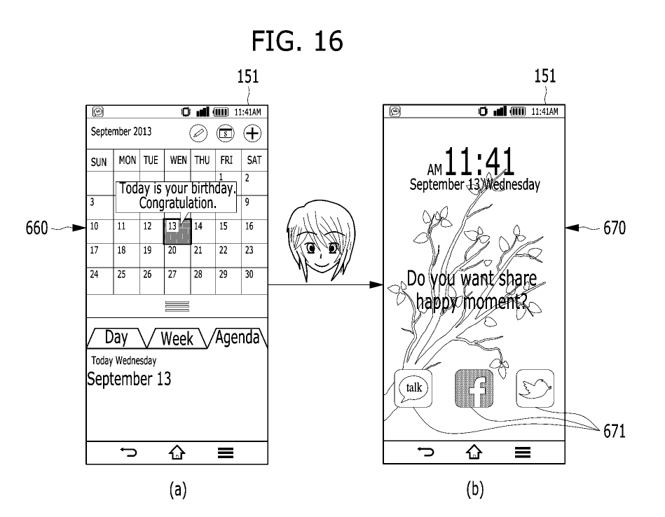

FIG. 16 is a diagram for explaining a further different example of a method of controlling a mobile terminal via brainwave recognition according to one embodiment of the present invention.

First of all, referring to FIG. 16 (a), a first screen 660 corresponding to a first application is displayed on the display unit 151 of the mobile terminal 100. As an example, the first application may correspond to a calendar application and the first screen 660 may correspond to a screen that appears when time corresponding to a schedule registered at the calendar application arrives while execution of the first application is triggered.

If a brainwave is detected by the brainwave detection unit, the controller 180 controls the brainwave recognition unit 181 to recognize the detected brainwave.

After the brainwave is recognized, if it is determined as a user is in a mood of very happy or satisfying a current status, the controller 180 controls the display unit 151 to display a second screen 670 different from the first screen 660 in at least a part based on a result of the brainwave recognition. When the second screen 670 is displayed on the display unit 151, the controller 180 can control the display unit 151 to display GUI corresponding to a second application related to the first application based on information related to the first application. In this case, the second application related to the first application may correspond to a preconfigured application capable of being interlocked with the first application.

As an example, referring to FIG. 16 (b), the controller 180 can determine that a user currently intends to share emotion of the user with an acquaintance based on information registered at the calendar application (today is registered as birthday) and a brainwave recognition result (happiness, sense of satisfaction). Hence, the controller 180 can control the display unit 151 to display GUI 671 of an SNS application (social networking) service application related to the calendar application on the second screen 670.

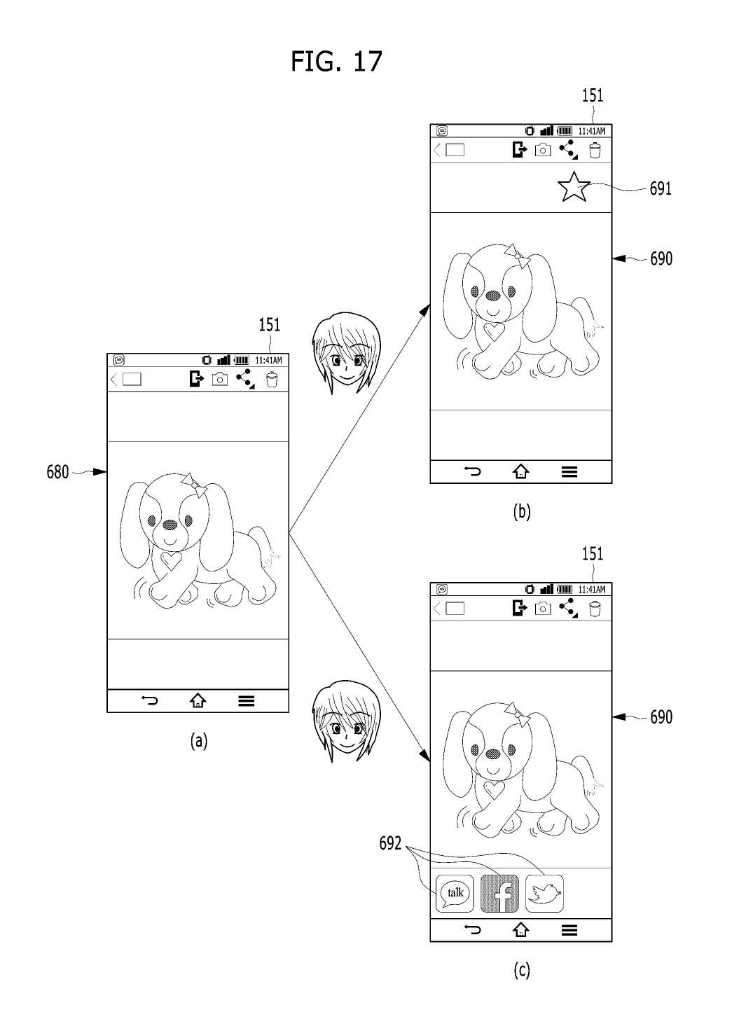

FIG. 17 is a diagram for explaining a further different example of a method of controlling a mobile terminal via brainwave recognition according to one embodiment of the present invention.

First of all, referring to FIG. 17 (a), a first screen 680 corresponding to a first application is displayed on the display unit 151 of the mobile terminal 100. As an example, the first application is a gallery application and the first screen 680 may correspond to an image stored in the gallery application.

If a brainwave is detected by the brainwave detection unit, the controller 180 controls the brainwave recognition unit 181 to recognize the detected brainwave.

After the brainwave is recognized, if it is determined as a user is in a mood of satisfying with an image of the first screen 680, the controller 180 controls the display unit 151 to display a second screen 690 different from the first screen 680 in at least a part based on a result of the brainwave recognition. When the second screen 690 is displayed on the display unit 151, the controller 180 can control the display unit 151 to display an indicator indicating an execution result of a specific function among functions related to the first application or GUI corresponding to a second application related to the first application.

As an example, referring to FIG. 17 (b), the controller 180 controls a bookmark adding function to be executed among functions related to the gallery application and can control the display unit 151 to display an indicator 691 indicating an execution result of the bookmark adding function on the second screen 690.

As a different example, referring to FIG. 17 (c), the controller 180 can control the display unit 151 to display GUI 692 corresponding to an SNS application related to the gallery application on the second screen 690 based on the brainwave recognition result. In this case, the SNS application related to the gallery application may correspond to a preconfigured application capable of being interlocked with the gallery application. A user selects a random application from the GUI 692 of the SNS application to share a corresponding image with an acquaintance.

Depending on an embodiment, in FIG. 17 (c), the controller 180 controls the brainwave detection unit to redetect a brainwave of a user and can control the brainwave recognition unit 181 to recognize the redetected brainwave. After the brainwave is recognized, if the redetected brainwave is recognized as a brainwave of a first type, the controller 180 executes a specific SNS application based on the brainwave recognition result and can control the display unit 151 to display an execution screen of the specific SNS application.

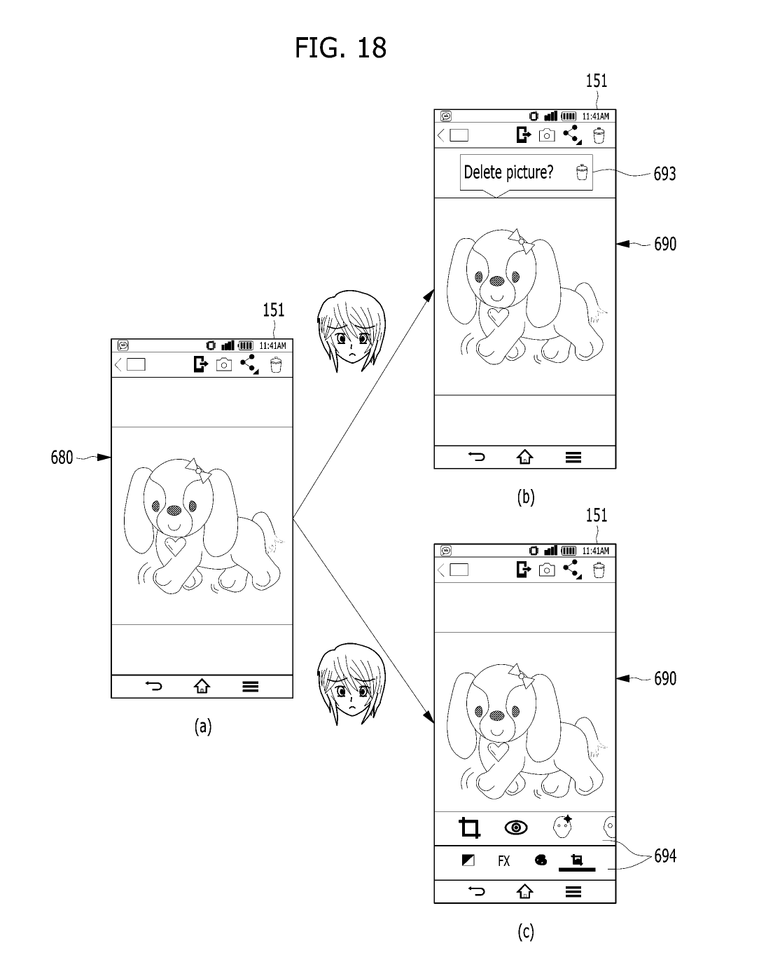

FIG. 18 is a diagram for explaining a further different example of a method of controlling a mobile terminal via brainwave recognition according to one embodiment of the present invention.

First of all, referring to FIG. 18 (a), a first screen 680 corresponding to a first application is displayed on the display unit 151 of the mobile terminal 100. As an example, the first application is a gallery application and the first screen 680 may correspond to an image stored in the gallery application.

If a brainwave is detected by the brainwave detection unit, the controller 180 controls the brainwave recognition unit 181 to recognize the detected brainwave.

After the brainwave is recognized, if it is determined as a user is in a mood of not satisfying with an image of the first screen 680, the controller 180 controls the display unit 151 to display a second screen 690 different from the first screen 680 in at least a part based on a result of the brainwave recognition. When the second screen 690 is displayed on the display unit 151, the controller 180 can control the display unit 151 to display an indicator indicating an execution result of a specific function among functions related to the first application or can control the display unit 151 to display GUI corresponding to a specific function among functions related to the first application. In some cases, the indicator may be identical to the GUI corresponding to the specific function.

As an example, referring to FIG. 18 (b), the controller 180 can control the display unit 151 to display GUI 693 corresponding to a picture deleting function among functions related to the gallery application on the second screen 690 based on the brainwave recognition result.

As a different example, referring to FIG. 18 (c), the controller 180 can control the display unit 151 to display GUI 694 corresponding to a picture editing function among functions related to the gallery application on the second screen 690 based on the brainwave recognition result.

Depending on an embodiment, in FIG. 17 (b), the controller 180 controls the brainwave detection unit to redetect a brainwave of a user and can control the brainwave recognition unit 181 to recognize the redetected brainwave. After the brainwave is recognized, if the redetected brainwave is recognized as a brainwave of a first type, the controller 180 can control a corresponding image to be deleted from the gallery application. In this case, the brainwave of the first type may correspond to a brainwave of a certain range matched with a brainwave of a frequency, a waveform and/or a pattern that appears when a user is in a mood of satisfying with a control result controlled by previous brainwave recognition and intending to continuously move forward from a current status.

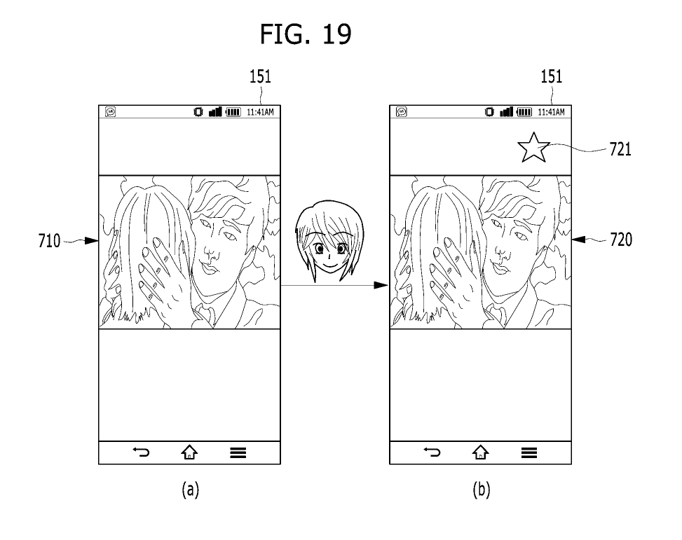

FIG. 19 is a diagram for explaining a further different example of a method of controlling a mobile terminal via brainwave recognition according to one embodiment of the present invention.

First of all, referring to FIG. 19 (a), a first screen 710 corresponding to a first application is displayed on the display unit 151 of the mobile terminal 100. As an example, the first application is a video playing application and the first screen 710 may correspond to a video data at random timing of contents played by the video playing application.

If a brainwave is detected by the brainwave detection unit, the controller 180 controls the brainwave recognition unit 181 to recognize the detected brainwave.

After the brainwave is recognized, if it is determined as a user is in a mood of satisfying with a current status, the controller 180 controls the display unit 151 to display a second screen 720 different from the first screen 710 in at least a part based on a result of the brainwave recognition. When the second screen 720 is displayed, the controller 180 can control the display unit 151 to display an indicator indicating an execution result of a specific function among functions related to the first application.

As an example, referring to FIG. 19 (b), the controller 180 controls a bookmark function to be executed among functions related to the video playing application based on the brainwave recognition result and can control the display unit 151 to display an indicator 721 indicating an execution result of the bookmark function on the second screen 720. A user can replay a bookmarked scene only.

Or, if the first application corresponds to a web-based application instead of the video playing application and the first screen 710 corresponds to a video data of contents streamed from an external server via a mobile communication module 112 or a short distance communication module 113, the controller 180 may be able to capture the first screen 710 or add a URL corresponding to the contents to the bookmark.

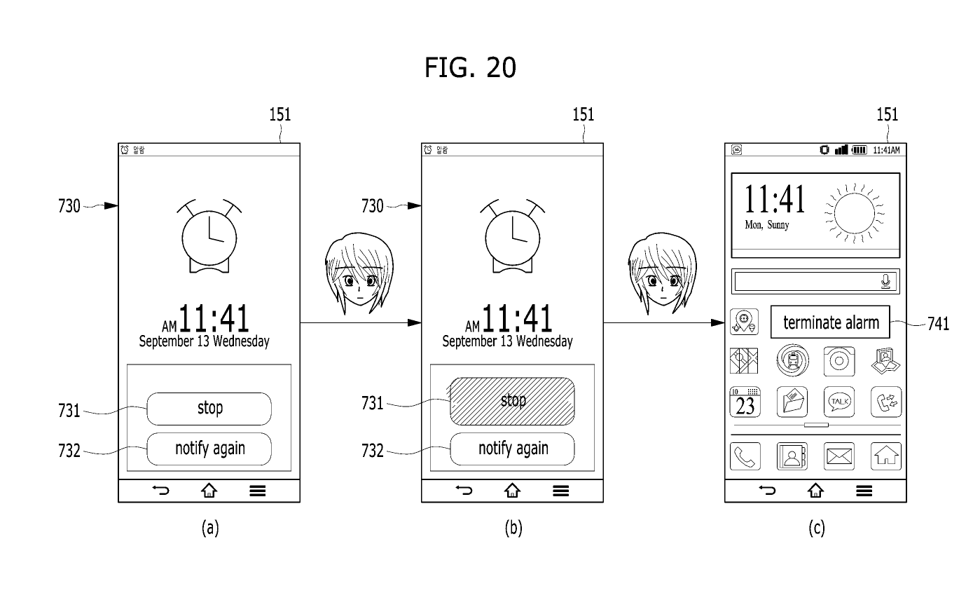

FIG. 20 is a diagram for explaining a further different example of a method of controlling a mobile terminal via brainwave recognition according to one embodiment of the present invention.

First of all, referring to FIG. 20 (a), a first screen 730 corresponding to a first application is displayed on the display unit 151 of the mobile terminal 100. As an example, the first application is an alarm application and the alarm application can be triggered at predetermined time by an alarm configuration.

As an example, the first screen 730 can include a first menu icon 731 corresponding to an alarm termination function and a second menu icon 732 corresponding to a function of alarming again after predetermined time elapses (snooze function). In general, when alarm rings, assume that the first menu icon 731 and the second menu icon 732 are displayed by a same size.

If a brainwave is detected by the brainwave detection unit, the controller 180 controls the brainwave recognition unit 181 to recognize the detected brainwave.

After the brainwave is recognized, if it is determined as an intention of a user corresponds to “terminating alarm”, the controller 180 controls the display unit 151 to display a second screen 740 different from the first screen 730 in at least a part based on a result of the brainwave recognition.

As an example, referring to FIG. 20 (b), among the first menu icon 731 and the second menu icon 732 included in the second screen 740, unlike the first menu icon 731 displayed on the first screen 730, the first menu icon 731 corresponding to the alarm termination function related to the brainwave recognition result can be displayed on the second screen 740 in a manner of being magnified. By doing so, a user can more easily access the alarm termination function.

FIG. 20 (b) is just an example only. The controller 180 can control the display unit 151 to display the menu icons included in the first screen 730 in a manner of changing at least one selected from the group consisting of a size, a shape, a location and array of the menu icons based on the brainwave recognition result.

When the second screen 740 is displayed on the display unit 151, the controller 180 controls the brainwave detection unit to redetect a brainwave of the user and can control the brainwave recognition unit 181 to recognize the redetected brainwave.

After the brainwave is recognized, if the redetected brainwave is recognized as a brainwave of a first type, the controller 180 may control the alarm termination function of the alarm application to be executed. In this case, the brainwave of the first type may correspond to a brainwave of a certain range matched with a brainwave of a frequency, a waveform and/or a pattern that appears when a user intends “alarm termination”.

Referring to FIG. 20 (c), the controller 180 controls the alarm terminal function of the alarm application to be executed and can control the display unit 151 to display an indicator 741 indicating an execution result of the alarm termination function.

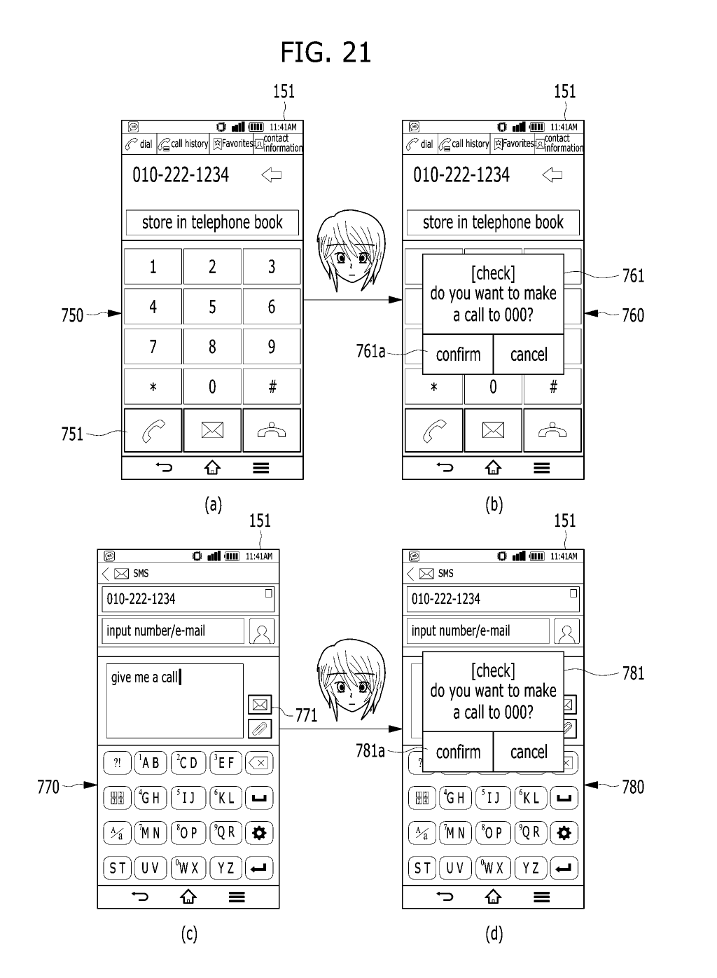

FIG. 21 is a diagram for explaining a further different example of a method of controlling a mobile terminal via brainwave recognition according to one embodiment of the present invention.

First of all, referring to FIG. 21 (a), a first screen 750 corresponding to a first application is displayed on the display unit 151 of the mobile terminal 100. As an example, the first application is a calling application and a user intends to make a call using the calling application.

If a brainwave is detected by the brainwave detection unit, the controller 180 controls the brainwave recognition unit 181 to recognize the detected brainwave. After the brainwave is recognized, assume that a user is in a state incapable of clearly making a decision since the user is in a drunken state or the like.

If the user selects a call menu icon 751 on a first screen 750 and a command for transmitting a call signal is detected, the controller 180 controls the display unit 151 to display a second screen 760 different from the first screen 750 in at least a part based on a result of the brainwave recognition.

As an example, referring to FIG. 21 (b), the controller 180 can control the display unit 151 to display a first GUI 761 on the second screen 760 to check an intention of a user again before a call signal is transmitted according to the command for transmitting the call signal. This is aimed at preventing such an accident as making a call to others by mistake when thinking of the user is not normal. If a confirm menu 761a in the first GUI 761 is selected, the controller 180 transmits a call signal according to the command for transmitting the call signal. If the confirm menu 761a in the first GUI 761 is not selected, the controller 180 can temporarily keep contents of which the transmission of the call signal is postponed to enable a user to check the contents later.

FIGS. 21 (c) and (d) show an example for a case that the first application corresponds to a text message application.

First of all, referring to FIG. 21 (c), a first screen 770 corresponding to the text message application is displayed on the display unit 151 of the mobile terminal 100. A user intends to send a text message using the text message application.

If a brainwave is detected by the brainwave detection unit, the controller 180 controls the brainwave recognition unit 181 to recognize the detected brainwave. After the brainwave is recognized, assume that a user is in a state incapable of clearly making a decision since the user is in a drunken state or the like.

If the user selects a transmission menu icon 771 on a first screen 770 and a command for sending a text message is detected, the controller 180 controls the display unit 151 to display a second screen 780 different from the first screen 770 in at least a part based on a result of the brainwave recognition.

As an example, referring to FIG. 21 (d), the controller 180 can control the display unit 151 to display a second GUI 781 on the second screen 780 to check an intention of a user again before a text message is transmitted according to the command for sending the text message. If a confirm menu 781a in the second GUI 781 is selected, the controller 180 transmits a text message according to the command for sending the text message. If the confirm menu 781a in the second GUI 781 is not selected, the controller 180 can temporarily keep contents of which the transmission of the text message is postponed to enable a user to check the contents later.

In FIGS. 6 to 23, a case that a mobile terminal corresponds to the mobile terminal mentioned earlier in FIGS. 1a to 1c is explained as an example. Yet, it is apparent that the aforementioned embodiments can be similarly applied to a case that a mobile terminal corresponds to the mobile terminal 200/300/400 mentioned earlier in FIGS. 2 to 4.

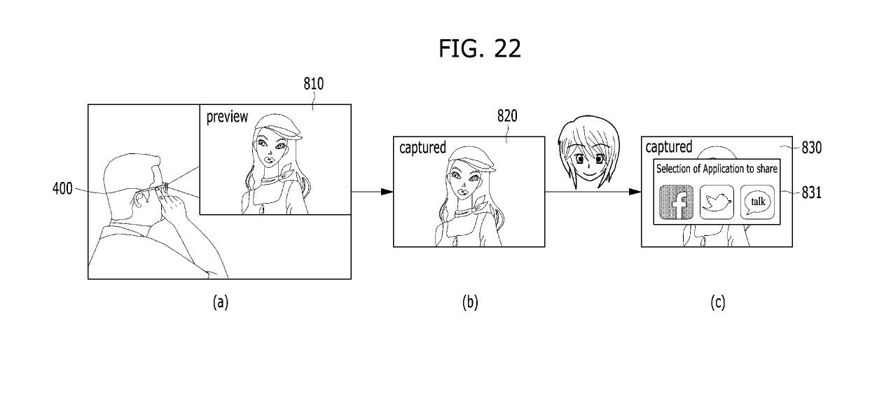

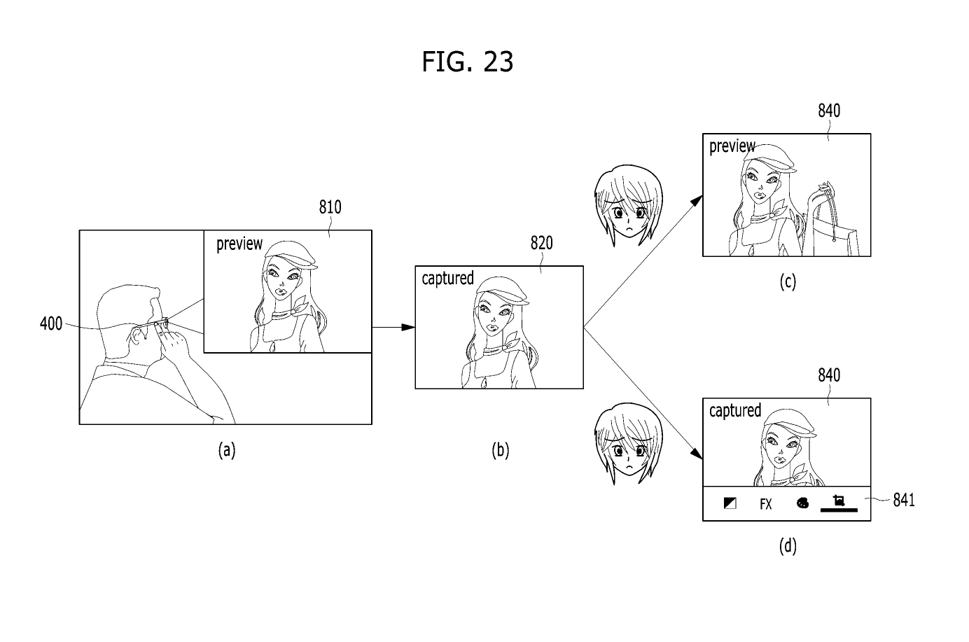

FIGS. 22 to 23 are diagrams for explaining a further different of a method of controlling a mobile terminal via brainwave recognition according to a different embodiment of the present invention. In FIG. 22, a case that a mobile terminal corresponds to the mobile terminal 400 mentioned earlier in FIG. 4 is explained as an example, by which the present invention may be non-limited.

First of all, referring to FIG. 22 (a) and FIG. 23 (a), a screen corresponding to a first application is displayed on a display unit 451 of the mobile terminal 400. As an example, the first application is a camera application and a preview image 810 captured by a camera 421 is displayed on the display unit 451.

Referring to FIGS. 22 (b) and 23 (b), if a command for capturing a picture is detected, a control module 480 control the display unit 451 to display an image captured by the camera 421. The captured image is referred to as a first screen 820. The command can be directly received from a user via a user input unit 423a/423b. Or, the command can be automatically generated by the control module 480 in a manner of reflecting a brainwave recognition result to the command when an intention of the user is determined as an intention of taking a picture based on the brainwave recognition result.

If a brainwave is detected by the brainwave detection unit, the control module 480 controls the brainwave recognition unit to recognize the detected brainwave. Assume that the brainwave detection unit and the brainwave recognition unit are installed in the control module 480 in the mobile terminal 400.

After the brainwave is recognized, if it is determined as a user is in a mood of satisfying with a captured image, the control module 480 controls the display unit 451 to display a second screen 830 different from the first screen 820 in at least a part based on a result of the brainwave recognition.

As an example, referring to FIG. 22 (c), the control module 480 can control the display unit 451 to display GUI 831 corresponding to an SNS application related to the camera application on the second screen 830. The SNS application related to the gallery application may correspond to a preconfigured application capable of being interlocked with the gallery application. A user selects a random application from the GUI 831 corresponding to the SNS application to share the image with an acquaintance.

On the contrary, after the brainwave is recognized, if it is determined as a user is not satisfied with the capture image of the first screen 820, the control module 480 controls the display unit 451 to display a second screen 840 different from the first screen 820 in at least a part based on a result of the brainwave recognition.

As an example, referring to FIG. 23 (c), the control module 480 can control a picture deleting function to be executed among functions related to the camera application based on the brainwave recognition result. In particular, the control module 480 can control the display unit 451 to delete the captured image and display the second screen 840 corresponding to a preview image captured by the camera 421.

As a different example, referring to FIG. 23 (d), the control module 480 can control a picture editing function to be executed among functions related to the camera application based on the brainwave recognition result. In particular, the control module 480 can control the display unit 451 to display GUI 841 corresponding to the picture editing function on the second screen 840.

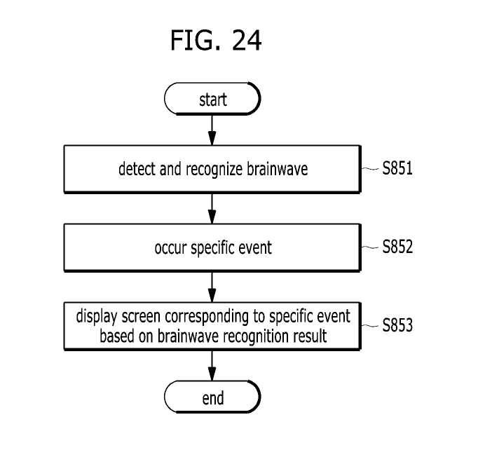

FIG. 24 is a flowchart for an example of a method of controlling a mobile terminal via brainwave recognition according to a different embodiment of the present invention. For clarity, a case that a mobile terminal corresponds to the mobile terminal mentioned earlier in FIGS. 1a to 1c is mainly explained. Yet, a mobile terminal may correspond to the mobile terminal 200/300/400 mentioned earlier in FIGS. 2 to 4 depending on an embodiment.

If a brainwave is detected by the brainwave detection unit, the controller 180 of the mobile terminal 100 controls the brainwave recognition unit 181 to recognize the detected brainwave [S851].

Subsequently, the controller 180 detects occurrence of a specific event [S852]. In this case, the occurrence of the specific event can include at least one selected from the group consisting of call signal reception detection, text message reception detection, notification occurrence detection, on signal detection detected by the display unit 150, detection detected by a proximity sensor 141, and detection of an execution signal of a specific application. The notification occurrence detection is to detect time at which a predetermined alarm is expected to ring arrives.

The controller 180 controls the display unit 151 to display a screen corresponding to the specific event based on the brainwave recognition result [S853]. The screen corresponding to the specific event corresponds to a first screen preconfigured to be displayed according to the brainwave recognition result when the specific event occurs in a brainwave detection mode for detecting a brainwave. At least a part of the first screen may be different from a second screen preconfigured to be displayed when the specific event occurs in a normal mode not detecting a brainwave (i.e., in a state that a brainwave detecting function is deactivated).

Depending on an embodiment, the step S851 and the step S852 can be performed in a manner of being overlapped with each other in at least a part. Or, the step S852 can be preferentially performed prior to the step S851.

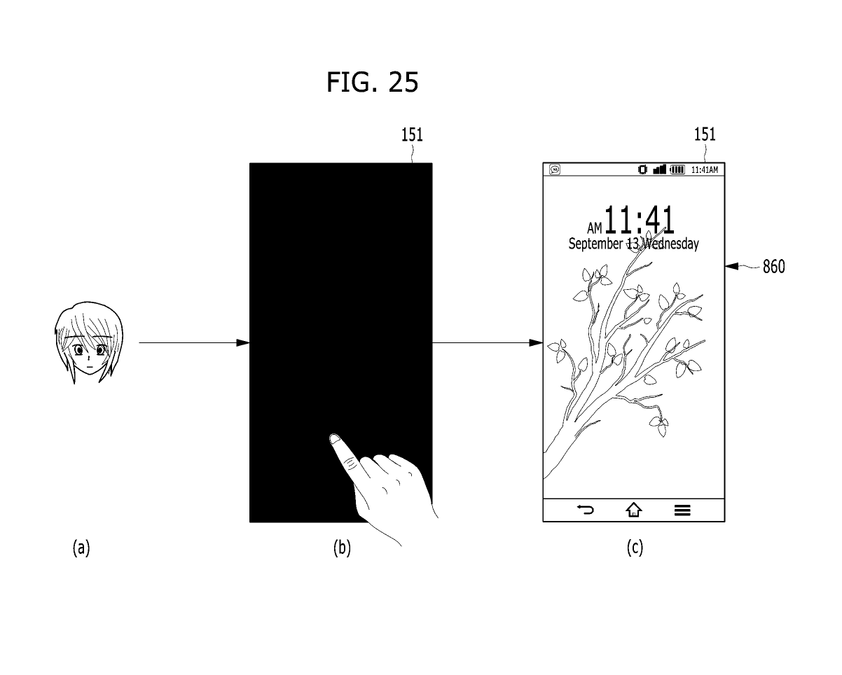

In the following, a different embodiment of the present invention mentioned earlier in relation to FIG. 24 is explained in detail with reference to FIGS. 25 to 33.

FIG. 25 is a diagram for explaining an example of a method of controlling a mobile terminal via brainwave recognition according to a different embodiment of the present invention.

Referring to FIG. 25 (a), if a brainwave is detected by the brainwave detection unit, the controller 180 controls the brainwave recognition unit 181 to recognize the detected brainwave. After the brainwave is recognized, assume that it is determined as an intention of a user corresponds to “checking time”.

Referring to FIG. 25 (b), the controller 180 detects occurrence of a specific event. In this case, the occurrence of the specific event can be detected by a proximity sensor 141. The proximity sensor 141 may be able to detect a proximity touch of a part of a body of a user located at a touch screen. In particular, when a user approaches to the mobile terminal 100 using a part of a body of the user to use the mobile terminal 100, if a proximity touch is detected by the proximity sensor 141, it can be determined as a specific event has occurred. For example, if it is determined as an intention of a user corresponds to “checking time”, the controller 180 turns on the proximity sensor 141 and may be then able to monitor whether or not the specific event occurs. As an example, in order to quickly identify the intention of the user intending to use the mobile terminal 100, the proximity sensor 141 can be respectively mounted on the top and the bottom of the front side of the mobile terminal 100.

The controller 180 can determine that the user intends to check time via the mobile terminal 100 based on the brainwave recognition result and the occurrence of the specific event.

Referring to FIG. 25 (c), the controller 180 controls the display unit 151 to turn on the display unit 151 and display a first screen 860 corresponding to the specific event based on the brainwave recognition result and the occurrence of the specific event.

In general, when the display unit 151 is turned on, a screen firstly displayed on the display unit 151 is referred to as a first home screen and a screen displayed by touching and eliminating the first home screen is referred to as a second home screen. If a lock function is set to the mobile terminal 100, the first home screen may correspond to a screen including current time together with a lock pattern input window or a password input window. If the lock function is not set to the mobile terminal 100, the first home screen may correspond to a screen including current time. The second home screen may correspond to a main home screen including current time and icons of applications.

As an example, the first screen 860 may correspond to the first home screen.

Depending on an embodiment, when the first screen 860 is displayed on the display unit 151, the controller 180 controls the brainwave detection unit to redetect a brainwave of the user and can control the brainwave recognition unit 181 to recognize the redetected brainwave.

After the brainwave is recognized, if the redetected brainwave is recognized as a brainwave of a first type, the controller 180 may return to a state that the display unit 151 is not turned on by the brainwave recognition. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type. In this case, the display unit 151 is turned off and the proximity sensor 141 is also turned off.

On the contrary, after the brainwave is recognized, if the redetected brainwave is recognized as a brainwave of a second type, the controller 180 may control the display unit 151 to display the second home screen (not depicted) instead of the first home screen 860. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

And, although it is not depicted, a second mobile terminal 100 can be controlled via a first mobile terminal 400 to display the first screen 860 on the display unit 151 of the first mobile terminal 100. FIGS. 25 (a) and (b) can be performed in the first mobile terminal 400 of a glass type. For example, when a brainwave is recognized in the first mobile terminal 400, if it is determined as an intention of a user corresponds to “checking time” and the second mobile terminal 100 is included in a preview image captured by a camera 421 of the first mobile terminal 400, a control module 480 of the first mobile terminal 400 can determine it as the user intends to check current time via the second mobile terminal 100. In this case, if the preview image captured by the camera 421 of the first mobile terminal 400 includes the second mobile terminal 100, it may correspond to occurrence of the specific event. The control module 480 of the first mobile terminal 400 generates a control signal for turning on the display unit 151 of the second mobile terminal 100 and transmits the generated control signal to the second mobile terminal 100. The controller 180 of the second mobile terminal 100 controls the wireless communication unit 110 to receive the control signal and may be able to make the display unit 151 to be activated according to the control signal. In the present example, assume that the first mobile terminal 400 and the second mobile terminal 100 are paired with each other.

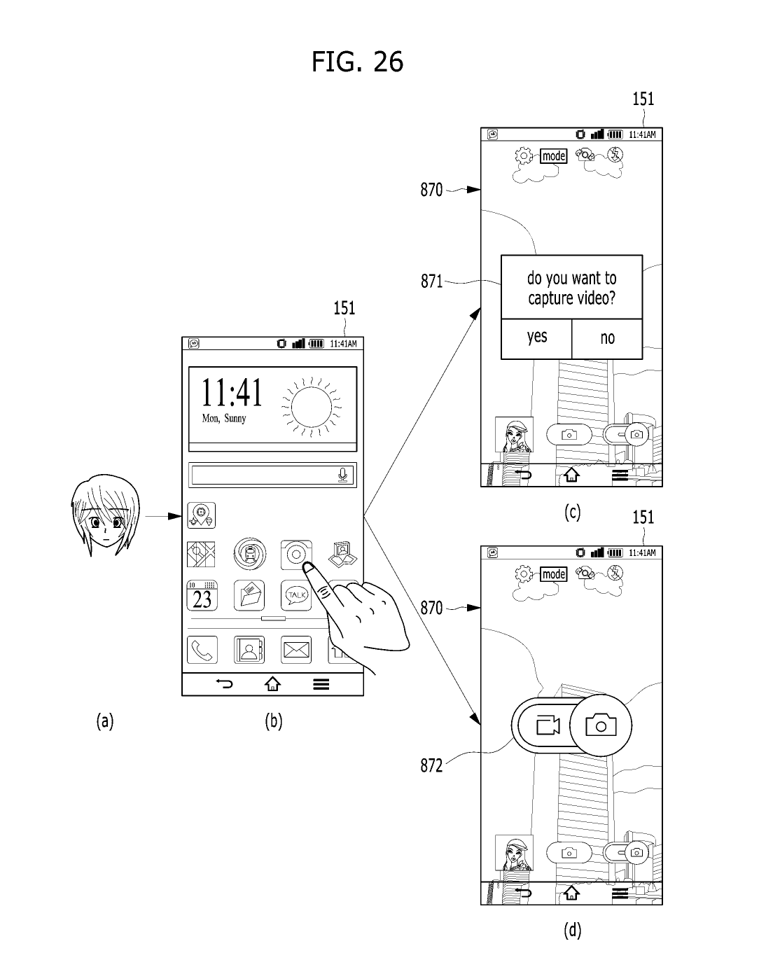

FIG. 26 is a diagram for explaining a different example of a method of controlling a mobile terminal via brainwave recognition according to a different embodiment of the present invention.

Referring to FIG. 26 (a), if a brainwave is detected by the brainwave detection unit, the controller 180 controls the brainwave recognition unit 181 to recognize the detected brainwave. After the brainwave is recognized, assume that it is determined as an intention of a user corresponds to “video capturing”.

Referring to FIG. 26 (b), the controller 180 detects occurrence of a specific event. In this case, the occurrence of the specific event may correspond to detecting an execution signal of a camera application.

The controller 180 can identify an intention of a user intending to capture a video using a camera application based on a brainwave recognition result and the occurrence of the specific event.

The controller 180 executes the camera application based on the brainwave recognition result and the occurrence of the specific event and can control the display unit 151 to display a first screen 870 corresponding to the specific event. The first screen corresponding to the specific event may correspond to an execution screen of the camera application to which the brainwave recognition result is reflected.

As an example, referring to FIG. 26 (c), the first screen 870 displayed on the display unit 151 may correspond to a screen that a first GUI 871 for selecting a video capturing function is displayed on a preview image obtained by a camera 121. The first GUI 871 may have a message form that asks whether or not the video capturing function is selected.

As a different example, referring to FIG. 26 (d), a second screen 870 displayed on the display unit 151 may correspond to a screen that a second GUI 872 for selecting a video capturing function is displayed on a preview image obtained by a camera 121. The second GUI 872 may have a graphic form that induces a user to select one of a video capturing function and a still image capturing function.

At least a part of the first screen 870 may be different from the second screen (not depicted) preconfigured to be displayed in a normal mode not detecting a brainwave when the specific event occurs. In the normal mode in which a brainwave is not detected, if the specific event occurs, a preview image obtained by the camera 121 is displayed on the display unit 151.

Depending on an embodiment, when the first screen 870 is displayed on the display unit 151, the controller 180 controls the brainwave detection unit to redetect a brainwave and can control the brainwave recognition unit 181 to recognize the redetected brainwave.

After the brainwave is recognized, if the redetected brainwave is recognized as a brainwave of a first type, the controller 180 can control the display unit 151 to display the second screen instead of the first screen 870. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 controls a video capturing function to be executed and may be able to control the display unit 151 to display a screen corresponding to a state in which the video capturing function is executed. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

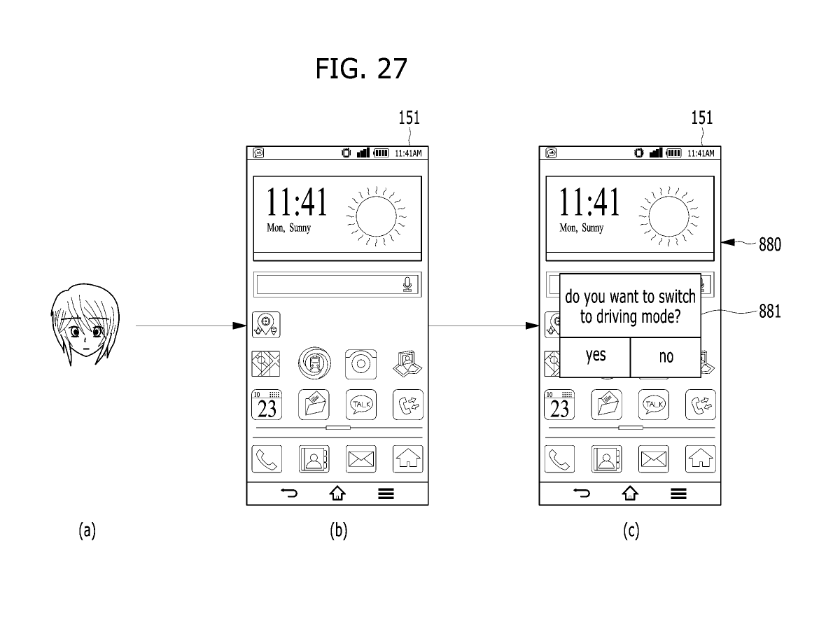

FIG. 27 is a diagram for explaining a further different example of a method of controlling a mobile terminal via brainwave recognition according to a different embodiment of the present invention.

Referring to FIG. 27 (a), if a brainwave is detected by the brainwave detection unit, the controller 180 controls the brainwave recognition unit 181 to recognize the detected brainwave. After the brainwave is recognized, assume that it is determined as an intention of a user corresponds to “driving”.

Referring to FIG. 27 (b), the controller 180 detects occurrence of a specific event. In this case, the occurrence of the specific event may correspond to detection of an on signal detected by the display unit 151 or detection of a proximity sensor 141. The proximity sensor 141 may be able to detect a proximity touch of a part of a body of a user located at a touch screen. For example, if it is determined as a user intends to perform “driving”, the controller 180 turns the proximity sensor 141 on and may be able to monitor whether or not the specific event occurs.

The controller 180 can determine that a user is going to drive a car and there is a chance for the user to use the mobile terminal 100 while driving based on the brainwave recognition result and the occurrence of the specific event.

Referring to FIG. 27 (c), the controller 180 controls the display unit 151 to display a first screen 880 corresponding to the specific event based on the brainwave recognition result and the occurrence of the specific event. If the occurrence of the specific event is detected by the proximity sensor 141, the controller 180 can activate the display unit 151 first before the first screen 880 is displayed on the display unit 151.

As an example, the first screen 880 displayed on the display unit 151 may correspond to a screen on which a first GUI 881 is displayed to select a mode configured to switch to a driving mode from a main home screen.

At least a part of the first screen 880 may be different from the second screen (not depicted) preconfigured to be displayed in a normal mode not detecting a brainwave when the specific event occurs. If the occurrence of the specific event corresponds to detection of an on signal of the display unit 151, in the normal mode in which a brainwave is not detected, a main home screen can be displayed on the display unit 151 when the specific event occurs.

Depending on an embodiment, when the first screen 880 is displayed on the display unit 151, the controller 180 controls the brainwave detection unit to redetect a brainwave and can control the brainwave recognition unit 181 to recognize the redetected brainwave.

After the brainwave is recognized, if the redetected brainwave is recognized as a brainwave of a first type, the controller 180 can control the display unit 151 to display the second screen instead of the first screen 880. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 controls a driving mode to be executed and may be able to control the display unit 151 to display a screen corresponding to a state in which the driving mode is executed. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

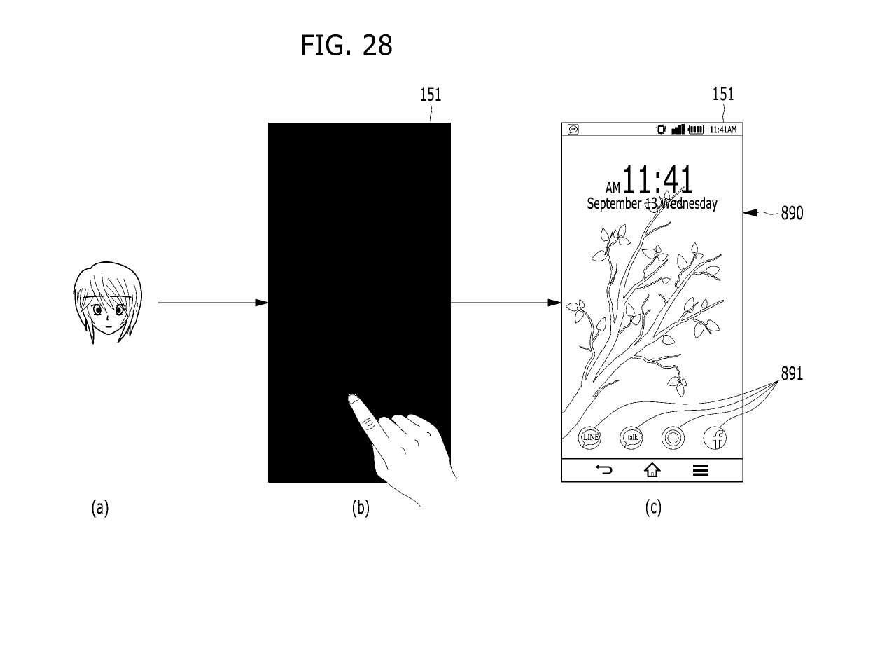

FIG. 28 is a diagram for explaining a further different example of a method of controlling a mobile terminal via brainwave recognition according to a different embodiment of the present invention.

Referring to FIG. 28 (a), if a brainwave is detected by the brainwave detection unit, the controller 180 controls the brainwave recognition unit 181 to recognize the detected brainwave. After the brainwave is recognized, assume that it is determined as an intention of a user corresponds to “using SNS application” or “conversation with acquaintance”.

Referring to FIG. 28 (b), the controller 180 detects occurrence of a specific event. In this case, the occurrence of the specific event may correspond to detection of an on signal detected by the display unit 151 or detection of a proximity sensor 141. The proximity sensor 141 may be able to detect a proximity touch of a part of a body of a user located at a touch screen. For example, if it is determined as a user intends to perform “using SNS application” or “conversation with acquaintance”, the controller 180 turns the proximity sensor 141 on and may be able to monitor whether or not the specific event occurs.

The controller 180 can determine that a user intends to share daily life with an acquaintance via an SNS application of the mobile terminal 100 based on the brainwave recognition result and the occurrence of the specific event.

Referring to FIG. 28 (c), the controller 180 controls the display unit 151 to display a first screen 890 corresponding to the specific event based on the brainwave recognition result and the occurrence of the specific event. If the occurrence of the specific event is detected by the proximity sensor 141, the controller 180 can activate the display unit 151 first before the first screen 890 is displayed on the display unit 151.

As an example, the first screen 890 displayed on the display unit 151 may correspond to the first home screen on which a first GUI 891 corresponding to SNS applications is displayed.

At least a part of the first screen 890 may be different from the second screen (not depicted) preconfigured to be displayed in a normal mode not detecting a brainwave when the specific event occurs. If the occurrence of the specific event corresponds to detection of an on signal of the display unit 151, in the normal mode in which a brainwave is not detected, the main home screen can be displayed on the display unit 151 when the specific event occurs.

Depending on an embodiment, when the first screen 890 is displayed on the display unit 151, the controller 180 controls the brainwave detection unit to redetect a brainwave and can control the brainwave recognition unit 181 to recognize the redetected brainwave.

After the brainwave is recognized, if the redetected brainwave is recognized as a brainwave of a first type, the controller 180 can control the display unit 151 to display the second screen instead of the first screen 880 when the occurrence of the specific event corresponds to the detection of the on signal of the display unit 151. If the occurrence of the specific event corresponds to the detection detected by the proximity sensor 141, the controller can control the display unit 151 to be turned off. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 controls a specific SNS application to which the redetected brainwave recognition result is reflected to be executed and may be able to control the display unit 151 to display a screen corresponding to a state in which the specific SNS application is executed. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

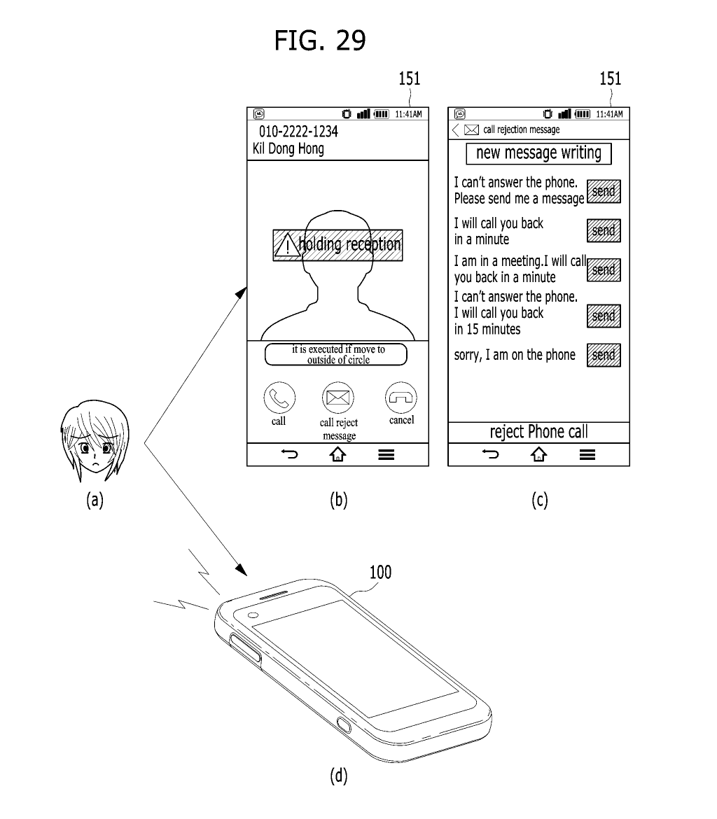

FIG. 29 is a diagram for explaining a further different example of a method of controlling a mobile terminal via brainwave recognition according to a different embodiment of the present invention.

Referring to FIG. 29 (a), if a brainwave is detected by the brainwave detection unit, the controller 180 controls the brainwave recognition unit 181 to recognize the detected brainwave. After the brainwave is recognized, assume that it is determined as a user has sad feeling now.

The controller 180 detects occurrence of a specific event. In this case, the occurrence of the specific event may correspond to at least one selected from the group consisting of detection of call signal reception, detection of text message reception, and detection of predetermined notification.

As an example, referring to FIGS. 29 (b) and (c), if a call signal is received based on the brainwave recognition result, the controller 180 may postpone reception of the call signal (FIG. 29 (b)) or transmit a phone rejection message without providing sound notification or vibration notification to a user.

As a different example, referring to FIG. 29 (d), if a text message is received or a predetermined notification is detected based on the brainwave recognition result, the controller 180 can perform silence processing without providing sound notification or vibration notification to a user.

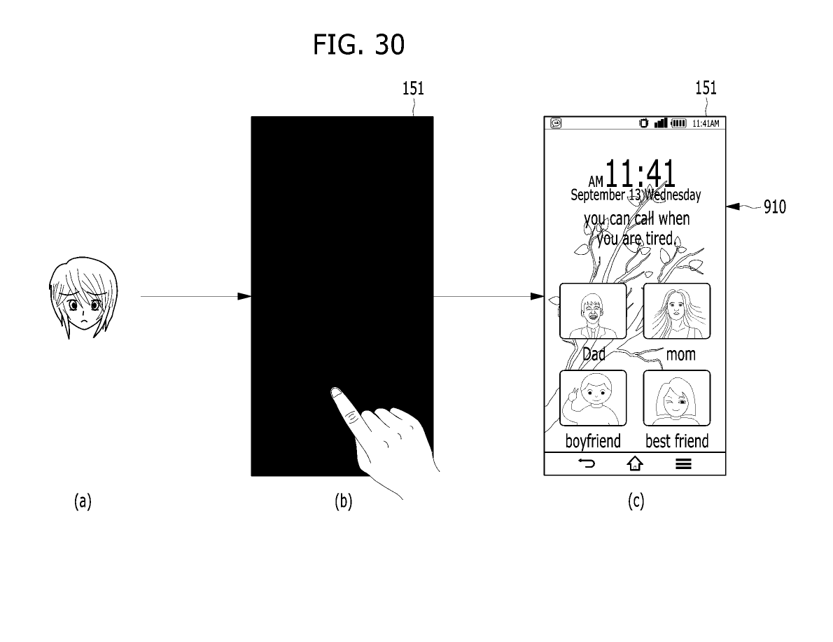

FIG. 30 is a diagram for explaining a further different example of a method of controlling a mobile terminal via brainwave recognition according to a different embodiment of the present invention.

Referring to FIG. 30 (a), if a brainwave is detected by the brainwave detection unit, the controller 180 controls the brainwave recognition unit 181 to recognize the detected brainwave. After the brainwave is recognized, assume that it is determined as a user is in a state of being depressed or in an unstable state right now.

Referring to FIG. 30 (b), the controller 180 detects occurrence of a specific event. In this case, the occurrence of the specific event may correspond to detection of an on signal detected by the display unit 151 or detection of a proximity sensor 141. The proximity sensor 141 may be able to detect a proximity touch of a part of a body of a user located at a touch screen. For example, if it is determined as a user is in a state of being depressed or in an unstable state right now, the controller 180 turns the proximity sensor 141 on and may be able to monitor whether or not the specific event occurs.

Referring to FIG. 30 (c), the controller 180 controls the display unit 151 to display a first screen 910 corresponding to the specific event based on the brainwave recognition result and the occurrence of the specific event. If the occurrence of the specific event is detected by the proximity sensor 141, the controller 180 can activate the display unit 151 first before the first screen 910 is displayed on the display unit 151.

As an example, the first screen 910 displayed on the display unit 151 may include a list of pictures, contacts, names, and the like of persons (e.g., persons registered at a contact application and/or persons registered at an SNS application as friends) of which the number of contacts is equal to or greater than a predetermined number within a predetermined period from now.

At least a part of the first screen 910 may be different from the second screen (not depicted) preconfigured to be displayed in a normal mode not detecting a brainwave when the specific event occurs. If the occurrence of the specific event corresponds to detection of an on signal of the display unit 151, in the normal mode in which a brainwave is not detected, the first home screen or the second home screen can be displayed on the display unit 151 when the specific event occurs.

After the brainwave is recognized, if the redetected brainwave is recognized as a brainwave of a first type, the controller 180 can control the display unit 151 to display the second screen instead of the first screen 910 when the occurrence of the specific event corresponds to the detection of the on signal of the display unit 151. If the occurrence of the specific event corresponds to the detection detected by the proximity sensor 141, the controller can control the display unit 151 to be turned off. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 can make a phone call to be made to a specific person or control a chatting room with a specific person to be made based on the recognition result of the redetected brainwave. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

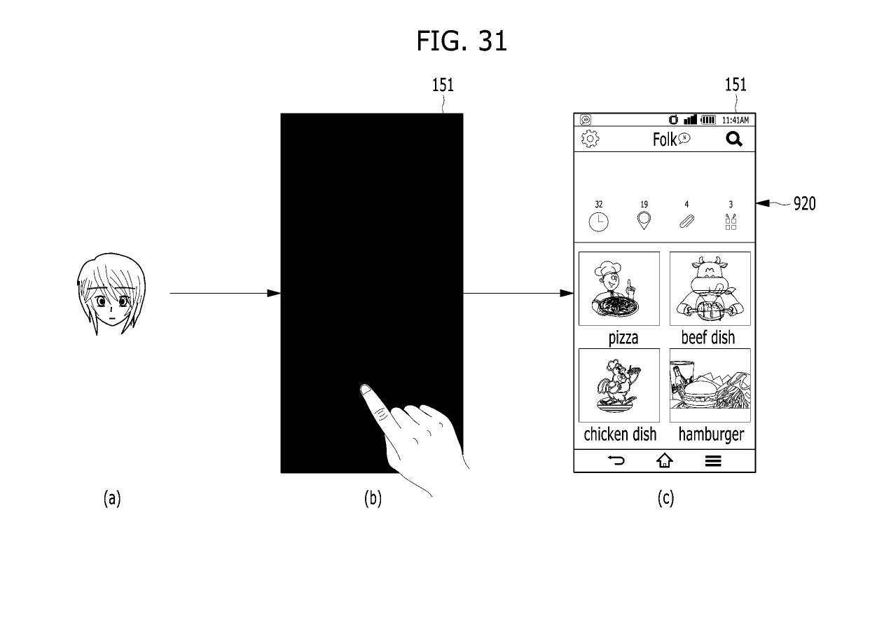

FIG. 31 is a diagram for explaining a further different example of a method of controlling a mobile terminal via brainwave recognition according to a different embodiment of the present invention.

Referring to FIG. 31 (a), if a brainwave is detected by the brainwave detection unit, the controller 180 controls the brainwave recognition unit 181 to recognize the detected brainwave. After the brainwave is recognized, assume that it is determined as a user is in a state of hungry.

Referring to FIG. 31 (b), the controller 180 detects occurrence of a specific event. In this case, the occurrence of the specific event may correspond to detection of an on signal detected by the display unit 151 or detection of a proximity sensor 141. The proximity sensor 141 may be able to detect a proximity touch of a part of a body of a user located at a touch screen. For example, if it is determined as a user is in a state of hungry, the controller 180 turns the proximity sensor 141 on and may be able to monitor whether or not the specific event occurs.

Referring to FIG. 31 (c), the controller 180 controls the display unit 151 to display a first screen 920 corresponding to the specific event based on the brainwave recognition result and the occurrence of the specific event. If the occurrence of the specific event is detected by the proximity sensor 141, the controller 180 can activate the display unit 151 first before the first screen 920 is displayed on the display unit 151.

As an example, the first screen 920 displayed on the display unit 151 may include names, menus, telephone numbers, and the like of restaurants located within a predetermined distance from a current location of the mobile terminal. The controller 180 can obtain current location information of the mobile terminal 100 from the location information module 115.

At least a part of the first screen 920 may be different from the second screen (not depicted) preconfigured to be displayed in a normal mode not detecting a brainwave when the specific event occurs. If the occurrence of the specific event corresponds to detection of an on signal of the display unit 151, in the normal mode in which a brainwave is not detected, the first home screen or the second home screen can be displayed on the display unit 151 when the specific event occurs.

Depending on an embodiment, when the first screen 920 is displayed on the display unit 151, the controller 180 controls the brainwave detection unit to redetect a brainwave and can control the brainwave recognition unit 181 to recognize the redetected brainwave.

After the brainwave is recognized, if the redetected brainwave is recognized as a brainwave of a first type, the controller 180 can control the display unit 151 to display the second screen instead of the first screen 920 when the occurrence of the specific event corresponds to the detection of the on signal of the display unit 151. If the occurrence of the specific event corresponds to the detection detected by the proximity sensor 141, the controller can control the display unit 151 to be turned off. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 can make a call to a specific restaurant or control a location of a specific restaurant to be displayed on the display unit 151 based on the recognition result of the redetected brainwave. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

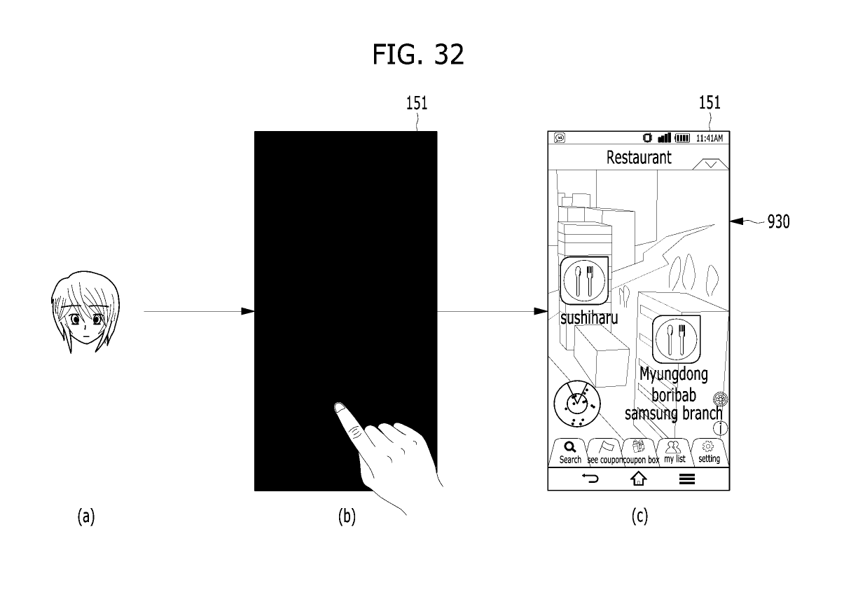

FIG. 32 is a diagram for explaining a further different example of a method of controlling a mobile terminal via brainwave recognition according to a different embodiment of the present invention.

Referring to FIG. 32 (a), if a brainwave is detected by the brainwave detection unit, the controller 180 controls the brainwave recognition unit 181 to recognize the detected brainwave. After the brainwave is recognized, assume that it is determined as a user gets lost and is in a confused state.

Referring to FIG. 32 (b), the controller 180 detects occurrence of a specific event. In this case, the occurrence of the specific event may correspond to detection of an on signal detected by the display unit 151 or detection of a proximity sensor 141. The proximity sensor 141 may be able to detect a proximity touch of a part of a body of a user located at a touch screen. For example, if it is determined as a user gets lost and is in a confused state, the controller 180 turns the proximity sensor 141 on and may be able to monitor whether or not the specific event occurs.

Referring to FIG. 32 (c), the controller 180 controls the display unit 151 to display a first screen 930 corresponding to the specific event based on the brainwave recognition result and the occurrence of the specific event. If the occurrence of the specific event is detected by the proximity sensor 141, the controller 180 can activate the display unit 151 first before the first screen 930 is displayed on the display unit 151.

As an example, the first screen 930 displayed on the display unit 151 may correspond to a map including a current location of the mobile terminal 100. The controller 180 can obtain current location information of the mobile terminal 100 from the location information module 115 and may be able to execute a map application or a navigation application.

At least a part of the first screen 930 may be different from the second screen (not depicted) preconfigured to be displayed in a normal mode not detecting a brainwave when the specific event occurs. If the occurrence of the specific event corresponds to detection of an on signal of the display unit 151, in the normal mode in which a brainwave is not detected, the first home screen or the second home screen can be displayed on the display unit 151 when the specific event occurs.

Depending on an embodiment, when the first screen 930 is displayed on the display unit 151, the controller 180 controls the brainwave detection unit to redetect a brainwave and can control the brainwave recognition unit 181 to recognize the redetected brainwave.

After the brainwave is recognized, if the redetected brainwave is recognized as a brainwave of a first type, the controller 180 can control the display unit 151 to display the second screen instead of the first screen 930 when the occurrence of the specific event corresponds to the detection of the on signal of the display unit 151. If the occurrence of the specific event corresponds to the detection detected by the proximity sensor 141, the controller can control the display unit 151 to be turned off. In this case, the brainwave of the first type may correspond to a brainwave of a certain range matched with a brainwave of a frequency, a waveform and/or a pattern that appears when a user in a mood of denying a current status. In particular, if a result of the first brainwave recognition is not matched with an intention of a user due to an error or the intention of the user changes, a redetected brainwave can be recognized as the brainwave of the first type.

On the contrary, after the brainwave is recognized, if the redetected brainwave is recognized as a brainwave of a second type, the controller 180 can control a pathfinding menu of the map application or the navigation application to be executed based on the recognition result of the redetected brainwave. In this case, the brainwave of the second type may correspond to a brainwave of a certain range matched with a brainwave of a frequency, a waveform and/or a pattern that appears when a user is affirmative to a control result controlled by previous brainwave recognition and intending to continuously move forward from a current status. As an example, the brainwave of the second type may correspond to a brainwave that appears when the user is in a mood of strongly affirmative to the control result controlled by the previous brainwave recognition.

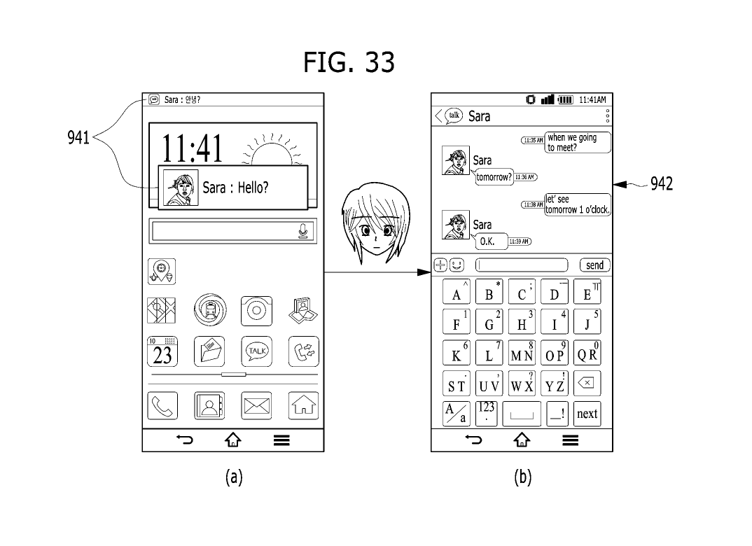

Meanwhile, according to one embodiment of the present invention, it may be able to recognize a brainwave after a specific event occurs. Regarding this, it is explained in the following with reference to FIG. 33.

FIG. 33 is a diagram for explaining a further different example of a method of controlling a mobile terminal via brainwave recognition according to a different embodiment of the present invention.

Referring to FIG. 33 (a), the controller 180 detects occurrence of a specific event. In this case, the occurrence of the specific event may correspond to detection of text message reception or detection of a notification notified by an SNS application. The controller 180 can control the display unit 151 to display an indicator 941 corresponding to the occurrence of the specific event.

If a brainwave is detected by the brainwave detection unit, the controller 180 controls the brainwave recognition unit 181 to recognize the detected brainwave. After the brainwave is recognized, assume that it is determined as a user intends to give a reply in response to the occurrence of the specific event.

Referring to FIG. 33 (b), if a text message is received, the controller 180 controls the display unit 151 to execute a text message application and display a text message writing window for sending a text message to a counterpart from which the text message is received based on the brainwave recognition result and the occurrence of the specific event. If a notification notified by an SNS application occurs, the controller 180 executes the SNS application and can control the display unit 151 to display a chatting window 942 with a counterpart of the notification.

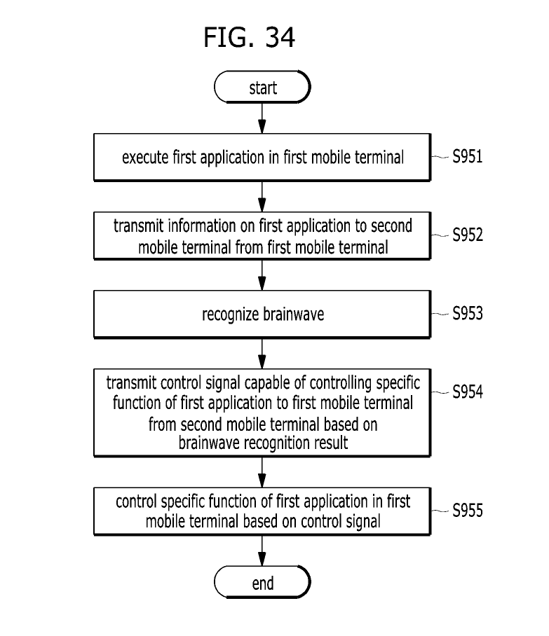

FIG. 34 is a flowchart for explaining an example of a method of controlling a mobile terminal via brainwave recognition according to a further different embodiment of the present invention. For clarity, although a case that a first mobile terminal corresponds to the mobile terminal 100 shown in FIGS. 1a to 1c and a second mobile terminal corresponds to the mobile terminal 400 shown in FIG. 4 is mainly explained, depending on an embodiment, the first or the second mobile terminal may correspond to one of the mobile terminals 100/200/300/400 shown in FIGS. 1 to 4. In relation to the second mobile terminal 400, it may refer to the contents of FIGS. 1a to 1c for a configuration element not explained in FIG. 4.

The controller 180 of the first mobile terminal executes a first application [S951].

The controller 180 of the first mobile terminal controls the mobile communication unit 110 to transmit information on a first application to the second mobile terminal 400 [S952]. In this case, assume that the first mobile terminal 100 and the second mobile terminal are paired with each other. In this case, the mobile communication unit 110 may correspond to the mobile communication module 112 or the short-distance communication module 114. The information on the first application may correspond to a type of the first application, a function related to the first application, a progress according to execution of the first application, and the like.

A control module 480 of the second mobile terminal 400 detects a brainwave and recognizes the detected brainwave [S953]. Assume that the control module 480 includes a brainwave detection unit and a brainwave recognition unit.

The control module 480 of the second mobile terminal 400 controls the mobile communication module to transmit a control signal capable of controlling a specific function of the first application to the first mobile terminal 100 based on the brainwave recognition result [S954]. After the brainwave is recognized, assume that it is determined as a user intends to execute the specific function of the first application currently executed in the first mobile terminal 100.

The controller 180 of the first mobile terminal 100 controls the mobile communication unit 110 to receive the control signal and controls the specific function of the first application according to the received control signal [S955].

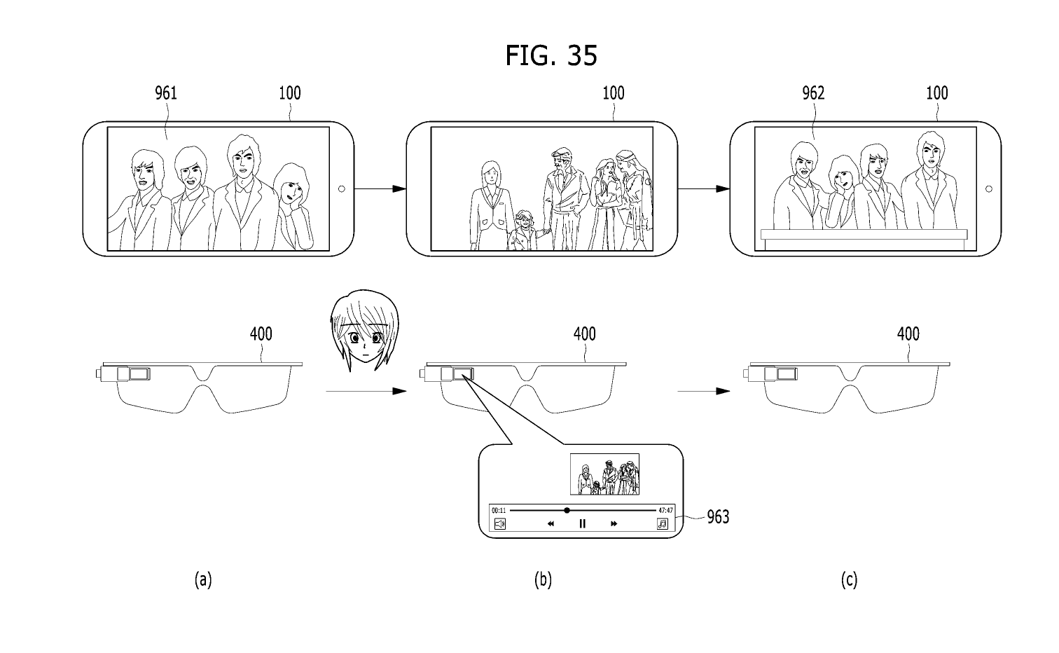

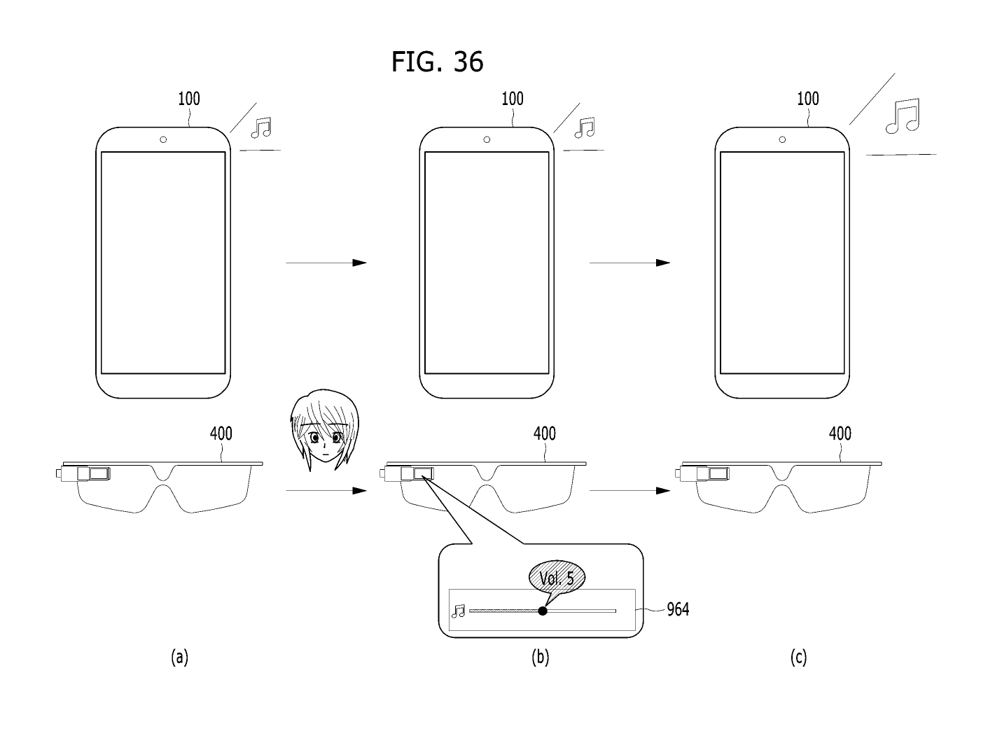

In the following, a further different embodiment of the present invention mentioned earlier in FIG. 34 is explained in detail with reference to FIGS. 35 and 36.

FIG. 35 is a diagram for explaining an example of a method of controlling a mobile terminal via brainwave recognition according to a further different embodiment of the present invention. Assume that the first mobile terminal 100 is paired with the second mobile terminal 400.

Referring to FIG. 35 (a), the controller 180 of the first mobile terminal 100 executes a first application. As an example, the first application corresponds to a video playing application and the video playing application can display a first screen 961 corresponding to a random timing of a currently playing content on the display unit 151. A user is wearing the second mobile terminal 400 of a glass type and watching contents via the first mobile terminal 100. Depending on an embodiment, the first application may correspond to a web-based application and the first screen 961 may correspond to a video data of contents streamed from an external server via the mobile communication module 112 or the short-distance communication module 113.

The controller 180 of the first mobile terminal 100 controls the mobile communication unit 110 to transmit information on a first application to the second mobile terminal 400. In this case, the information on the first application may include a type (video playing application) of the first application, a function of the video playing application, total running time of contents currently played via the video playing application, a current playing status of the contents, and the like.

Referring to FIG. 35 (b), the second mobile terminal 400 detects a brainwave of a user and recognizes the detected brainwave. After the brainwave is recognized, assume that it is determined as the user intends to watch a next scene instead of a current scene in the contents currently played via the first application. In particular, assume that the user intends to execute a fast-forward function among functions related to the first application.

The control module 480 of the second mobile terminal 400 generates a control signal corresponding to the fast-forward function of the first application. The control signal can be generated based on the information on the first application transmitted from the first mobile terminal 100 or may be stored in the memory of the second mobile terminal in advance. As an example, the control signal may correspond to a control signal corresponding to a 10-second fast forward. As a different example, the control signal may correspond to a control signal corresponding to a fast forward of time shorter than or longer than 10 seconds based on the strength of a brainwave and brainwave recognition result.

The second mobile terminal 400 transmits the control signal to the first mobile terminal 100.

Referring to FIG. 35 (c), the controller 180 of the first mobile terminal 100 controls the wireless communication unit 110 to receive the control signal from the second mobile terminal 400 and controls the 10-second fast forward function to be executed in the video playing application according to the received control signal. The controller 180 of the first mobile terminal 100 controls the display unit 151 to display a screen 962 corresponding to timing at which 10 seconds elapsed from timing of playing content immediately before the control signal is applied to the video playing application.

When the video playing application is executed in the first mobile terminal 100, GUI for controlling the function of the video playing application may not be displayed on the display unit 151 of the first mobile terminal 100. Instead, GUI 936 for controlling the function of the video playing application can be displayed on the display unit 451 of the second mobile terminal 400. Hence, a user can watch contents via the first mobile terminal 100 without interruption of a screen.

FIG. 36 is a diagram for explaining a different example of a method of controlling a mobile terminal via brainwave recognition according to a further different embodiment of the present invention.

Referring to FIG. 36 (a), the controller 180 of the first mobile terminal 100 executes a first application stored in the memory 170. As an example, the first application corresponds to a music playing application and the music playing application can output an audio signal of a currently playing content via the audio output unit 152. A user is wearing the second mobile terminal 400 of a glass type and listening to music via the first mobile terminal 100. Or, depending on an embodiment, the audio signal of the currently playing content is transmitted to the second mobile terminal 400 from the first mobile terminal 100 without being outputted via the first mobile terminal 100 and the audio signal can be delivered to a user via the audio output module 452 of the second mobile terminal 400.

The controller 180 of the first mobile terminal 100 controls the mobile communication unit 110 to transmit information on the first application to the second mobile terminal 400. In this case, the information on the first application may include a type (music playing application) of the first application, a function of the music playing application, playing time of contents currently played via the music playing application, a list of contents, a current playing status of the contents, and the like.

Referring to FIG. 36 (b), the second mobile terminal 400 detects a brainwave of a user and recognizes the detected brainwave. After the brainwave is recognized, assume that it is determined as the user intends to execute a volume control function (specifically, a volume up function) of the first application.

The control module 480 of the second mobile terminal 400 generates a control signal corresponding to the volume up function of the first application. The control signal can be generated based on the information on the first application transmitted from the first mobile terminal 100 or may be stored in the memory of the second mobile terminal in advance. As an example, the control signal may correspond to a control signal corresponding to a one step (e.g., Vol. 4 to Vo. 5) volume up function. As a different example, the control signal may correspond to a control signal corresponding to a volume up function of steps greater than one step based on the strength of a brainwave and brainwave recognition result.

The second mobile terminal 400 transmits the control signal to the first mobile terminal 100.

Referring to FIG. 36 (c), the controller 180 of the first mobile terminal 100 controls the wireless communication unit 110 to receive the control signal from the second mobile terminal 400 and controls the one step volume up function to be executed in the music playing application according to the received control signal.

When the music playing application is executed in the first mobile terminal 100, GUI for controlling the function of the music playing application may not be displayed on the display unit 151 of the first mobile terminal 100. Instead, GUI 964 for controlling the function of the music playing application can be displayed on the display unit 451 of the second mobile terminal 400. Hence, a user can control the first application without using the first mobile terminal 100.

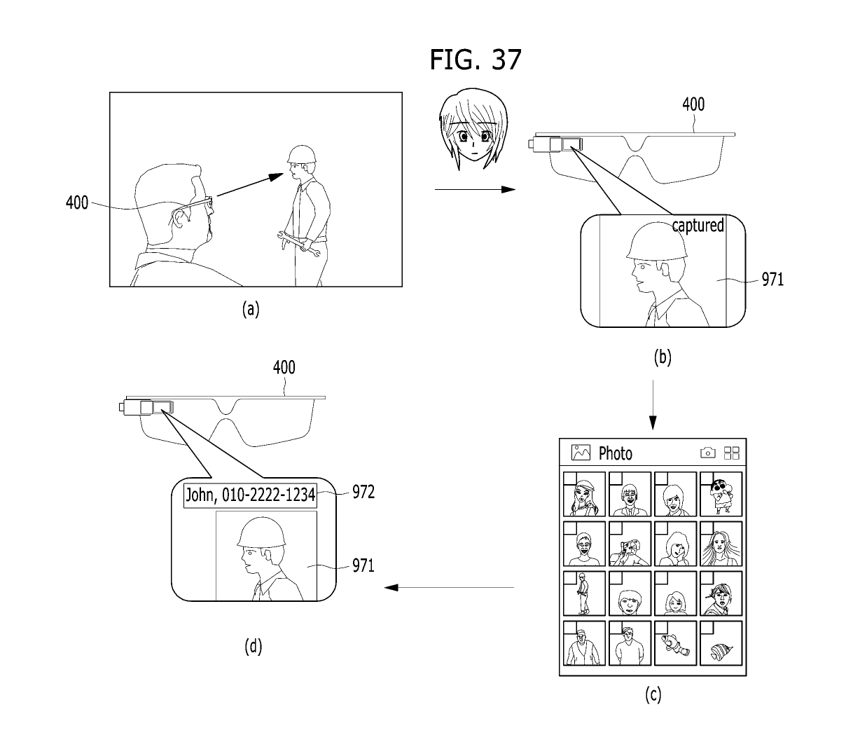

FIG. 37 is a diagram for explaining an example of a method of controlling a mobile terminal via brainwave recognition according to a further different embodiment of the present invention. In this case, assume that a mobile terminal corresponds to the mobile terminal 400 shown in FIG. 4.

Referring to FIG. 37 (a), a user wearing the mobile terminal 400 of a glass type is watching somebody. The control module 480 of the mobile terminal 400 detects a brainwave of a user and recognizes the detected brainwave. After the brainwave is recognized, assume that it is determined as the user is confused about a person at whom the user is looking.

Referring to FIG. 37 (b), the control module 480 of the mobile terminal 400 activates the camera 421 based on the brainwave recognition result and controls the display unit 451 to display an image 971 captured by the camera 421. Since the camera 421 mounted on the mobile terminal 400 moves in accordance with a gaze of the user, the captured image 971 can include a face of the person at whom the user is looking.

Referring to FIG. 37 (c), the control module 480 of the mobile terminal 400 searches for personal information related to the face included in the captured image 971. In this case, a search range of the control module 480 can include contact information stored in the memories of mobile terminals paired with the mobile terminal 400, tag information of pictures, information related to an SNS application, and the like. If a web-based application of the mobile terminal 400 is executed, the search range of the control module 480 can include information shown in a web page and information included in a cloud service to which a user has subscribed.

Referring to FIG. 37 (d), the control module 480 of the mobile terminal 400 can control the display unit 451 to display a message 972 including searched personal information.

According to the aforementioned embodiments of the present invention, it is able to provide user environment appropriate for an intention of a user to a mobile terminal via brainwave recognition.

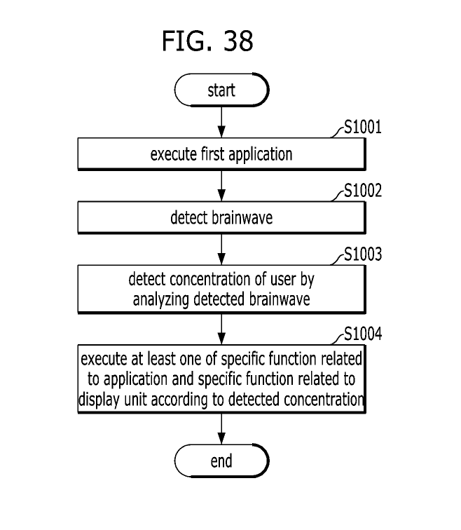

FIG. 38 is a flowchart for an example of a method of controlling a mobile terminal via brainwave recognition according to one embodiment of the present invention.

The controller 180 of the mobile terminal 100 executes a first application [S1001]. In this case, execution of the first application can include not only a case of executing the first application by a user by operating the mobile terminal 100 but also a case of automatically triggering the first application due to a call signal reception, a predetermined notification, or the like. Subsequently, the controller 180 controls the display unit 151 to display a first screen corresponding to the first application. The first screen corresponding to the first application may correspond to an execution screen at the time of starting the first application or an execution screen corresponding to a state of the first application after prescribed time elapses from the start of the first application.

Subsequently, the controller 180 controls the brainwave detection unit to detect a brainwave [S1002]. Depending on an embodiment, a brainwave of a user can be detected by a brainwave sensor 143 embedded in the mobile terminal 100 or can be received from an external device via the wireless communication unit 110 or the interface unit 160.

The controller 180 controls the brainwave recognition unit 181 to recognize the detected brainwave [S1003]. Specifically, the controller 180 can detect concentration of the user by analyzing the detected brainwave based on brainwave data according to concentration stored in the memory 170. Depending on an embodiment, the controller 180 can further detect feeling of the user by analyzing the detected brainwave based on brainwave data according to human feeling stored in the memory 170.

The controller 180 can execute at least one function among a specific function related to the first application and a specific function related to the display unit 151 [S1004]. Depending on an embodiment, the controller 180 can control the display unit 151 to display a second screen different from the first screen in at least a part while the specific function is executed. As an example, the second screen can include an execution result of the specific function and a result related to the execution result.

Depending on an embodiment, the controller 180 may control the display unit 151 and/or the audio output unit 152 to output a guide message for checking whether or not the specific function is executed. If the guide message is outputted on the display unit 151, the guide message can be outputted in a GUI form to receive a command of a user. If the guide message is outputted via the audio output unit 152, the guide message can be outputted in a form of audio data. If a first command for selecting the execution of the specific function is detected, the controller 180 can execute the specific function at last. The first command can be detected via a touch screen of the display unit 151 or can be detected via voice recognition based on an audio signal received by the microphone 122. If the first command is detected, the controller 180 is able to learn that the recognized brainwave is matched with the intention of the user intending to execute the specific function and the controller 180 can store a result of the learning in the memory 170. On the contrary, if a second command for not selecting the execution of the specific function is detected, the controller 180 is able to learn that the execution of the specific function is not matched with the intention of the user. The controller 180 can store a result of the learning in the memory 170. Whenever a specific function is executed based on a result of brainwave recognition, the controller 180 can output a guide message to check whether or not the execution of the specific function is matched with the intention of the user. A result of user selection according to the output of the guide message can be stored in the memory 170 together with the recognized brainwave. By doing so, it may be able to enhance accuracy of a control signal when the control signal is generated based on brainwave recognition. If the guide message is outputted more than a predetermined count in relation to an identical/similar brainwave, the guide message may not be outputted. And, if a user selects termination of outputting the guide message, the guide message may not be outputted.

Depending on an embodiment, when the specific function is executed, the controller 180 controls the brainwave detection unit to redetect a brainwave and controls the brainwave recognition unit to detect feeling of a user by analyzing the redetected brainwave based on brainwave data according to feeling stored in the memory 170. If the redetected brainwave is recognized as a brainwave corresponding to feeling of a first type, the controller 180 maintains an execution result of the specific function. If the redetected brainwave is recognized as a brainwave corresponding to feeling of a second type, the controller 180 can return to a state that the specific function is not executed. In this case, the brainwave corresponding to feeling of the first type may correspond to a brainwave of a certain range matched with a brainwave of a frequency, a waveform and/or a pattern that appears when a user is affirmative to a current status. And, the brainwave corresponding to feeling of the second type may correspond to a brainwave of a certain range matched with a brainwave of a frequency, a waveform and/or a pattern that appears when a user is denying a current status.

Although a case of detecting and recognizing a brainwave of a user after the first application is executed is explained in FIG. 38 as an example, depending on an embodiment, it may execute a specific application according to a brainwave after the brainwave of a user is detected and recognized.

In the following, one embodiment of the present invention mentioned earlier in relation to FIG. 38 is explained in detail with reference to FIGS. 38 to 47.

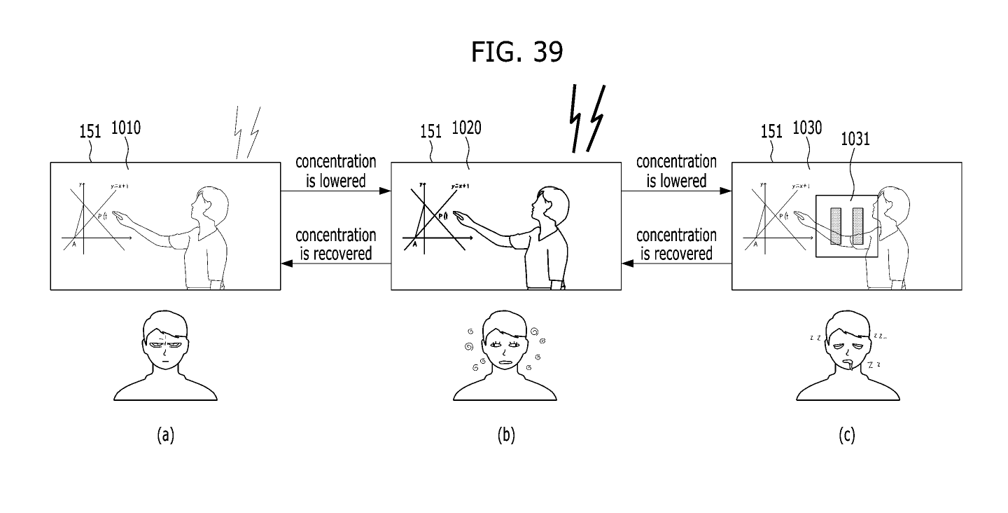

FIG. 39 is a diagram for explaining an example of a method of controlling a mobile terminal via brainwave recognition according to one embodiment of the present invention.

Referring to FIG. 39 (a), a first screen 1010 corresponding to a first application is displayed on the display unit of the mobile terminal 100. As an example, the first application may correspond to a video playing application, a web service application, or a DMB application. The first screen 1010 may correspond to a screen on which specific content is playing.

If a brainwave is detected by the brainwave detection unit, the controller 180 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

Referring to FIG. 39 (b), if the detected concentration is lower than a first reference and higher than a second reference, the controller 180 can execute at least one of a specific function related to the first application and a specific function related to the display unit 151. For example, if the detected concentration is lower than the first reference and higher than the second reference, the controller 180 can control the display unit 151 to change at least one selected from the group consisting of brightness, definition, and contrast ratio of the first screen 1010 among functions related to the display unit 151. And, the controller 180 can control the display unit 151 to display a second screen 1020 including a result of the executed function. At least a part of the second screen 1020 can be different from the first screen 1010. In FIG. 39 (b), the second screen 1020 is different from the first screen 1010 in at least one selected from the group consisting of brightness, definition, and contrast ratio. And, if the detected concentration is lower than the first reference and higher than the second reference, the controller 180 can execute a volume up function among the functions related to the first application. By doing so, it is able to call user's attention and create an atmosphere to make the user more concentrate on the content.

Referring to FIG. 39 (c), if the detected concentration is lower than the second reference, the controller 180 can execute at least one of a specific function related to the first application and a specific function related to the display unit 151. For example, if the detected concentration is lower than the second reference, the controller 180 can execute a function of pausing the specific content among the functions related to the first application. And, the controller 180 can control the display unit 151 to display a third screen 1030 including a result of the executed function. The third screen 1030 can include an indicator 1031 corresponding to the pausing function. At least a part of the third screen 1030 can be different from the first screen 1010 and the second screen 1020. Depending on an embodiment, when the first application corresponds to a DMB application, if the detected concentration is lower than the second reference, the controller 180 temporarily stops outputting live broadcasting and activates a time shift function.

Depending on an embodiment, the controller 180 controls the brainwave detection unit to redetect a brainwave when the specific function is executed and can control the brainwave recognition unit to detect feeling of a user by analyzing the redetected brainwave based on brainwave data according to feeling stored in the memory 170. If the redetected brainwave is recognized as a brainwave corresponding to feeling of a first type that satisfies the execution of the specific function, the controller 180 maintains an execution result of the specific function. If the redetected brainwave is recognized as a brainwave corresponding to feeling of a second type not satisfying the execution of the specific function, the controller 180 can return to a state that the specific function is not executed. As an example, in FIG. 39 (b), if it is recognized that a user is not satisfied with execution of a specific function, the controller 180 can return to a state of FIG. 39 (a). Redetection and recognition of a brainwave redetected and recognized after a specific function is executed can be applied to all embodiments. In the following, detail explanation on the redetection and the recognition is omitted.

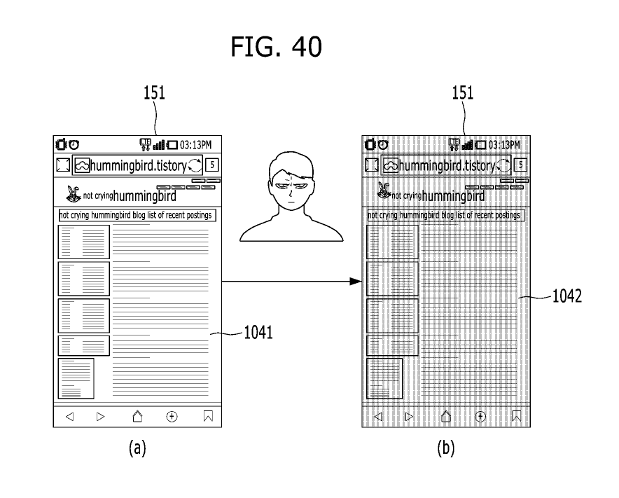

FIG. 40 is a diagram for explaining an example of a method of controlling a mobile terminal via brainwave recognition according to one embodiment of the present invention.

Referring to FIG. 40 (a), a first screen 1041 corresponding to a first application is displayed on the display unit 151 of the mobile terminal 100. As an example, the first application may correspond to a web service application.

If a brainwave is detected by the brainwave detection unit, the controller 180 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

Referring to FIG. 40 (b), if the detected concentration is higher than a first reference, the controller 180 can execute at least one of a specific function related to the first application and a specific function related to the display unit 151. For example, if the detected concentration is higher than the first reference, the controller 180 can control the display unit 151 to lower brightness of the first screen 1010 to a predetermined level among functions related to the display unit 151. A screen 1042 with brightness darker than the first screen 1010 may be referred to as a second screen. By doing so, although a user intensively uses the mobile terminal 100 for a long time, it is able to prevent eye fatigue from being increased.

FIG. 40 illustrates that the second screen 1042 is outputted while a user already uses the first application. However, if the user uses an application different from the first application and executes the first application while high concentration is maintained, it is apparent that the second screen 1042 can be immediately outputted without passing through the first screen 1041.

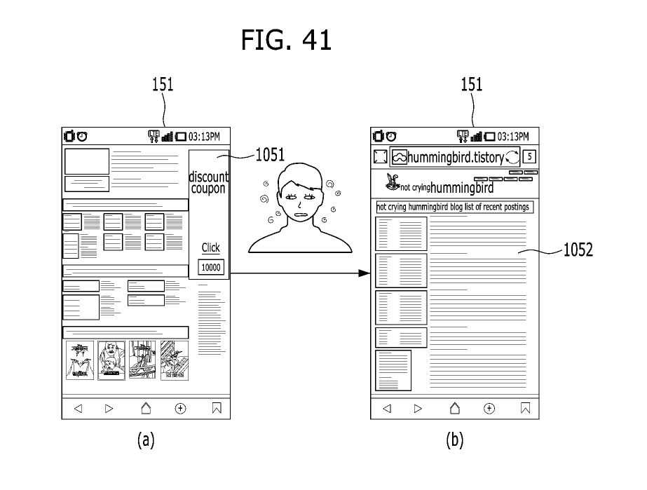

FIG. 41 is a diagram for explaining an example of a method of controlling a mobile terminal via brainwave recognition according to one embodiment of the present invention.

Referring to FIG. 41 (a), a first screen 1051 corresponding to a first application is displayed on the display unit 151 of the mobile terminal 100. As an example, assume that the first application corresponds to a web service application and the first screen includes text information, advertisement information, category information for categorizing the text information according to category, and the like.

If a brainwave is detected by the brainwave detection unit, the controller 180 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

Referring to FIG. 41 (b), if the detected concentration is lower than a first reference, the controller 180 can execute at least one of a specific function related to the first application and a specific function related to the display unit 151. For example, if the detected concentration is lower than the first reference, the controller 180 can change at least one selected from the group consisting of a font, a size, and thickness of letters included in the first screen 1051 and the controller 180 can delete partial information of low importance among the text information, the advertisement information, and the category information for categorizing the text information according to category from a screen. And, the controller 180 can control the display unit 151 to display a second screen 1052 including a result of the executed function. At least a part of the second screen 1052 can be different from the first screen 1051. As an example, among the information included in the first screen 1051, the advertisement information and the category information for categorizing the text information according to category are deleted from the second screen 1052 and the text information can be remained only. In this case, letters constructing the text information can be magnified.

FIG. 41 illustrates that the second screen 1052 is outputted while a user already uses the first application. However, if the user uses an application different from the first application and executes the first application while high concentration is maintained, it is apparent that the second screen 1052 can be immediately outputted without passing through the first screen 1051.

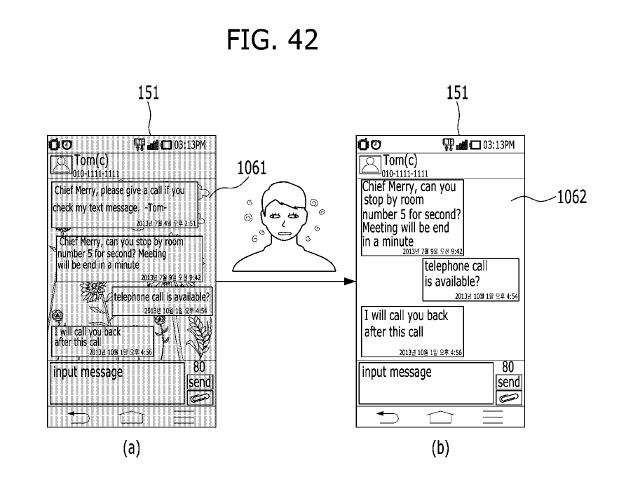

FIG. 42 is a diagram for explaining an example of a method of controlling a mobile terminal via brainwave recognition according to one embodiment of the present invention.

Referring to FIG. 42 (a), a first screen 1061 corresponding to a first application is displayed on the display unit 151 of the mobile terminal 100. As an example, the first application may correspond to a text message application and the first screen 1061 may correspond to a screen including text messages transceived with a specific person as an execution screen of the text message application.

If a brainwave is detected by the brainwave detection unit, the controller 180 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

Referring to FIG. 42 (b), if the detected concentration is lower than a first reference, the controller 180 can execute at least one of a specific function related to the first application and a specific function related to the display unit 151. For example, if the detected concentration is lower than the first reference, the controller 180 can change at least one selected from the group consisting of a font, a size, and thickness of letters included in the first screen 1061 and the controller 180 can simplify a background screen of the text messages included in the first screen 1061. And, the controller 180 can control the display unit 151 to display a second screen 1062 including a result of the executed function. At least a part of the second screen 1062 can be different from the first screen 1051.

FIG. 42 illustrates that the second screen 1062 is outputted while a user already uses the first application. However, if the user uses an application different from the first application and executes the first application while high concentration is maintained, it is apparent that the second screen 1062 can be immediately outputted without passing through the first screen 1061.

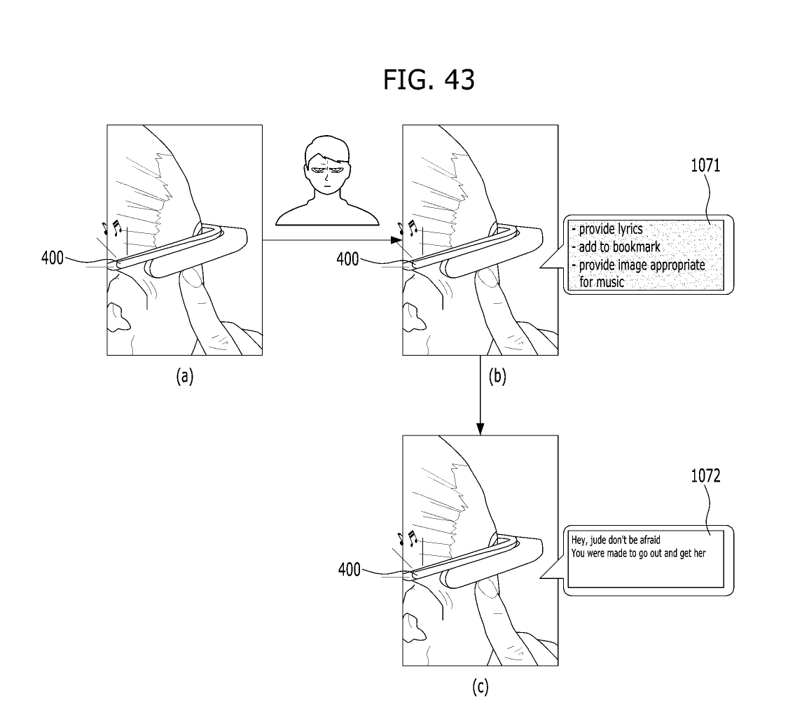

FIG. 43 is a diagram for explaining an example of a method of controlling a mobile terminal via brainwave recognition according to one embodiment of the present invention.

Referring to FIG. 43 (a), the control module 480 of the mobile terminal 400 executes a first application. As an example, the first application may correspond to a music playing application. Depending on an embodiment, an execution screen of the first application can be outputted on the display unit 451 or the first application can be executed at the background without outputting the execution screen of the first application on the display unit 451. The control module 480 of the mobile terminal 400 can output audio data corresponding to a specific music file via the audio output module 452.

If a brainwave is detected by the brainwave detection unit, the control module 480 controls the brainwave recognition unit 181 to recognize the detected brainwave. For example, the control module 480 can control the brainwave recognition unit 181 to detect concentration of a user by analyzing the detected brainwave based on brainwave data according to concentration stored in the memory 170.

Referring to FIG. 43 (b), if the detected concentration is higher than a first reference, the control module 480 can control the display unit 451 to display GUI 1071 corresponding to a specific function related to the first application. For example, the GUI 1071 can include a menu for providing lyrics of the specific music file currently played by the first application, a menu for adding the specific music file to a bookmark, a menu for providing an image appropriate for a song of the specific music file, and the like.

Referring to FIG. 43 (c), if selection of a specific menu selected from the menus included in the GUI 1071 is detected, the control module 480 can control the display unit 451 to display a screen 1072 related to the selected specific menu. For example, the specific menu can be selected by redetecting a brainwave and recognizing the brainwave or can be selected by the user input unit 423a/423b.

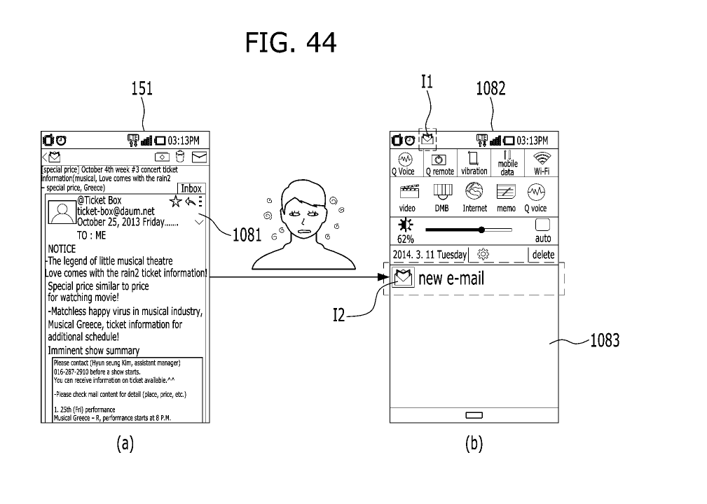

FIG. 44 is a diagram for explaining an example of a method of controlling a mobile terminal via brainwave recognition according to one embodiment of the present invention.

Referring to FIG. 44 (a), a first screen 1081 corresponding to a first application is displayed on the display unit 151 of the mobile terminal 100. As an example, the first application may correspond to an e-mail application and the first screen 1081 may correspond to an execution screen of the e-mail application. The execution screen can include contents of a new e-mail received from a specific person.

If a brainwave is detected by the brainwave detection unit, the controller 180 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

Referring to FIG. 44 (b), if the detected concentration is lower than a first reference, the controller 180 can execute a specific function related to the first application. For example, if the detected concentration is lower than the first reference, although a user has already checked the new e-mail, the controller 180 can process it as if the new e-mail had not been checked yet. And, the controller 180 can control the display unit 151 to display an indicator (I1) indicating the new e-mail received from the specific person on a notification bar 1082 outputted on the display unit 151. The controller 180 can control the display unit 151 to display an indicator (12) indicating the new e-mail received from the specific person on a sub screen 1083 of the notification bar 1082.

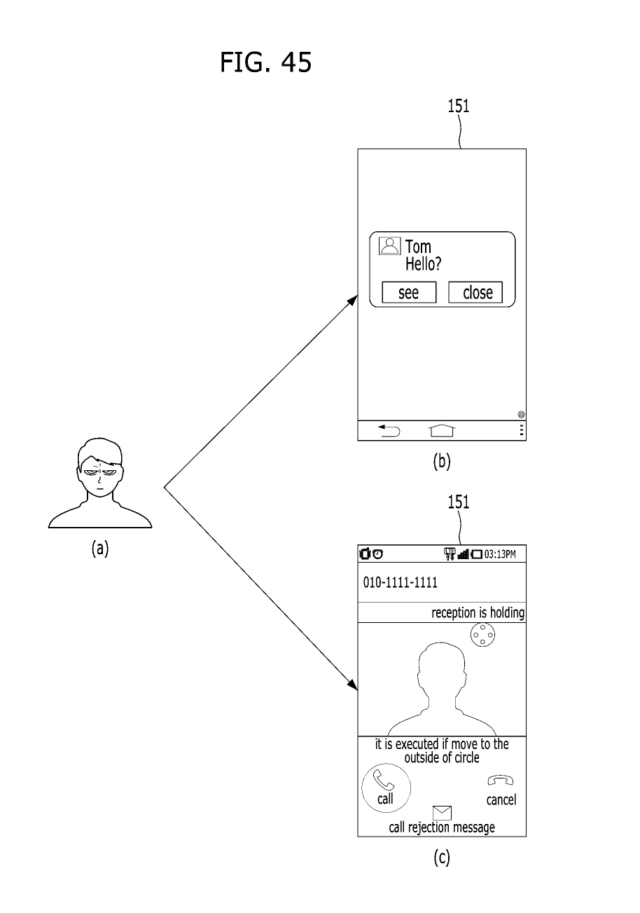

FIG. 45 is a diagram for explaining an example of a method of controlling a mobile terminal via brainwave recognition according to one embodiment of the present invention.

Referring to FIG. 45 (a), if a brainwave is detected by the brainwave detection unit, the controller 180 of the mobile terminal 100 controls the brainwave recognition unit 181 to recognize the detected brainwave. For example, the controller 180 can control the brainwave recognition unit 181 to detect concentration of a user by analyzing the detected brainwave based on brainwave data according to concentration stored in the memory 170.

When the detected concentration is higher than a first reference, if an event related to a specific application occurs, the controller 180 may set a notification of the event to silence or set the notification of the event to a vibration notification rather than a sound notification.

As an example, referring to FIG. 45 (b), if reception of a new message received via a text message application or an SNS application is detected in a state that the detected concentration is higher than the first reference, the controller 180 can set a reception notification of the new message to silence irrespective of a notification setting set by a user. In this case, the reception notification of the new message is set to silence only. A screen outputted on the display unit 151 does not change according to the brainwave recognition result. When a brainwave is redetected and recognized, if it is recognized as the concentration of the user is lower than the first reference, it may return to a notification status configured by the user in advance.

As a different example, referring to FIG. 45 (c), if reception of a call signal received via a calling application is detected in a state that the detected concentration is higher than the first reference, the controller 180 can set a reception notification of the call signal to vibration notification irrespective of a notification setting set by a user. In this case, the reception notification of the call signal is set to the vibration notification only. A screen outputted on the display unit 151 does not change according to the brainwave recognition result. When a brainwave is redetected and recognized, if it is recognized as the concentration of the user is lower than the first reference, it may return to a notification status configured by the user in advance.

According to the present embodiment, there is a merit in that a concentration state of a user is not interrupted.

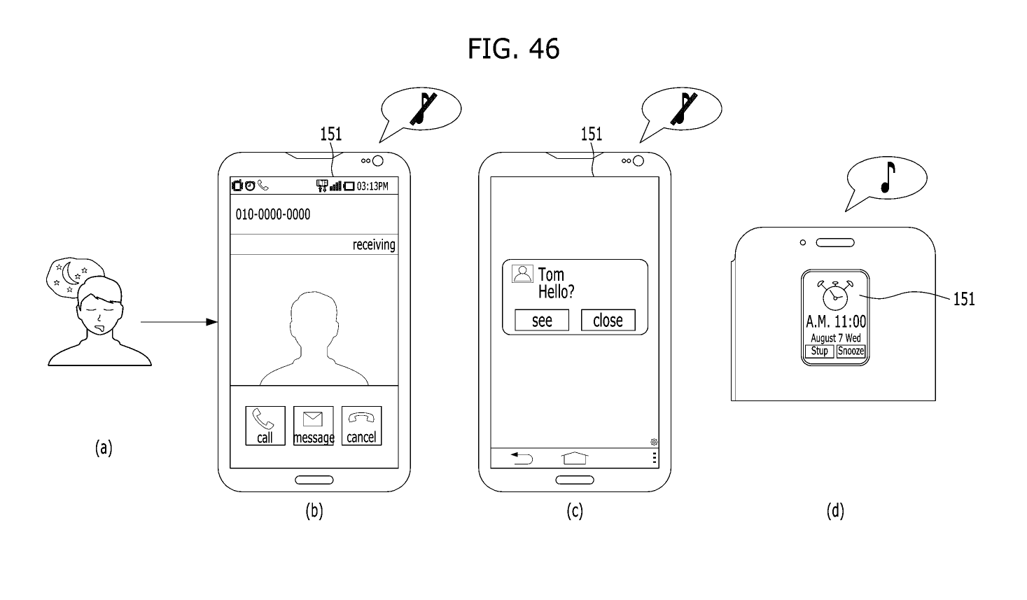

FIG. 46 is a diagram for explaining an example of a method of controlling a mobile terminal via brainwave recognition according to one embodiment of the present invention.

Referring to FIG. 46 (a), if a brainwave is detected by the brainwave detection unit, the controller 180 of the mobile terminal 100 controls the brainwave recognition unit 181 to recognize the detected brainwave. For example, the controller 180 can recognize that a user is currently sleeping based on brainwave data stored in the memory 170.

If it is recognized as the user is currently sleeping, the controller 180 can set a notification of an event to silence when an event related to a specific application occurs.

As an example, referring to FIG. 46 (b), if reception of a call signal received via a calling application is detected in a state that the currently sleeping user is recognized, the controller 180 can set a reception notification of the call signal to silence irrespective of a notification setting set by the user. In this case, the reception notification of the call signal is set to silence only. A screen outputted on the display unit 151 does not change according to the brainwave recognition result. When a brainwave is redetected and recognized, if it is recognized as the concentration of the user is higher than the third reference, it may return to a notification status configured by the user in advance.

As a different example, referring to FIG. 46 (c), if reception of a new message received via a text message application or an SNS application is detected in a state that the currently sleeping user is recognized, the controller 180 can set a reception notification of the new message to silence irrespective of a notification setting set by the user. In this case, the reception notification of the message is set to silence only. A screen outputted on the display unit 151 does not change according to the brainwave recognition result. When a brainwave is redetected and recognized, if it is recognized as the concentration of the user is higher than the third reference, it may return to a notification status configured by the user in advance.

On the contrary, referring to FIG. 46 (c), if an event related to an alarm application occurs, the controller 180 does not set a notification of the event to silence and maintains the notification status configured by the user in advance.

According to the present embodiment, if it is determined that a user is sleeping, other sound notifications except alarm are cancelled. By doing so, it may not interrupt sound sleep of the user.

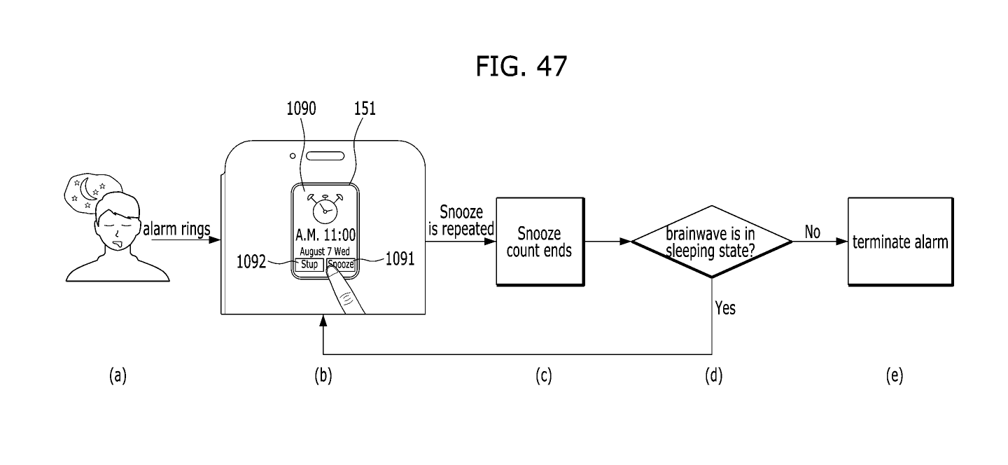

FIG. 47 is a diagram for explaining an example of a method of controlling a mobile terminal via brainwave recognition according to one embodiment of the present invention.

Referring to FIG. 47 (a), if a brainwave is detected by the brainwave detection unit, the controller 180 of the mobile terminal 100 controls the brainwave recognition unit 181 to recognize the detected brainwave. For example, the controller 180 can recognize that a user is currently sleeping based on brainwave data stored in the memory 170.

As shown in FIG. 47 (b), if the alarm set by the user rings via an alarm application, the controller 180 can control the display unit 151 to display an execution screen 1090 of the alarm application. The execution screen 1090 can include a first menu 1091 corresponding to a function for making the alarm ring again after prescribed time elapses (hereinafter, a snooze function) and a second menu 1092 corresponding to a function for terminating the alarm.

The alarm application can make the snooze function to be executed with an interval of about 5 minutes unless a user selects the second menu 1092. And, as shown in FIG. 47 (c), assume that the count of executing the predetermined snooze function is all terminated.

Referring to FIG. 47 (d), the controller 180 controls the brainwave detection unit to redetect a brainwave and controls the brainwave recognition unit 181 to recognize the redetected brainwave. After the redetected brainwave is recognized, if it is recognized that the user is still sleeping, the controller 180 can configure the alarm to ring again via the alarm application. Meanwhile, referring to FIG. 47 (e), after the redetected brainwave is recognized, if it is recognized that the user is not sleeping, the controller 180 can disable the alarm as it is.

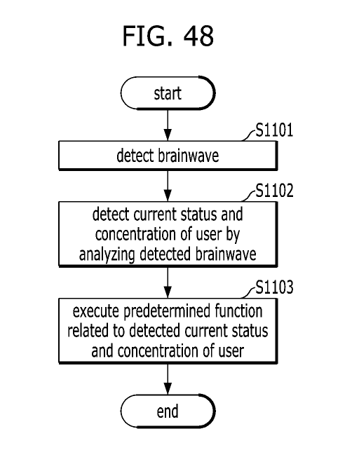

FIG. 48 is a flowchart for explaining an example of a method of controlling a mobile terminal via brainwave recognition according to one embodiment of the present invention.

The controller 180 of the mobile terminal 100 controls the brainwave detection unit to detect a brainwave [S1101]. Depending on an embodiment, a brainwave of a user can be detected by a brainwave sensor 143 embedded in the mobile terminal 100 or can be received from an external device via the wireless communication unit 110 or the interface unit 160.

The controller 180 controls the brainwave recognition unit 181 to recognize the detected brainwave [S1102]. Specifically, the controller 180 can detect a current status of the user and concentration of the user by analyzing the detected brainwave based on brainwave data according to a current status of the user and concentration stored in the memory 170. In this case, the brainwave data according to the current status of the user stored in the memory 170 corresponds to brainwave data capable of identifying such a current idea of the user as an intention of the user, a current operation performed by the user, and the like. The memory 170 may be able to store sufficient experience data for a brainwave respectively corresponding to each state of the user. The controller 180 can detect a current status of the user and current concentration of the user by analyzing the detected brainwave based on the brainwave data according to the current status and the concentration stored in the memory 170.

The controller 180 executes a predetermined function according to the detected current status of the user and the concentration of the user [S1103]. The memory 170 may be able to store data mapped between a specific function and the current status of the user and the concentration.

Depending on an embodiment, the controller 180 can control the display unit 151 to output a guide message for checking whether or not the predetermined function is executed before the predetermined function is executed. The controller 180 can execute the predetermined function when a user command for selecting execution of the predetermined function is detected via the guide message. Subsequently, the controller 180 can control the display unit 151 to display an execution result of the predetermined function. The controller 180 can output a guide message for checking whether or not a specific function is matched with an intention of the user whenever the specific function is executed based on the brainwave recognition result. The controller 180 stores a selection result according to the output of the guide message in the memory 170 together with the recognized brainwave to increase accuracy at the time of generating a control signal in the future based on brainwave recognition. If the guide message is outputted more than a predetermined count in relation to an identical/similar brainwave, the guide message may not be outputted. And, if a user selects termination of outputting the guide message, the guide message may not be outputted

And, depending on an embodiment, when the predetermined function is executed, the controller 180 can control the brainwave detection unit to redetect a brainwave and control the brainwave recognition unit 181 to recognize the redetected brainwave. If the redetected brainwave is recognized as a brainwave corresponding to feeling of a first type, the controller 180 maintains an execution result of the specific function. If the redetected brainwave is recognized as a brainwave corresponding to feeling of a second type, the controller 180 can return to a state that the specific function is not executed. In this case, the brainwave corresponding to feeling of the first type may correspond to a brainwave of a certain range matched with a brainwave of a frequency, a waveform and/or a pattern that appears when a user is affirmative to a current status. And, the brainwave corresponding to feeling of the second type may correspond to a brainwave of a certain range matched with a brainwave of a frequency, a waveform and/or a pattern that appears when a user is denying a current status.

And, depending on an embodiment, the controller 180 can control the audio output unit 152 to output predetermined specific audio data related to the detected current status of the user and the concentration.

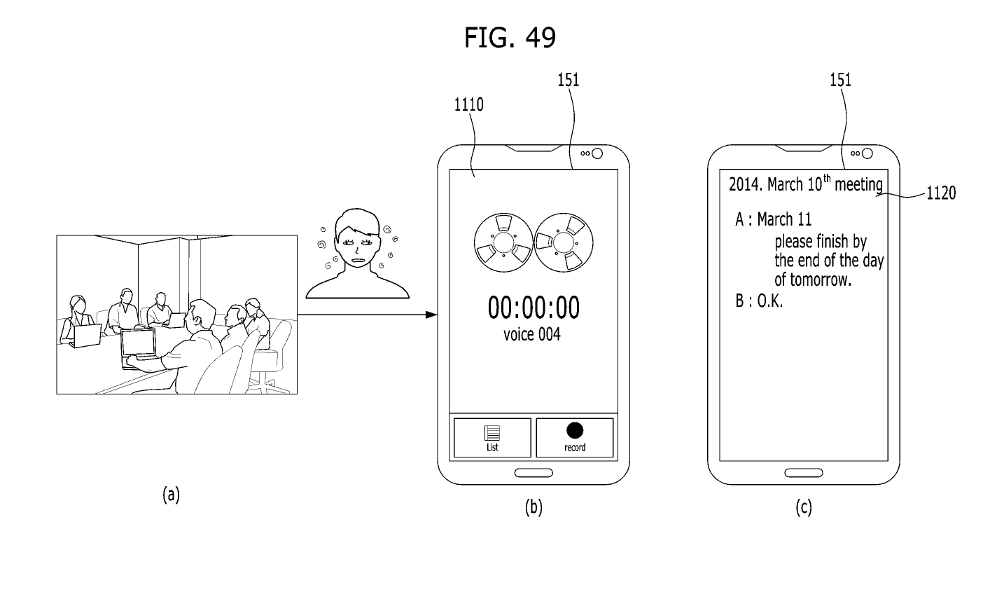

In the following, one embodiment of the present invention mentioned earlier in relation to FIG. 48 is explained in detail with reference to FIGS. 49 to 51.

FIG. 49 is a diagram for explaining an example of a method of controlling a mobile terminal via brainwave recognition according to one embodiment of the present invention.

Referring to FIG. 49 (a), if a brainwave is detected by the brainwave detection unit, the controller 180 of the mobile terminal 100 controls the brainwave recognition unit 181 to recognize the detected brainwave. Specifically, the controller 180 can detect a current status and concentration of a user by analyzing the detected brainwave based on brainwave data according to a current status of the user and concentration stored in the memory 170. As an example, after the brainwave is recognized, assume that it is determined as the user is in a meeting related to a specific work and the concentration is lower than a first reference.

The controller 180 executes a predetermined function according to the detected current status and the concentration of the user.

As an example, the controller 180 can execute a voice recording function among functions capable of being implemented in the mobile terminal 100. The controller 10 executes a voice recording application and can control the display unit 151 to display an execution screen 1110 of the voice recording application. Subsequently, after a redetected brainwave is recognized, if it is determined as the meeting related to the specific work is finished or the concentration is higher than the first reference, the controller 180 stops voice recording and may be able to store a recoded file in the memory 170.

As a different example, the controller 180 can execute an STT (speech to text) function among functions capable of being implemented in the mobile terminal 100. The controller 10 executes an STT application and can control the display unit 151 to display an execution screen 1120 of the STT application. Subsequently, the controller 180 starts voice recording and can perform an operation of converting a recorded voice file into a text by analyzing the voice file. After a redetected brainwave is recognized, if it is determined as the meeting related to the specific work is finished or the concentration is higher than the first reference, the controller 180 stops STT function and may be able to store a converted text file in the memory 170.

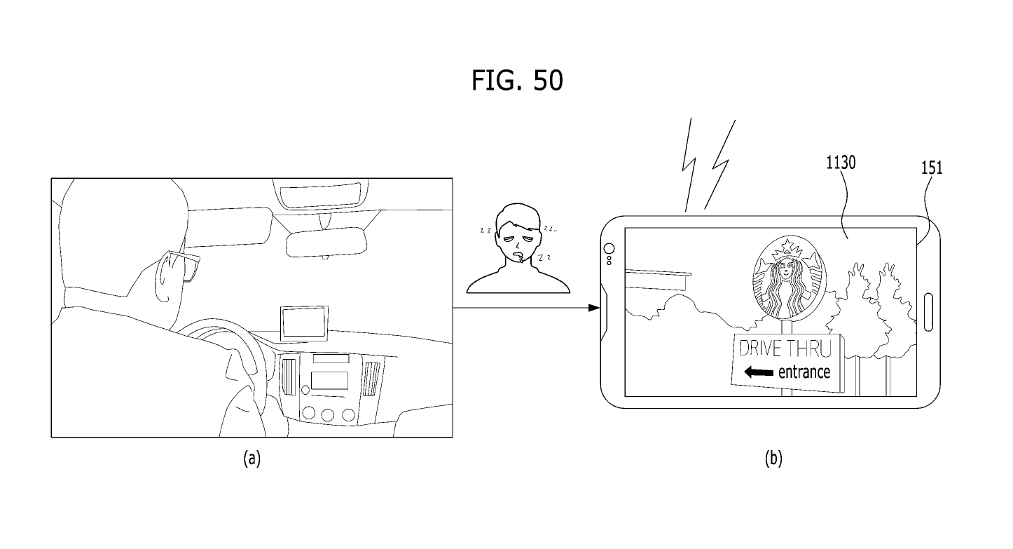

FIG. 50 is a diagram for explaining an example of a method of controlling a mobile terminal via brainwave recognition according to one embodiment of the present invention.

Referring to FIG. 50 (a), if a brainwave is detected by the brainwave detection unit, the controller 180 of the mobile terminal 100 controls the brainwave recognition unit 181 to recognize the detected brainwave. Specifically, the controller 180 can detect a current status and concentration of a user by analyzing the detected brainwave based on brainwave data according to a current status of the user and concentration stored in the memory 170. As an example, after the brainwave is recognized, assume that it is determined as the user is driving a car and the concentration is lower than a first reference.

The controller 180 executes a predetermined function according to the detected current status and the concentration of the user.

As an example, referring to FIG. 50 (b), the controller 180 can control the audio output unit 152 to output predetermined audio data related to driving while drowsy stored in the memory 170. By doing so, it is able to call user's attention based on the outputted audio data. And, the controller 180 may inform the user of a location of a coffee shop existing in the vicinity of the user based on current location information of the mobile terminal 100. The controller 180 executes a map application or a navigation application and may be then able to output a screen 1130 including a location of a coffee shop existing in the vicinity of the user based on the current location information of the mobile terminal 100 acquired through the location information module 115.

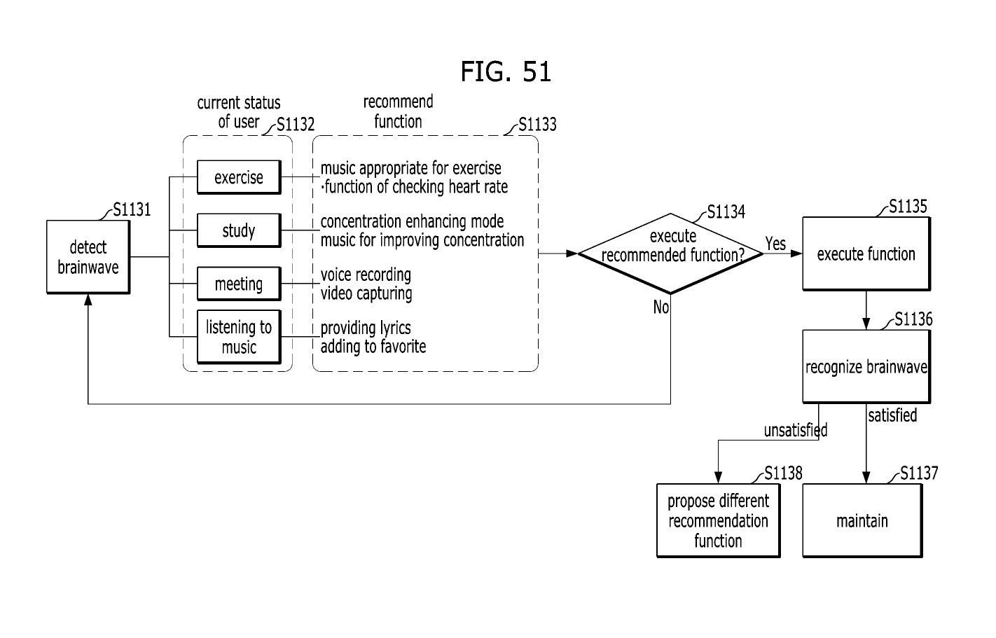

FIG. 51 is a flowchart for a different example of a method of controlling a mobile terminal via brainwave recognition according to one embodiment of the present invention.

The controller 180 of the mobile terminal 100 controls the brainwave detection unit to detect a brainwave [S1131]. Depending on an embodiment, a brainwave of a user can be detected by a brainwave sensor 143 embedded in the mobile terminal 100 or can be received from an external device via the wireless communication unit 110 or the interface unit 160.

The controller 180 controls the brainwave recognition unit 181 to recognize the detected brainwave [S1132]. Specifically, the controller 180 can control the brainwave recognition unit 181 to detect a current status of the user by analyzing the detected brainwave based on a current status of the user stored in the memory 170. For example, after the brainwave is recognized, the controller 180 can detect that the user is exercising, studying, in meeting, or listening to music.

The controller 180 accesses the memory 170 and may be then able to detect a recommendation function mapped to the detected current status of the user [S1133]. For example, if the current status of the user corresponds to an exercising status, the memory 170 stores a function of playing music appropriate for the exercise or a function of checking heart rate as a recommendation function. If the current status of the user corresponds to a studying status, the memory 170 stores a function of setting a concentration enhancing mode or a function of playing music for improving concentration as a recommendation function. If the current status of the user corresponds to a meeting status, the memory 170 stores a voice recording function or a video capturing function as a recommendation function. If the current status of the user corresponds to a music listening status, the memory 170 can store a function of providing lyrics or a function of adding bookmark as a recommendation function.

Subsequently, the controller 180 can control the display unit 151 to display a guide message for asking whether to execute the detected recommendation function [ S1134].

If a user command for selecting a specific function from among the detected recommendation function is detected via the guide message [S1134, yes], the controller 180 executes the selected specific function [S1136].

Subsequently, after the specific function is executed, the controller 180 can control the brainwave detection unit to redetect a brainwave and control the brainwave recognition unit 181 to recognize the redetected brainwave [S1136].

If the redetected brainwave is recognized as a brainwave corresponding to feeling of a first type, the controller 180 maintains an execution result of the specific function [S1137]. If the redetected brainwave is recognized as a brainwave corresponding to feeling of a second type, the controller 180 can return to a state that the specific function is not executed or may be able to provide the user with a different recommendation function [S1138]. In this case, the brainwave corresponding to feeling of the first type may correspond to a brainwave of a certain range matched with a brainwave of a frequency, a waveform and/or a pattern that appears when a user is affirmative to a current status. And, the brainwave corresponding to feeling of the second type may correspond to a brainwave of a certain range matched with a brainwave of a frequency, a waveform and/or a pattern that appears when a user is denying a current status.

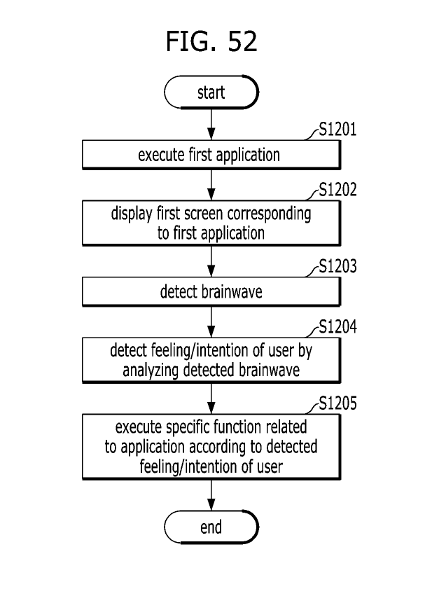

FIG. 52 is a flowchart for an example of a method of controlling a mobile terminal via brainwave recognition according to one embodiment of the present invention.

The controller 180 of the mobile terminal 100 executes a first application [S1201]. In this case, execution of the first application can include not only a case of executing the first application by a user by operating the mobile terminal 100 but also a case of automatically triggering the first application due to a call signal reception, a predetermined notification, or the like.

Subsequently, the controller 180 controls the display unit 151 to display a first screen corresponding to the first application [S1202]. The first screen corresponding to the first application may correspond to an execution screen at the time of starting the first application or an execution screen corresponding to a state of the first application after prescribed time elapses from the start of the first application.

Subsequently, the controller 180 controls the brainwave detection unit to detect a brainwave [S1203]. Depending on an embodiment, a brainwave of a user can be detected by a brainwave sensor 143 embedded in the mobile terminal 100 or can be received from an external device via the wireless communication unit 110 or the interface unit 160.

The controller 180 controls the brainwave recognition unit 181 to recognize the detected brainwave [S1204]. Specifically, the controller 180 can detect feeling or an intention of a user by analyzing the detected brainwave based on brainwave data stored in the memory 170.

The controller 180 can execute a specific function related to the first application according to the detected feeling/intention of the user [S1205]. And, the controller 180 can control the display unit 151 to display a second screen, which is different from the first screen in at least a part, while the specific function is executed. As an example, the second screen may be related to an execution result of the specific function or may include the execution result of the specific function.

Depending on an embodiment, the controller 180 can control the display unit 151 and/or the audio output unit 152 to output a guide message for checking whether to execute the specific function before the specific function is executed. In case of outputting the guide message on the display unit 151, the guide message can be outputted in a form of GUI to receive a command of a user. In case of outputting the guide message on the audio output unit 152, the guide message can be outputted in a form of audio data. If a first command for selecting execution of the specific function is detected, the controller 180 can execute the specific function at last. The first command can be detected via a touch screen of the display unit 151 or can be detected via voice recognition based on an audio signal received through the microphone 122. If the first command is detected, the controller 180 is able to learn that the recognized brainwave is matched with the intention of the user intending to execute the specific function and the controller 180 can store a result of the learning in the memory 170. On the contrary, if a second command for not selecting the execution of the specific function is detected, the controller 180 is able to learn that the recognized brainwave is not matched with the intention of the user related to the execution of the specific function. The controller 180 can store a result of the learning in the memory 170. Whenever a specific function is executed based on a result of brainwave recognition, the controller 180 can output a guide message to check whether or not the execution of the specific function is matched with the intention of the user. A result of user selection according to the output of the guide message can be stored in the memory 170 together with the recognized brainwave. By doing so, it may be able to enhance accuracy of a control signal when the control signal is generated based on brainwave recognition. If the guide message is outputted more than a predetermined count in relation to an identical/similar brainwave, the guide message may not be outputted. And, if a user selects termination of outputting the guide message, the guide message may not be outputted.

Depending on an embodiment, when the specific function is executed, the controller 180 controls the brainwave detection unit to redetect a brainwave and controls the brainwave recognition unit to detect feeling of a user by analyzing the redetected brainwave based on brainwave data according to feeling stored in the memory 170. If the redetected brainwave is recognized as a brainwave corresponding to feeling of a first type, the controller 180 maintains an execution result of the specific function. If the redetected brainwave is recognized as a brainwave corresponding to feeling of a second type, the controller 180 can return to a state that the specific function is not executed. In this case, the brainwave corresponding to feeling of the first type may correspond to a brainwave of a certain range matched with a brainwave of a frequency, a waveform and/or a pattern that appears when a user is affirmative to a current status. And, the brainwave corresponding to feeling of the second type may correspond to a brainwave of a certain range matched with a brainwave of a frequency, a waveform and/or a pattern that appears when a user is denying a current status.

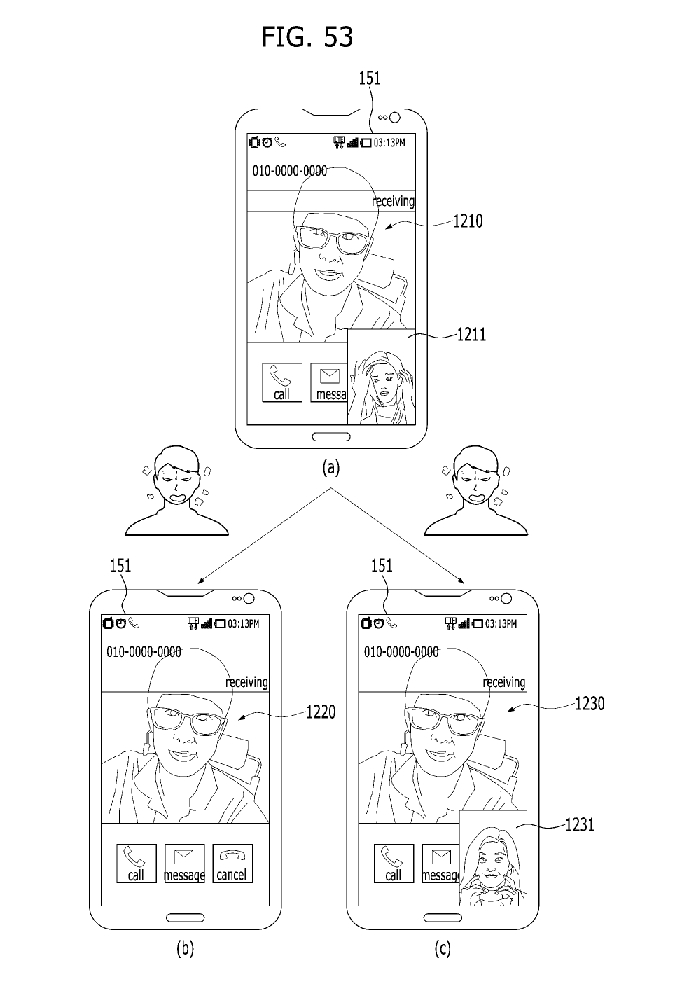

In the following, one embodiment of the present invention mentioned earlier in relation to FIG. 52 is explained in detail with reference to FIGS. 53 to 55.

FIG. 53 is a diagram for explaining an example of a method of controlling a mobile terminal via brainwave recognition according to one embodiment of the present invention.

Referring to FIG. 53 (a), a first screen 1210 corresponding to a first application is displayed on the display unit 151 of the mobile terminal 100. As an example, the first application is a calling application and the first screen 1210 may correspond to a screen for video call. The first screen 1210 includes an image 1211 of a user of the mobile terminal 100 captured by the camera 121 in the middle of the video call.

If a brainwave is detected by the brainwave detection unit, the controller 180 controls the brainwave recognition unit 181 to recognize the detected brainwave. For example, the controller 180 can control the brainwave recognition unit 181 to detect feeling of a user by analyzing the detected brainwave based on brainwave data stored in the memory 170.

The controller 180 executes a specific function related to the first application according to the detected feeling of the user and can display a second screen including an execution result of the specific function on the display unit 151. At least a part of the second screen may be different from the first screen.

As an example, after the brainwave is recognized, if it is determined as the user is very upset, the controller 180 controls the camera 121 not to capture the image 1211 of the user of the mobile terminal 100 and can control the display unit 151 to display a second screen 1220 that the image 1211 is excluded from the first screen 1210.

As a different example, after the brainwave is recognized, if it is determined as the user is very upset, the controller 180 controls the camera 121 not to capture the image 1211 of the user of the mobile terminal 100 and can control the display unit 151 to display a second screen 1230 including a predetermined image 1231 stored in the memory 170. The second screen 1230 may correspond to a screen including the predetermined image 1231 instead of the image 1211 of the user of the mobile terminal 100 in the first screen 1210. The image 1211 may correspond to an image designated by the user in advance among images stored in the memory 170. And, the image 1211 may correspond to a still image or a video image.

According to the present embodiment, a user is able to make a video call without showing feeling of the user to a counterpart.

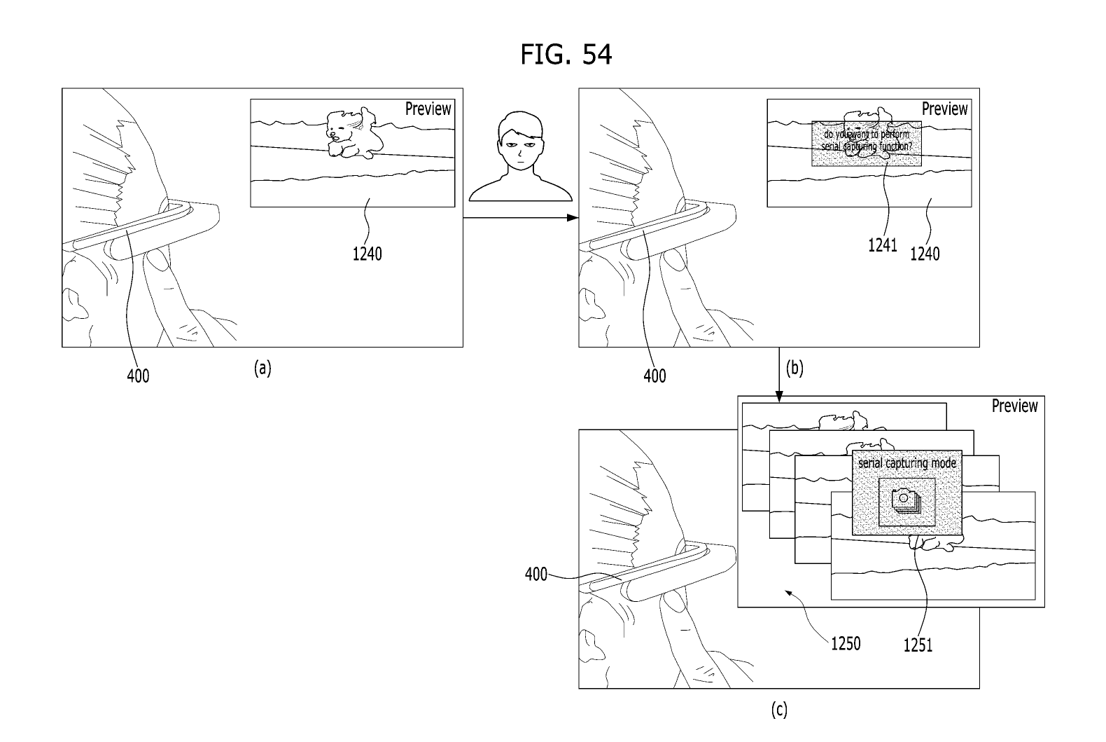

FIG. 54 is a diagram for explaining an example of a method of controlling a mobile terminal via brainwave recognition according to one embodiment of the present invention.

Referring to FIG. 54 (a), a first screen 1240 corresponding to a first application is displayed on the display unit 451 of the mobile terminal 400. As an example, the first application is a calling application and the first screen 1240 may correspond to a preview image captured by the camera 421.

If a brainwave is detected by the brainwave detection unit, the control module 480 controls the brainwave recognition unit 181 to recognize the detected brainwave. For example, the control module 480 can control the brainwave recognition unit 181 to detect intention and feeling of a user by analyzing the detected brainwave based on brainwave data stored in the memory 170. After the brainwave is recognized, assume that it is determined as the user intends to capture a picture using the camera 421 but the user has difficulty capturing a picture because a subject is moving fast. The control module 480 may use an acceleration sensor embedded in the mobile terminal 400 to identify whether the reason of difficulty in capturing a picture corresponds to movement of the subject or movement of the user.

Referring to FIG. 54 (b), the control module 480 can control the display unit 451 to display GUI 1241 to propose a serial capturing function among functions related to a camera application based on the brainwave recognition result.

Referring to FIG. 54 (c), if a user command for selecting the serial capturing function is detected, the control module 480 executes the serial capturing function and can control the display unit 451 to display a second screen 1250 including an execution result of the serial capturing function. Depending on an embodiment, the second screen 1250 may include an indicator 1251 to indicate that the serial capturing function is currently executed or the serial capturing function is finished. The user command can be detected by redetecting and recognizing a brainwave or can be detected by the user input unit 423a/423b.

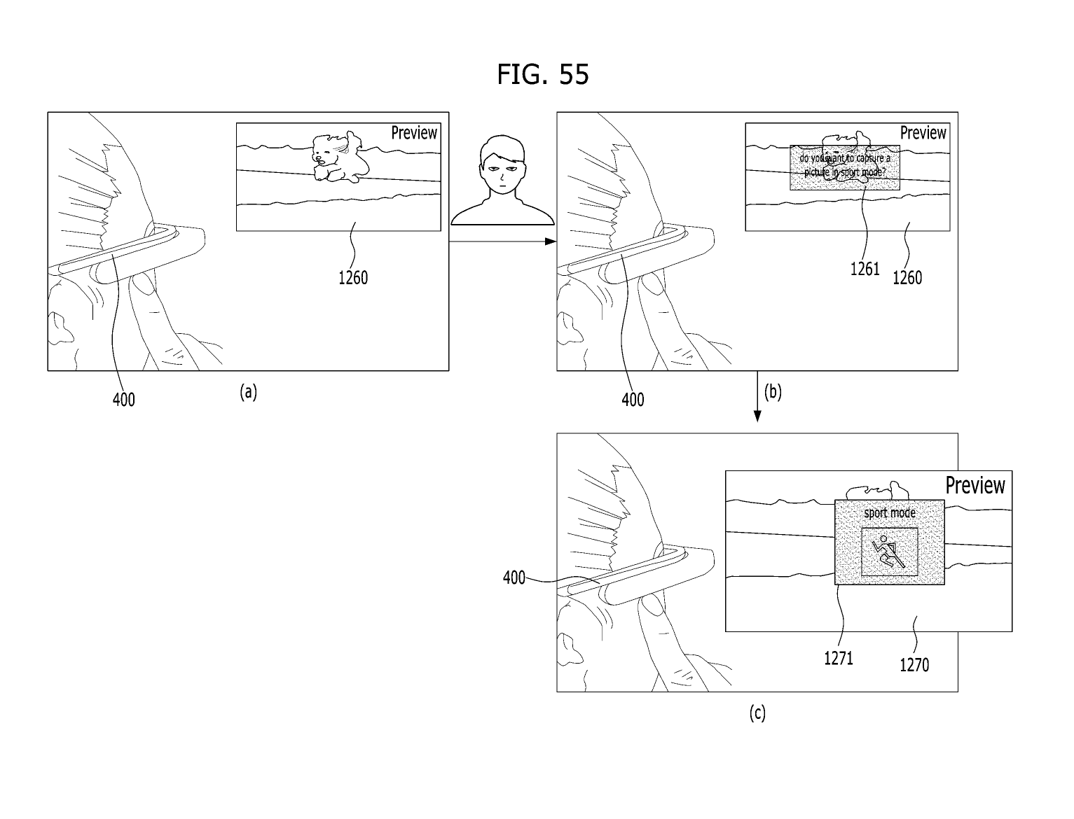

FIG. 55 is a diagram for explaining an example of a method of controlling a mobile terminal via brainwave recognition according to one embodiment of the present invention.

Referring to FIG. 55 (a), a first screen 1260 corresponding to a first application is displayed on the display unit 451 of the mobile terminal 400. As an example, the first application is a calling application and the first screen 1260 may correspond to a preview image captured by the camera 421.

If a brainwave is detected by the brainwave detection unit, the control module 480 controls the brainwave recognition unit 181 to recognize the detected brainwave. For example, the control module 480 can control the brainwave recognition unit 181 to detect intention and feeling of a user by analyzing the detected brainwave based on brainwave data stored in the memory 170. After the brainwave is recognized, assume that it is determined as the user intends to capture a picture using the camera 421 but the user has difficulty capturing a picture because the user is capturing a picture while moving. The control module 480 may use an acceleration sensor embedded in the mobile terminal 400 to identify whether the reason of difficulty in capturing a picture corresponds to movement of a subject or movement of the user.

Referring to FIG. 55 (b), the control module 480 can control the display unit 451 to display GUI 1261 to propose a sport mode function among functions related to a camera application based on the brainwave recognition result.

Referring to FIG. 55 (c), if a user command for selecting the sport mode function is detected, the control module 480 sets a capturing mode of the camera 421 to a sport mode and can control the display unit 451 to display a second screen 1270 including a setting result of the sport mode. Depending on an embodiment, the second screen 1270 may include an indicator 1271 to indicate that the capturing mode is set to the sport mode. The user command can be detected by redetecting and recognizing a brainwave or can be detected by the user input unit 423a/423b.

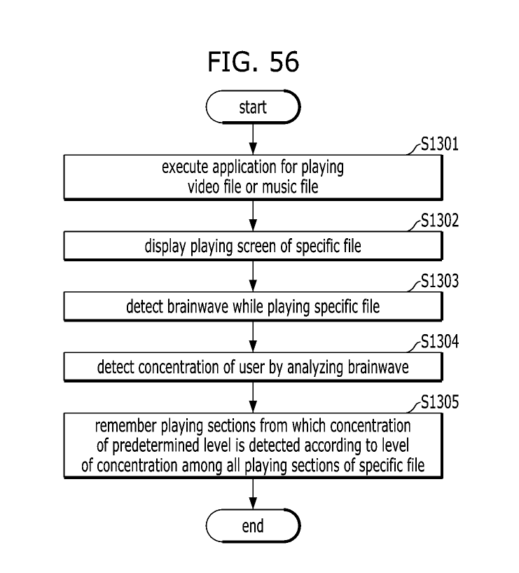

FIG. 56 is a flowchart for explaining an example of a method of controlling a mobile terminal via brainwave recognition according to one embodiment of the present invention.

The controller 180 of the mobile terminal 100 executes a first application [S1301]. In the present embodiment, assume that the first application corresponds to an application for playing a video file or a music file.

The controller 180 controls the display unit 151 to output a playing screen of a specific file selected by a user. Assume that the specific file corresponds to a video file.

The controller 180 controls the brainwave detection unit to detect a brainwave while playing the specific file [S1303] and controls the brainwave recognition unit 181 to detect concentration of the user by analyzing the detected brainwave based on brainwave data according to concentration stored in the memory 170 [S1304]. The brainwave detection and recognition can be performed with a predetermined time interval while the entire specific file is playing.

The controller 180 can remember playing sections from which concentration of a predetermined level is detected according to a level of concentration among all playing sections based on the detected concentration of the user [S1305]. For example, the controller 180 can remember playing sections from which concentration of a first level is detected, playing sections from which concentration of a second level higher than the first level is detected, and playing sections from which concentration of a third level higher than the second level is detected according to a level of concentration.

And, depending on an embodiment, the controller 180 can further detects feeling of a user based on brainwave data according to feeling stored in the memory 170 [S1304] and remember playing sections from which feeling of an identical type is detected according to a type of feeling. For example, the controller 180 can remember playing sections from which feeling of a first type (joyful, fun) is detected and playing sections from which feeling of a second type (touching, happy) is detected according to a type of feeling.

And, depending on an embodiment, the controller 180 can respectively remember each level of concentration and playing sections from which feeling of each type is detected in consideration of both concentration and feeling.

And, depending on an embodiment, the controller 180 may store a thumbnail image that represents each of remembered playing sections in the memory 170.

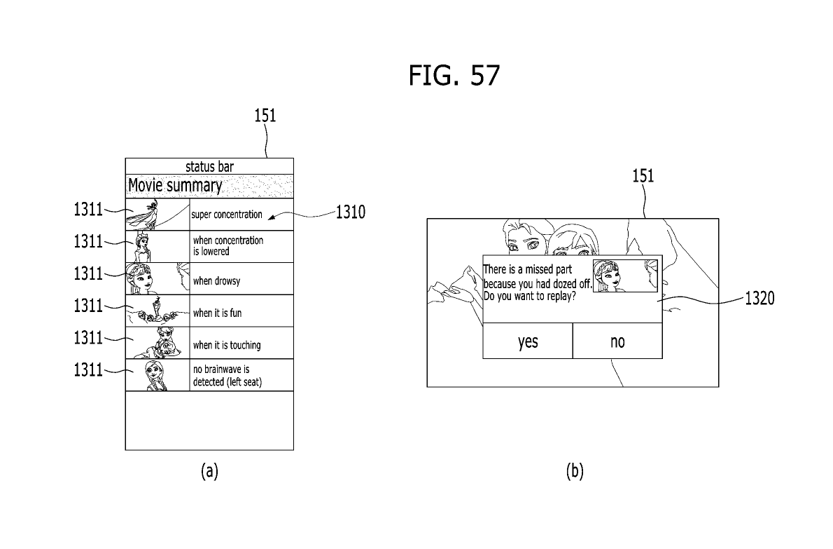

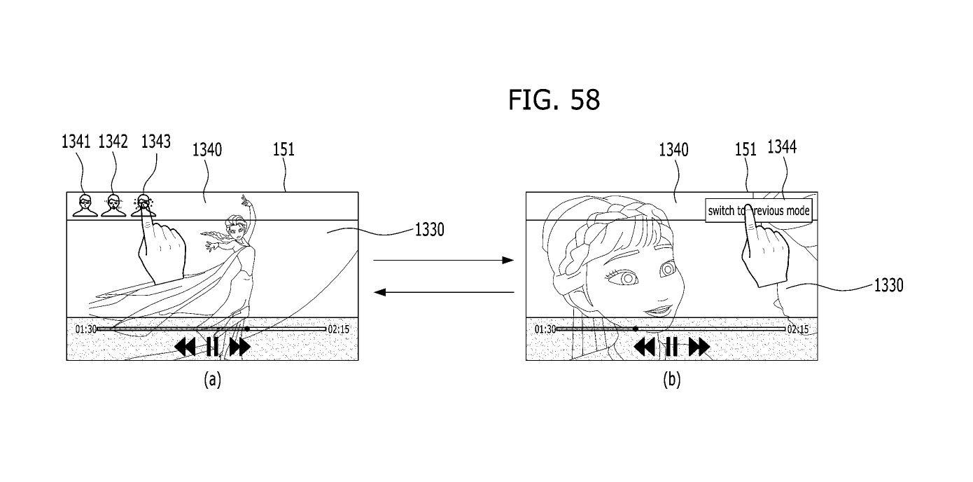

In the following, one embodiment of the present invention mentioned earlier in relation to FIG. 56 is explained in detail with reference to FIGS. 57 and 58.

FIG. 57 is a diagram for explaining an example of a method of controlling a mobile terminal via brainwave recognition according to one embodiment of the present invention.

Referring to FIG. 57 (a), if playing of a specific file is completed via a video playing application, the controller 180 can control the display unit 151 to output GUI 1310 that displays the remembered playing sections according to at least one level among concentration and feeling. The GUI 1310 can include a thumbnail image 1311 that represents each of the playing sections according to each level of concentration and/or each type of feeling.

If a user selects concentration of a specific level or feeling of a specific type included in the GUI 1310, the user can separately watch playing sections corresponding to concentration of the selected specific level or feeling of the selected specific type only.

Meanwhile, referring to FIG. 57 (b), if playing of a specific file is completed via a video playing application, the controller 180 can control the display unit 151 to output GUI 1320 to inform a user that playing sections of which concentration does not satisfy a first reference are capable of being replayed. If the user selects replay via the GUI 1320, the controller 180 can separately replay the playing sections that the concentration does not satisfy the first reference only. The controller 180 can replay the specific file from the playing section that the concentration does not satisfy the first reference.

FIG. 58 is a diagram for explaining an example of a method of controlling a mobile terminal via brainwave recognition according to one embodiment of the present invention.

Referring to FIG. 58 (a), a playing screen 1330 of a specific file, which is played via a video playing application, is displayed on the display unit 151 of the mobile terminal 100. The controller 180 controls the brainwave recognition unit to detect a brainwave while the specific file is playing. The controller 180 controls the brainwave recognition unit 181 to detect concentration of a user by analyzing the detected brainwave based on brainwave data according to concentration stored in the memory 170. Subsequently, the controller 180 remembers playing sections from which concentration of a predetermined level is detected among all playing sections of the specific file according to a level of concentration based on the detected concentration of the user.

The controller 180 can control the display unit 151 to output a status bar 1340 including a first icon 1341 corresponding to concentration higher than a first reference, a second icon 1342 corresponding to concentration lower than the first reference and higher than a second reference, and a third icon 1343 corresponding to concentration lower than the second reference on a partial area of the playing screen 1330 (e.g., top of the playing screen 1330). As an example, the status bar 1340 can be outputted on the display unit 151 when the user touches a random area of the display unit 151 one time. The three icons shown in FIG. 58 (a) is just an example only. Icons less than or greater than three icons can be included in the status bar 1340 depending on the number of concentration levels.

Among the playing sections played until the timing at which the status bar 1340 is outputted, the controller 180 stores information on playing sections from which concentration higher than the first reference is detected by mapping the information to the first icon 1341, stores information on playing sections from which concentration lower than the first reference and higher than the second reference is detected by mapping the information to the second icon 1342, and stores information on playing sections from which concentration lower than the second reference is detected by mapping the information to the third icon 1343.

Subsequently, if a user command for selecting one from among the first icon 1341, the second icon 1342, and the third icon 1343 is detected, as shown in FIG. 58 (b), the controller 180 can control the video playing application to play playing sections corresponding to information mapped to the selected icon only. And, the controller 180 can output the status bar 1340 including a menu 1344 for returning to a state that the icon is not selected on the top of a screen of the display unit 151. If the user selects the menu 1344, the user can continuously watch the video from a part outputted via the playing screen 1330 of the timing at which the icon is selected.

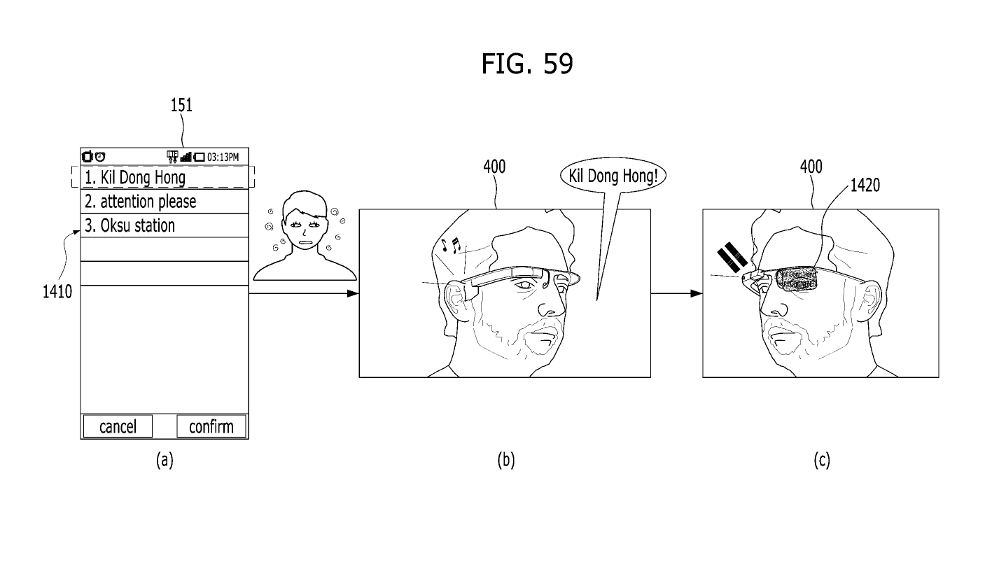

FIG. 59 is a diagram for explaining an example of a method of controlling a mobile terminal via brainwave recognition according to one embodiment of the present invention.

Referring to FIG. 59 (a), a user can make a list of voice recognition words by executing an application related to voice recognition. A list 1410 of voice recognition words registered by the user can be displayed on the display unit 451 of the mobile terminal 400. If a voice recognition mode is activated, the control module 480 analyzes a voice signal received via the microphone 121 and may be able to recognize a word included in the list 1410. The voice recognition mode can be activated by the user. After a brainwave is recognized, if it is determined as concentration of the user is lowered, the voice recognition mode can be automatically activated. In the present embodiment, a case of recognizing “Kil Dong Hong”, i.e., a name of the user, is explained as an example.

The control module 480 controls the brainwave detection unit to detect a brainwave and can detect concentration of the user by analyzing the detected brainwave based on brainwave data according to concentration stored in the memory 170.

If the detected concentration is lower than a first reference, the control module 480 can activate a voice recognition mode. Of course, the voice recognition mode can be activated by the user before the brainwave is recognized.

Referring to FIG. 59 (b), if a sentence including such a word as “Kil Dong Hong” is said in the vicinity of a user of the mobile terminal 400, the control module 480 analyzes a voice signal received via the microphone 122 and may be able to recognize the word “Kil Dong Hong”. Assume that a program necessary for performing a voice recognition function and an STT (speech to text) functions is stored in the memory 170 in advance. And, assume that a user is listening to music via the mobile terminal 400.

Referring to FIG. 59 (c), if such a word as “Kil Dong Hong” is recognized, the control module 480 can control the display unit 451 to output a guide message 1420 to indicate that the word “Kil Dong Hong” is recognized and control a music playing application to pause a currently playing music file.

According to the present embodiment, when concentration of a user is distracted while a user is listening to music, if a word predetermined by the user is recognized, it is able to make the user recognize the word. By doing so, it is able to call user's attention.

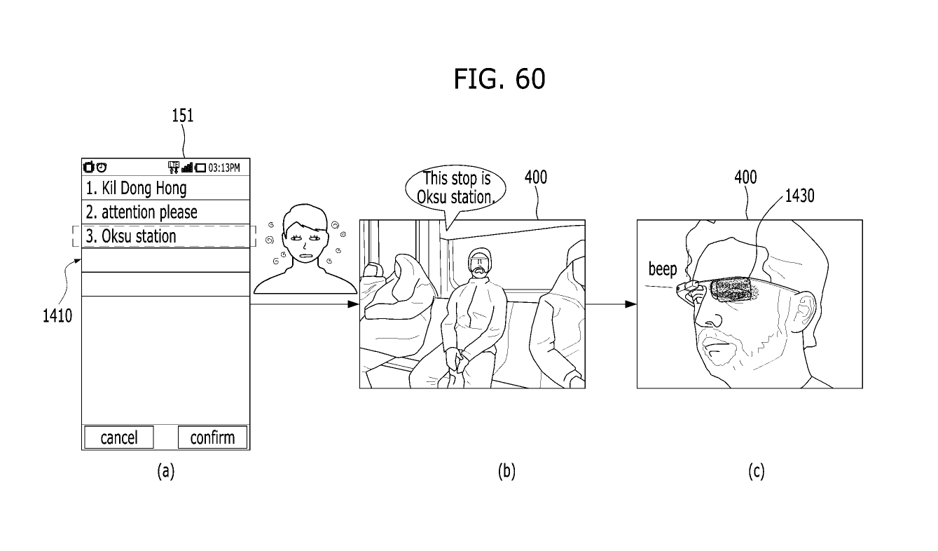

FIG. 60 is a diagram for explaining an example of a method of controlling a mobile terminal via brainwave recognition according to one embodiment of the present invention.

Referring to FIG. 60 (a), a user can make a list of voice recognition words by executing an application related to voice recognition. A list 1410 of voice recognition words registered by the user can be displayed on the display unit 451 of the mobile terminal 400. If a voice recognition mode is activated, the control module 480 analyzes a voice signal received via the microphone 121 and may be able to recognize a word included in the list 1410. The voice recognition mode can be activated by the user. After a brainwave is recognized, if it is determined as concentration of the user is lowered, the voice recognition mode can be automatically activated. In the present embodiment, a case of recognizing “Oksu station”, i.e., a destination of the user, is explained as an example.

The control module 480 controls the brainwave detection unit to detect a brainwave and can detect concentration of the user by analyzing the detected brainwave based on brainwave data according to concentration stored in the memory 170.

If the detected concentration is lower than a first reference, the control module 480 can activate a voice recognition mode. Of course, the voice recognition mode can be activated by the user before the brainwave is recognized.

Referring to FIG. 60 (b), if a sentence including such a word as “Oksu station” is said in the vicinity of a user of the mobile terminal 400, the control module 480 analyzes a voice signal received via the microphone 122 and may be able to recognize the word “Oksu station”. Assume that a program necessary for performing a voice recognition function and an STT (speech to text) functions is stored in the memory 170 in advance.

Referring to FIG. 60 (c), if such a word as “Oksu station” is recognized, the control module 480 can control the display unit 451 to output a guide message 1430 to indicate that the word “Oksu station” is recognized and control the audio output unit 452 to output a predetermined sound notification.

According to the present embodiment, when concentration of a user is distracted while a user dozes off or is listening to music, if a word corresponding, to a destination predetermined by the user is recognized, it is able to make the user recognize the word. By doing so, it is able to call user's attention.

### MODE FOR INVENTION

The present invention mentioned in the foregoing description can be implemented by codes readable by a computer in media in which a program is recorded. Media readable by a computer includes all kinds of recording devices in which data readable by a computer system is stored. Examples of the media readable by a computer include a HDD (hard disk drive), an SSD (solid state disk), an SDD (silicon disk drive), a ROM, a RAM, a CD-ROM, a magnetic tape, a floppy disk, an optical data storing device and the like. And, the media can be implemented in a form of a carrier wave (e.g., transmission via the internet). And, the computer may include a controller of a wearable device. While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

### INDUSTRIAL APPLICABILITY

Since the present invention is applicable to a mobile terminal and a method of controlling therefor, it is natural that there exists industrial applicability.

What is claimed is:

1. A mobile terminal, comprising:
a brainwave detection unit;
a brainwave recognition unit;
a display unit; and
a controller, the controller configured to control the display unit to display a first screen corresponding to a currently executed first application, the controller configured to control the brainwave detection unit to detect a brainwave, the controller configured to control the brainwave recognition unit to recognize the detected brainwave based on the first application, the controller configured to control the display unit to display a second screen different from the first screen in at least a part based on a brainwave recognition result.

2. The mobile terminal of claim 1, wherein the controller is configured to execute a specific function among functions related to the first application based on the brainwave recognition result.

3. The mobile terminal of claim 2, wherein the controller is configured to control the display unit to display an indicator indicating an execution result of the specific function on the second screen.

4. The mobile terminal of claim 1, wherein the controller is configured to control the display unit to display a menu icon contained in the first screen in a manner of changing at least one selected from the group consisting of a size, a shape, and arrangement of the menu icon, configured to control the display unit to display a GUI corresponding to a specific function among functions related to the first application, configured to control the display unit to display a GUI corresponding to a second application related to the first application, or configured to control the display unit to display an execution screen of the second application related to the first application as a sub screen, when the second screen is displayed on the display unit.

5. The mobile terminal of claim 1, wherein the brainwave detection unit comprises at least one selected from the group consisting of a brainwave detection sensor embedded in the mobile terminal, a wireless communication unit configured to receive a brainwave from an external device connected with the mobile terminal in wireless, and an interface unit configured to receive a brainwave from an external device connected with the mobile terminal in wired.

6. The mobile terminal of claim 2, wherein the controller is configured to output a guide message for checking whether or not the second screen is displayed before the second screen is displayed and configured to control the display unit to display the second screen when a command for selecting display of the second screen is detected.

7. The mobile terminal of claim 2, wherein when the second screen is displayed on the display unit, the controller is configured to control the brainwave detection unit to redetect a brainwave, configured to control the brainwave recognition unit to recognize the redetected brainwave, and if the redetected brainwave is recognized as a brainwave of a first type, configured to return to a state that the specific function is not executed.

8. The mobile terminal of claim 6, wherein if the redetected brainwave is recognized as a brainwave of a second type, the controller is configured to maintain an execution effect of the specific function and control the display unit to display the first screen instead of the second screen.

9. The mobile terminal of claim 6, wherein when the redetected brainwave is recognized as a brainwave of a third type, if the brainwave recognized as the third type brainwave is continuously detected for more than predetermined time or is detected with strength equal to or greater than predetermined strength, the controller is configured to execute the specific function toward a direction that an effect of the specific function is increasing.

10. The mobile terminal of claim 9, wherein the specific function is related to a numerical change.

11. A method of controlling a mobile terminal, comprising the steps of:
detecting and recognizing a brainwave;
occurring a specific event; and
displaying a screen corresponding to the specific event based on a brainwave recognition result.

12. The method of claim 11, wherein occurrence of the specific event comprises at least one selected from the group consisting of detection of call signal reception, detection of text message reception, detection of notification occurrence, detection of on signal of a display unit, detection detected by a proximity sensor, and detection of an execution signal of a specific application.

13. The method of claim 11, wherein the screen corresponding to the specific event corresponds to a first screen preconfigured to be displayed according to a brainwave recognition result when the specific event occurs in a brainwave mode for detecting a brainwave and wherein at least a part of the first screen is different from a second screen preconfigured to be displayed when the specific event occurs in a normal mode not detecting a brainwave.

14. The method of claim 13, further comprising the steps of:
redetecting and recognizing a brainwave when the first screen is displayed; and
if the detected brainwave is recognized as a brainwave of a first type, displaying the second screen instead of the first screen.

15. A mobile terminal, comprising:
a brainwave detection unit;
a brainwave recognition unit;
a display unit;
a memory configured to store brainwave data according to concentration; and
a controller, the controller configured to control the display unit to display a first screen corresponding to a currently executed first application, the controller configured to control the brainwave detection unit to detect a brainwave, the controller configured to control the brainwave recognition unit to detect concentration of a user by analyzing the detected brainwave based on the brainwave data according to the concentration, the controller configured to execute at least one of a specific function related to the application and a specific function related to the display unit according to the detected concentration.

16. The mobile terminal of claim 15, wherein the controller is configured to control the display unit to display a second screen different from the first screen in at least a part according to the detected concentration.

17. The mobile terminal of claim 16, wherein the controller is configured to control the display unit to change at least one selected from the group consisting of brightness, definition, and contrast ratio, configured to control the display unit to change at least one selected from the group consisting of a font, a size and thickness of a letter contained in the first screen, or configured to control the display unit to display a GUI corresponding to a specific function among functions related to the application, when the second screen is displayed on the display unit.

18. The mobile terminal of claim 15, wherein the memory is further configured to store brainwave data according to feeling and wherein the controller is configured to control the brainwave detection unit to redetect a brainwave when the specific function is executed, configured to control the brainwave recognition unit to detect feeling of a user by analyzing the redetected brainwave based on the brainwave data according to the feeling, if the redetected brainwave is recognized as a brainwave corresponding to feeling of a first type, configured to maintain an execution result of the specific function, and if the redetected brainwave is recognized as a brainwave corresponding to feeling of a second type, configured to return to a state that the specific function is not executed.

19. A mobile terminal, comprising:
a brainwave detection unit;
a brainwave recognition unit;
a memory configured to store brainwave data according to a current status and concentration of a user; and
a controller, the controller configured to control the brainwave detection unit to detect a brainwave, the controller configured to control the brainwave recognition unit to detect the current status and the concentration of the user by analyzing the detected brainwave based on the brainwave data, the controller configured to execute a predetermined function related to the detected current status and the concentration of the user.

20. The mobile terminal of claim 19, further comprising a display unit,
wherein the controller is configured to control the display unit to output a guide message for checking whether or not the predetermined function is executed before the predetermined function is executed, configured to execute the predetermined function when a user command for selecting execution of the predetermined function is detected via the guide message, and configured to control the display unit to display an execution result of the predetermined function.
